(19) United States
(12) Patent Application Publication
(10) Pub. No.: US 2024/0183163 A1
(43) Pub. Date: Jun. 6, 2024

(54) MULTILAYER STRUCTURE WITH ENHANCED WALKABILITY

(71) Applicant: Owens Corning Intellectual Capital, LLC, Toledo, OH (US)

(72) Inventors: Stephanie Pruzinsky, Newark, OH (US); Martin Vido, Surrey (CA); Toni Newsome, Pataskala, OH (US); Brian Shaeffer, Pataskala, OH (US); Marcos Cortes-Medina, Miami, FL (US); Melissa Nogaj, Westerville, OH (US); Stephanie Maxson, Dublin, OH (US); Dinh Chi Pham, Granville, OH (US)

(21) Appl. No.: 18/527,882

(22) Filed: Dec. 4, 2023

Related U.S. Application Data
(60) Provisional application No. 63/386,032, filed on Dec. 5, 2022.

(51) Int. Cl. E04D 12/00; B32B 3/30; B32B 7/12; B32B 27/12

(52) U.S. Cl. CPC E04D 12/002; B32B 3/30; B32B 7/12; B32B 27/12; B32B 2250/03; B32B 2307/536; B32B 2307/7376; B32B 2419/06

(57) ABSTRACT

A roofing underlayment with enhanced walkability is provided. The roofing underlayment has a reinforcement, a film, and a plurality of gripping structures. The gripping structures are disposed on at least a portion of a first film surface of the film. The roofing underlayment has at least one of a coefficient of friction of between about 1.2 and about 1.8 when tested in dry condition using COF method 1, a coefficient of friction of between about 0.8 and about 1.5 when tested in wet condition using COF method 1, and a coefficient of friction of between about 0.5 and about 1.2 using COF method 1.

### CROSS-REFERENCE TO RELATED APPLICATION(S)

This application claims priority to and any benefit of U.S. Provisional Application No. 63/386,032, filed Dec. 5, 2022, the content of which is incorporated herein by reference in its entirety.

### FIELD

The general inventive concepts relate to multilayer structures suitable for use as a roofing underlayment and, more particularly, to a multilayer structure configured to enhance walkability.

### BACKGROUND

Underlayments are commonly used in roofing applications along with an overlayment roofing material, such as asphalt shingles, slate tiles, wooden shakes, metal roofing, and so forth. Underlayments are generally secured to the roof deck and provide the first protection against water infiltration into the interior structure of a building during construction and subsequently become a secondary barrier to water infiltration into the interior upon installation of the primary overlayment roofing material.

A primary drawback of certain underlayments, such as conventional synthetic roofing underlayments, is that the surface of such underlayments is relatively smooth and poses a slipping hazard, particularly during wet, humid, and/or dusty conditions. The smooth surface associated with such underlayments creates a hazardous working condition for roofing installers who must walk upon the underlayments to install roofing materials.

### SUMMARY

The general inventive concepts relate to a multilayer structure (also referred to herein as a “roofing underlayment”) that is configured to enhance walkability. To illustrate various aspects of the general inventive concepts, several exemplary embodiments of roofing underlayments are disclosed.

In accordance with one aspect of the present disclosure, a multilayer structure (e.g., a construction membrane, a roofing membrane, a roofing underlayment, etc.) is provided. The multilayer structure includes a reinforcement having a first reinforcement surface and a second reinforcement surface, a film having a first film surface and a second film surface, and a plurality of gripping structures. The plurality of gripping structures are disposed on at least a portion of the first film surface at a density of 15 to 10,000 gripping structures per square centimeter. The first reinforcement surface is adhered to the second film surface. Each gripping structure has a height of 10 μm to 600 μm and a maximum cross-sectional dimension of 25 μm to 1,000 μm.

In some exemplary embodiments, the film and the plurality of gripping structures have a Shore D hardness of about 40 to 100.

In some exemplary embodiments, the film and the plurality of gripping structures have a Shore A hardness of greater than about 90.

In some exemplary embodiments, the multilayer structure has a tensile strength of greater than or equal to 25 lbf.

In some exemplary embodiments, the multilayer structure has a notched tear strength of greater than or equal to 20 lbf.

In some exemplary embodiments, the multilayer structure is a self-adhered underlayment having a tensile strength of greater than or equal to 25 lbf and a notched tear strength of greater than or equal to 20 lbf.

In some exemplary embodiments, the multilayer structure has a tensile strength of greater than or equal to 20 lbf.

In some exemplary embodiments, the multilayer structure has a trapezoidal tear strength of greater than or equal to 15 lbf.

In some exemplary embodiments, the multilayer structure is a synthetic underlayment having a tensile strength of greater than or equal to 20 lbf and a trapezoidal tear strength of greater than or equal to 15 lbf.

In some exemplary embodiments, the plurality of gripping structures have a contact area of 5% to 15%.

In some exemplary embodiments, the plurality of gripping structures have a contact area of 13%.

In some exemplary embodiments, a pitch between adjacent gripping structures is from 150 μm to 4,000 μm.

In some exemplary embodiments, at least a portion of the plurality of gripping structures have different heights.

In some exemplary embodiments, at least a portion of the plurality of gripping structures have different maximum cross-sectional dimensions.

In some exemplary embodiments, the film comprises at least one of a polyolefin, a polyester, a polyamide, a polyimide, a polycarbonate, a polyurethane, a fluoropolymer, a copolymer of an olefin and an α,β-unsaturated carbonyl, a synthetic rubber, or a thermoplastic elastomer.

In some exemplary embodiments, the reinforcement comprises a mesh structure, a nonwoven structure, a film structure, or combinations thereof.

In some exemplary embodiments, the multilayer structure further comprises a bonding material, wherein the bonding material adheres the first reinforcement surface to the second film surface.

In some exemplary embodiments, the bonding material comprises an adhesive, wherein the adhesive has a basis weight of 3 g/m² to 15 g/m².

In some exemplary embodiments, the bonding material comprises a thermoplastic coating, wherein the thermoplastic coating comprises at least one of a polyolefin, a polyacrylate, a polyester, a polyamide, a polyimide, a polycarbonate, a polyurethane, a fluoropolymer, a copolymer of an olefin and an α,β-unsaturated carbonyl, a synthetic rubber, a thermoplastic elastomer, or combinations thereof, and wherein the thermoplastic coating has a basis weight of 6 g/m² to 75 g/m².

In some exemplary embodiments, the reinforcement comprises at least one of a polymer or a fiberglass, and wherein the reinforcement has a basis weight of 10 g/m² to 200 g/m².

In some exemplary embodiments, the multilayer structure has a width of 0.6 m to 2 m, a length of 9 m to 100 m, and a thickness of 125 μm to 2,500 μm.

In some exemplary embodiments, the film is a coextruded film comprising a first coextruded layer that includes a U.V. protective component and a second coextruded layer.

In some exemplary embodiments, the plurality of gripping structures are disposed on at least 50% of the first film surface at a density of 15 to 10,000 gripping structures per square centimeter.

In some exemplary embodiments, the plurality of gripping structures are disposed on 50% to 100% of the first film surface at a density of 15 to 10,000 gripping structures per square centimeter.

In some exemplary embodiments, the multilayer structure further comprises a bottom coating adhered to the second reinforcement surface.

In some exemplary embodiments, the bottom coating is a coextruded coating comprising a thermoplastic elastomer extrudate and a polyolefin extrudate, wherein the bottom coating has a basis weight of 10 g/m² to 80 g/m², and wherein the polyolefin extrudate is adhered to the second reinforcement surface.

In some exemplary embodiments, the multilayer structure further comprises a bottom film adhered to the bottom coating opposite the second reinforcement surface, wherein the bottom coating has a basis weight of 10 g/m² to 80 g/m², and wherein the bottom film comprises at least one of a polyolefin, ethylene-vinyl acetate copolymer, ethylene-methyl acrylate copolymer, or a thermoplastic elastomer.

In some exemplary embodiments, the multilayer structure further comprises a bottom coating, an adhesive coating, and an optional release liner. The bottom coating is adhered to the second reinforcement surface. The adhesive coating is adhered to the bottom coating opposite the second reinforcement surface. The optional release liner is optionally adhered to a surface of the adhesive coating opposite the bottom coating.

In some exemplary embodiments, the bottom coating is a coextruded coating comprising a thermoplastic elastomer extrudate and a polyolefin extrudate, wherein the bottom coating has a basis weight of 10 g/m² to 80 g/m², and wherein the polyolefin extrudate is adhered to the second reinforcement surface.

In some exemplary embodiments, the multilayer structure further comprises an adhesive coating adhered to the second reinforcement surface and an optional release liner optionally adhered to a surface of the adhesive coating opposite the second reinforcement surface.

In some exemplary embodiments, the multilayer structure further comprises a first adhesive coating, a second adhesive coating, and an optional liner, and the reinforcement comprises a glass mat. The first adhesive coating is adhered to the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the multilayer structure further comprises a first adhesive coating, a glass mat, a second adhesive coating, and an optional liner. The first adhesive coating is adhered to the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the multilayer structure further comprises a bottom coating, a first adhesive coating, a second adhesive coating, and an optional release liner, and the reinforcement comprises a glass mat. The bottom coating is adhered to the second reinforcement surface. The first adhesive coating is adhered to the bottom coating opposite the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the multilayer structure further comprises a bottom coating, a first adhesive coating, a glass mat, a second adhesive coating, and an optional release liner. The bottom coating is adhered to the second reinforcement surface. The first adhesive coating is adhered to the bottom coating opposite the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the first adhesive coating comprises asphalt.

In some exemplary embodiments, the first adhesive coating comprises a non-asphaltic coating that includes butyl rubber.

In some exemplary embodiments, the first adhesive coating comprises a non-asphaltic acrylic adhesive coating.

In some exemplary embodiments, the second adhesive coating comprises asphalt.

In some exemplary embodiments, the second adhesive coating comprises a non-asphaltic coating that includes butyl rubber.

In some exemplary embodiments, the second adhesive coating comprises a non-asphaltic acrylic adhesive coating.

In some exemplary embodiments, the multilayer structure further comprises at least one of a coating layer or an adhesive layer, where the at least one of the coating layer or the adhesive layer are positioned between the first reinforcement surface and the second film surface.

In some exemplary embodiments, the multilayer structure further comprises at least one of a coating layer or an adhesive layer positioned between the film and the reinforcement, and further comprises an optional coating layer positioned below the reinforcement.

In some exemplary embodiments, the multilayer structure further comprises at least one of a coating layer or an adhesive layer positioned between the film and the reinforcement, and further comprises an optional coating layer positioned below the reinforcement. The multilayer structure further comprises a adhesive coating positioned below the optional coating layer and an optional release liner positioned below the adhesive coating.

In some exemplary embodiments, the multilayer structure further comprises a coating layer positioned between the film and the reinforcement, and further comprises an adhesive coating and an optional release liner positioned below the reinforcement.

In some exemplary embodiments, the multilayer structure further comprises at least one of a coating layer or an adhesive layer positioned between the film and the reinforcement, and further comprises an optional coating layer positioned below the reinforcement. The multilayer structure further comprises a second coating layer positioned below the optional coating layer, a second reinforcement positioned below second coating layer, an adhesive coating positioned below the second reinforcement, and an optional release liner positioned below the adhesive coating.

In accordance with one aspect of the present disclosure, a multilayer structure (e.g., a construction membrane, a roofing membrane, a roofing underlayment, etc.) is provided. The multilayer structure includes a reinforcement having a first reinforcement surface and a second reinforcement surface, and a thermoplastic coating that includes a plurality of gripping structures. The thermoplastic coating is adhered to the first reinforcement surface. Each gripping structure has a height of 10 μm to 600 μm and a maximum cross-sectional dimension of 25 μm to 1,000 μm. The plurality of gripping structures are positioned on at least a portion of the thermoplastic coating at a density of 15 to 10,000 gripping structures per square centimeter.

In some exemplary embodiments, the thermoplastic coating and the plurality of gripping structures have a Shore D hardness of about 40 to 100.

In some exemplary embodiments, the film and the plurality of gripping structures have a Shore A hardness of greater than about 90.

In some exemplary embodiments, a pitch between adjacent gripping structures is from 150 μm to 4,000 μm.

In some exemplary embodiments, at least a portion of the plurality of gripping structures have different heights.

In some exemplary embodiments, at least a portion of the plurality of gripping structures have different maximum cross-sectional dimensions.

In some exemplary embodiments, the thermoplastic coating comprises at least one of a polyolefin, a polyacrylate, a polyester, a polyamide, a polyimide, a polycarbonate, a polyurethane, a fluoropolymer, a copolymer of an olefin and an α,β-unsaturated carbonyl, a synthetic rubber, a thermoplastic elastomer, or combinations thereof, and wherein the thermoplastic coating has a basis weight of 10 g/m² to 100 g/m².

In some exemplary embodiments, the reinforcement comprises a mesh structure, a nonwoven structure, a film structure, or combinations thereof.

In some exemplary embodiments, the reinforcement comprises at least one of a polymer or a fiberglass, and wherein the reinforcement has a basis weight of 10 g/m² to 200 g/m².

In some exemplary embodiments, the multilayer structure has a width of 0.6 m to 2 m, a length of 9 m to 100 m, and a thickness of 125 μm to 2,500 μm.

In some exemplary embodiments, the thermoplastic coating is coextruded and comprises a first coextruded layer that includes a U.V. protective component and a second coextruded layer.

In some exemplary embodiments, the plurality of gripping structures are disposed on at least 50% of the thermoplastic coating at a density of 15 to 10,000 gripping structures per square centimeter.

In some exemplary embodiments, the plurality of gripping structures are positioned on 1% to 50% of the thermoplastic coating at a density of 15 to 10,000 gripping structures per square centimeter.

In some exemplary embodiments, the plurality of gripping structures are positioned on 50% to 100% of the thermoplastic coating at a density of 15 to 10,000 gripping structures per square centimeter.

In some exemplary embodiments, the multilayer structure further comprises a bottom coating adhered to the second reinforcement surface.

In some exemplary embodiments, the bottom coating is a coextruded coating comprising a thermoplastic elastomer extrudate and a polyolefin extrudate, wherein the bottom coating has a basis weight of 10 g/m² to 80 g/m², and wherein the polyolefin extrudate is adhered to the second reinforcement surface.

In some exemplary embodiments, the multilayer structure further comprises a bottom coating, and adhesive coating, and an optional release liner. The bottom coating is adhered to the second reinforcement surface. The adhesive coating is adhered to the bottom coating opposite the second reinforcement surface. The optional release liner is optionally adhered to a surface of the adhesive coating opposite the bottom coating.

In some exemplary embodiments, the bottom coating is a coextruded coating comprising a thermoplastic elastomer extrudate and a polyolefin extrudate, wherein the bottom coating has a basis weight of 10 g/m² to 80 g/m², and wherein the polyolefin extrudate is adhered to the second reinforcement surface.

In some exemplary embodiments, the multilayer structure further comprises an adhesive coating adhered to the second reinforcement surface and an optional release liner optionally adhered to a surface of the adhesive coating opposite the second reinforcement surface.

In some exemplary embodiments, the multilayer structure further comprises a first adhesive coating, a second adhesive coating, and an optional liner, and the reinforcement comprises a glass mat. The first adhesive coating is adhered to the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the multilayer structure further comprises a first adhesive coating, a glass mat, a second adhesive coating, and an optional liner. The first adhesive coating is adhered to the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the multilayer structure further comprises a bottom coating, a first adhesive coating, a second adhesive coating, and an optional release liner, and the reinforcement comprises a glass mat. The bottom coating is adhered to the second reinforcement surface. The first adhesive coating is adhered to the bottom coating opposite the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the multilayer structure further comprises a bottom coating, a first adhesive coating, a glass mat, a second adhesive coating, and an optional release liner. The bottom coating is adhered to the second reinforcement surface. The first adhesive coating is adhered to the bottom coating opposite the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the first adhesive coating comprises asphalt.

In some exemplary embodiments, the first adhesive coating comprises a non-asphaltic coating that includes butyl rubber.

In some exemplary embodiments, the first adhesive coating comprises a non-asphaltic acrylic adhesive coating.

In some exemplary embodiments, the second adhesive coating comprises asphalt.

In some exemplary embodiments, the second adhesive coating comprises a non-asphaltic coating that includes butyl rubber.

In some exemplary embodiments, the second adhesive coating comprises a non-asphaltic acrylic adhesive coating.

In some exemplary embodiments, the multilayer structure further comprises at least one of a coating layer or an adhesive layer, where the at least one of the coating layer or the adhesive layer are positioned between the first reinforcement surface and the second film surface.

In some exemplary embodiments, the multilayer structure further comprises comprises an optional coating layer positioned below the reinforcement.

In some exemplary embodiments, the multilayer structure further comprises an optional coating layer positioned below the reinforcement. The multilayer structure further comprises an adhesive coating positioned below the optional coating layer and an optional release liner positioned below the adhesive coating.

In some exemplary embodiments, the multilayer structure further comprises an optional coating layer positioned below the reinforcement. The multilayer structure further comprises a second coating layer positioned below the optional coating layer, a second reinforcement positioned below second coating layer, an adhesive coating positioned below the second reinforcement, and an optional release liner positioned below the adhesive coating.

In accordance with one aspect of the present disclosure, a multilayer structure (e.g., a construction membrane, a roofing membrane, a roofing underlayment, etc.) is provided. The multilayer structure includes a reinforcement having a first reinforcement surface and a second reinforcement surface, a film having a first film surface and a second film surface, and a plurality of gripping structures. The plurality of gripping structures are disposed on at least a portion of the first film surface.

In some exemplary embodiments, the multilayer structure has at least one of the following: a coefficient of friction between about 1.2 and about 1.8 when tested in dry conditions using COF method 1, a coefficient of friction of between about 0.8 and about 1.5 when tested in wet conditions using COF method 1, and a coefficient of friction of between about 0.5 and about 1.2 when tested in sawdust conditions using COF method 1.

In some exemplary embodiments, the multilayer structure has at least two of the following: a coefficient of friction between about 1.2 and about 1.8 when tested in dry conditions using COF method 1, a coefficient of friction of between about 0.8 and about 1.5 when tested in wet conditions using COF method 1, and a coefficient of friction of between about 0.5 and about 1.2 when tested in sawdust conditions using COF method 1.

In some exemplary embodiments, the multilayer structure has each of the following: a coefficient of friction between about 1.2 and about 1.8 when tested in dry conditions using COF method 1, a coefficient of friction of between about 0.8 and about 1.5 when tested in wet conditions using COF method 1, and a coefficient of friction of between about 0.5 and about 1.2 when tested in sawdust conditions using COF method 1.

In some exemplary embodiments, the coefficient of friction of the multilayer structure is between about 1.3 and about 1.6 when tested in dry conditions using COF method 1.

In some exemplary embodiment, the coefficient of friction of the multilayer structure is between about 0.9 and 1.41 when tested in wet conditions using COF method 1.

In some exemplary embodiments, the coefficient of friction of the multilayer structure is between about 0.55 and 0.92 when tested in sawdust conditions using COF method 1.

In some exemplary embodiments, the multilayer structure has at least one of the following: a coefficient of friction of greater than or equal to 1.2 when tested in dry conditions using COF method 1, a coefficient of friction of greater than or equal to 0.8 when tested in wet conditions using COF method 1, and a coefficient of friction of greater than or equal to 0.5 when tested in sawdust conditions using COF method 1.

In some exemplary embodiments, the multilayer structure has at least two of the following: a coefficient of friction of greater than or equal to 1.2 when tested in dry conditions using COF method 1, a coefficient of friction of greater than or equal to 0.8 when tested in wet conditions using COF method 1, and a coefficient of friction of greater than or equal to 0.5 when tested in sawdust conditions using COF method 1.

In some exemplary embodiments, the multilayer structure has each of the following: a coefficient of friction of greater than or equal to 1.2 when tested in dry conditions using COF method 1, a coefficient of friction of greater than or equal to 0.8 when tested in wet conditions using COF method 1, and a coefficient of friction of greater than or equal to 0.5 when tested in sawdust conditions using COF method 1.

In some exemplary embodiments, the coefficient of friction of the multilayer structure is greater than or equal to 1.3 when tested in dry conditions using COF method 1.

In some exemplary embodiments, the coefficient of friction of the multilayer structure is greater than or equal to 1.4 when tested in dry conditions using COF method 1.

In some exemplary embodiments, the coefficient of friction of the multilayer structure is greater than or equal to 1.5 when tested in dry conditions using COF method 1.

In some exemplary embodiments, the coefficient of friction of the multilayer structure is greater than or equal to 0.9 when tested in wet conditions using COF method 1.

In some exemplary embodiments, the coefficient of friction of the multilayer structure is greater than or equal to 1.05 when tested in wet conditions using COF method 1.

In some exemplary embodiments, the coefficient of friction of the multilayer structure is greater than or equal to 1.2 when tested in sawdust conditions using COF method 1.

In some exemplary embodiments, the coefficient of friction of the multilayer structure is greater than or equal to 0.55 when tested in sawdust conditions using COF method 1.

In some exemplary embodiments, the coefficient of friction of the multilayer structure is greater than or equal to 0.7 when tested in dry conditions using COF method 1.

In some exemplary embodiments, the coefficient of friction of the multilayer structure is greater than or equal to 0.8 when tested in sawdust conditions using COF method 1.

In some exemplary embodiments, the multilayer structure has a retention rate of greater than or equal to 65% in wet conditions when tested using COF method 1.

In some exemplary embodiments, the multilayer structure has a retention rate of greater than or equal to 70% in wet conditions when tested using COF method 1.

In some exemplary embodiments, the multilayer structure has a retention rate of greater than or equal to 75% in wet conditions when tested using COF method 1.

In some exemplary embodiments, the multilayer structure has a retention rate of greater than or equal to 90% in wet conditions when tested using COF method 1.

In some exemplary embodiments, the multilayer structure has a retention rate of greater than or equal to 35% in sawdust conditions when tested using COF method 1.

In some exemplary embodiments, the multilayer structure has a retention rate of greater than or equal to 50% in sawdust conditions when tested using COF method 1.

In some exemplary embodiments, the multilayer structure has a retention rate of greater than or equal to 55% in sawdust conditions when tested using COF method 1.

In some exemplary embodiments, the multilayer structure has a retention rate of greater than or equal to 60% in sawdust conditions when tested using COF method 1.

In some exemplary embodiments, the plurality of gripping structures are disposed on at least a portion of the first film surface at a density of 15 to 10,000 gripping structures per square centimeter.

In some exemplary embodiments, each gripping structure has a height of 10 μm to 600 μm and a maximum cross-sectional dimension of 25 μm to 1,000 μm.

In some exemplary embodiments, the plurality of gripping structures have a contact area of 5% to 15%.

In some exemplary embodiments, the plurality of gripping structures have a contact area of 13%.

In some exemplary embodiments, the multilayer structure has a tensile strength of greater than or equal to 25 lbf.

In some exemplary embodiments, the multilayer structure has a notched tear strength of greater than or equal to 20 lbf.

In some exemplary embodiments, the multilayer structure is a self-adhered underlayment having a tensile strength of greater than or equal to 25 lbf and a notched tear strength of greater than or equal to 20 lbf.

In some exemplary embodiments, the multilayer structure has a tensile strength of greater than or equal to 20 lbf.

In some exemplary embodiments, the multilayer structure has a trapezoidal tear strength of greater than or equal to 15 lbf.

In some exemplary embodiments, the multilayer structure is a synthetic underlayment having a tensile strength of greater than or equal to 20 lbf and a trapezoidal tear strength of greater than or equal to 15 lbf.

In some exemplary embodiments, the film and the plurality of gripping structures have a Shore D hardness of about 40 to 100.

In some exemplary embodiments, the film and the plurality of gripping structures have a Shore A hardness of greater than about 90.

In some exemplary embodiments, a pitch between adjacent gripping structures is from 150 μm to 4,000 μm.

In some exemplary embodiments, at least a portion of the plurality of gripping structures have different heights.

In some exemplary embodiments, at least a portion of the plurality of gripping structures have different maximum cross-sectional dimensions.

In some exemplary embodiments, the film comprises at least one of a polyolefin, a polyester, a polyamide, a polyimide, a polycarbonate, a polyurethane, a fluoropolymer, a copolymer of an olefin and an α,β-unsaturated carbonyl, a synthetic rubber, or a thermoplastic elastomer.

In some exemplary embodiments, the reinforcement comprises a mesh structure, a nonwoven structure, a film structure, or combinations thereof.

In some exemplary embodiments, the multilayer structure further comprises a bonding material, wherein the bonding material adheres the first reinforcement surface to the second film surface.

In some exemplary embodiments, the bonding material comprises an adhesive, and wherein the adhesive has a basis weight of 3 g/m² to 15 g/m².

In some exemplary embodiments, the bonding material comprises a thermoplastic coating, wherein the thermoplastic coating comprises at least one of a polyolefin, a polyacrylate, a polyester, a polyamide, a polyimide, a polycarbonate, a polyurethane, a fluoropolymer, a copolymer of an olefin and an α,β-unsaturated carbonyl, a synthetic rubber, a thermoplastic elastomer, or combinations thereof, and wherein the thermoplastic coating has a basis weight of 6 g/m² to 75 g/m².

In some exemplary embodiments, the reinforcement comprises at least one of a polymer or a fiberglass, and wherein the reinforcement has a basis weight of 10 g/m² to 200 g/m².

In some exemplary embodiments, the multilayer structure has a width of 0.6 m to 2 m, a length of 9 m to 100 m, and a thickness of 125 μm to 2,500 μm.

In some exemplary embodiments, the film is a coextruded film comprising a first coextruded layer that includes a U.V. protective component and a second coextruded layer.

In some exemplary embodiments, the plurality of gripping structures are disposed on at least 50% of the first film surface at a density of 15 to 10,000 gripping structures per square centimeter.

In some exemplary embodiments, the plurality of gripping structures are disposed on 50% to 100% of the first film surface at a density of 15 to 10,000 gripping structures per square centimeter.

In some exemplary embodiments, the multilayer structure further comprises a bottom coating adhered to the second reinforcement surface.

In some exemplary embodiments, the bottom coating is a coextruded coating comprising a thermoplastic elastomer extrudate and a polyolefin extrudate, wherein the bottom coating has a basis weight of 10 g/m² to 80 g/m², and wherein the polyolefin extrudate is adhered to the second reinforcement surface.

In some exemplary embodiments, the multilayer structure further comprises a bottom film adhered to the bottom coating opposite the second reinforcement surface, wherein the bottom coating has a basis weight of 10 g/m² to 80 g/m², and wherein the bottom film comprises at least one of a polyolefin, ethylene-vinyl acetate copolymer, ethylene-methyl acrylate copolymer, or a thermoplastic elastomer.

In some exemplary embodiments, the multilayer structure further comprises a bottom coating, and adhesive coating, and an optional release liner. The bottom coating is adhered to the second reinforcement surface. The adhesive coating is adhered to the bottom coating opposite the second reinforcement surface. The optional release liner is optionally adhered to a surface of the adhesive coating opposite the bottom coating.

In some exemplary embodiments, the bottom coating is a coextruded coating comprising a thermoplastic elastomer extrudate and a polyolefin extrudate, wherein the bottom coating has a basis weight of 10 g/m² to 80 g/m², and wherein the polyolefin extrudate is adhered to the second reinforcement surface.

In some exemplary embodiments, the multilayer structure further comprises an adhesive coating adhered to the second reinforcement surface and an optional release liner optionally adhered to a surface of the adhesive coating opposite the second reinforcement surface.

In some exemplary embodiments, the multilayer structure further comprises a first adhesive coating, a second adhesive coating, and an optional liner, and the reinforcement comprises a glass mat. The first adhesive coating is adhered to the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the multilayer structure further comprises a first adhesive coating, a glass mat, a second adhesive coating, and an optional liner. The first adhesive coating is adhered to the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the multilayer structure further comprises a bottom coating, a first adhesive coating, a second adhesive coating, and an optional release liner, and the reinforcement comprises a glass mat. The bottom coating is adhered to the second reinforcement surface. The first adhesive coating is adhered to the bottom coating opposite the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the multilayer structure further comprises a bottom coating, a first adhesive coating, a glass mat, a second adhesive coating, and an optional release liner. The bottom coating is adhered to the second reinforcement surface. The first adhesive coating is adhered to the bottom coating opposite the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the first adhesive coating comprises a non-asphaltic coating that includes butyl rubber.

In some exemplary embodiments, the first adhesive coating comprises a non-asphaltic acrylic adhesive coating.

In some exemplary embodiments, the second adhesive coating comprises asphalt.

In some exemplary embodiments, the second adhesive coating comprises a non-asphaltic coating that includes butyl rubber.

In some exemplary embodiments, the second adhesive coating comprises a non-asphaltic acrylic adhesive coating.

In some exemplary embodiments, the multilayer structure further comprises at least one of a coating layer or an adhesive layer, where the at least one of the coating layer or the adhesive layer are positioned between the first reinforcement surface and the second film surface.

In some exemplary embodiments, the multilayer structure further comprises at least one of a coating layer or an adhesive layer positioned between the film and the reinforcement, and further comprises an optional coating layer positioned below the reinforcement.

In some exemplary embodiments, the multilayer structure further comprises at least one of a coating layer or an adhesive layer positioned between the film and the reinforcement, and further comprises an optional coating layer positioned below the reinforcement. The multilayer structure further comprises a adhesive coating positioned below the optional coating layer and an optional release liner positioned below the adhesive coating.

In some exemplary embodiments, the multilayer structure further comprises a coating layer positioned between the film and the reinforcement, and further comprises an adhesive coating and an optional release liner positioned below the reinforcement.

In some exemplary embodiments, the multilayer structure further comprises at least one of a coating layer or an adhesive layer positioned between the film and the reinforcement, and further comprises an optional coating layer positioned below the reinforcement. The multilayer structure further comprises a second coating layer positioned below the optional coating layer, a second reinforcement positioned below second coating layer, an adhesive coating positioned below the second reinforcement, and an optional release liner positioned below the adhesive coating.

In accordance with one aspect of the present disclosure, a multilayer structure (e.g., a construction membrane, a roofing membrane, a roofing underlayment, etc.) is provided. The multilayer structure includes a reinforcement having a first reinforcement surface and a second reinforcement surface, and a thermoplastic coating that includes a plurality of gripping structures. The thermoplastic coating is adhered to the first reinforcement surface.

In some exemplary embodiments, the multilayer structure has at least one of the following: a coefficient of friction between about 1.2 and about 1.8 when tested in dry conditions using COF method 1, a coefficient of friction of between about 0.8 and about 1.5 when tested in wet conditions using COF method 1, and a coefficient of friction of between about 0.5 and about 1.2 when tested in sawdust conditions using COF method 1.

In some exemplary embodiments, the multilayer structure has at least two of the following: a coefficient of friction between about 1.2 and about 1.8 when tested in dry conditions using COF method 1, a coefficient of friction of between about 0.8 and about 1.5 when tested in wet conditions using COF method 1, and a coefficient of friction of between about 0.5 and about 1.2 when tested in sawdust conditions using COF method 1.

In some exemplary embodiments, the multilayer structure has each of the following: a coefficient of friction between about 1.2 and about 1.8 when tested in dry conditions using COF method 1, a coefficient of friction of between about 0.8 and about 1.5 when tested in wet conditions using COF method 1, and a coefficient of friction of between about 0.5 and about 1.2 when tested in sawdust conditions using COF method 1.

In some exemplary embodiments, the coefficient of friction of the multilayer structure is between about 1.3 and about 1.6 when tested in dry conditions using COF method 1.

In some exemplary embodiment, the coefficient of friction of the multilayer structure is between about 0.9 and 1.41 when tested in wet conditions using COF method 1.

In some exemplary embodiments, the coefficient of friction of the multilayer structure is between about 0.55 and 0.92 when tested in sawdust conditions using COF method 1.

In some exemplary embodiments, the multilayer structure has at least one of the following: a coefficient of friction of greater than or equal to 1.2 when tested in dry conditions using COF method 1, a coefficient of friction of greater than or equal to 0.8 when tested in wet conditions using COF method 1, and a coefficient of friction of greater than or equal to 0.5 when tested in sawdust conditions using COF method 1.

In some exemplary embodiments, the multilayer structure has at least two of the following: a coefficient of friction of greater than or equal to 1.2 when tested in dry conditions using COF method 1, a coefficient of friction of greater than or equal to 0.8 when tested in wet conditions using COF method 1, and a coefficient of friction of greater than or equal to 0.5 when tested in sawdust conditions using COF method 1.

In some exemplary embodiments, the multilayer structure has each of the following: a coefficient of friction of greater than or equal to 1.2 when tested in dry conditions using COF method 1, a coefficient of friction of greater than or equal to 0.8 when tested in wet conditions using COF method 1, and a coefficient of friction of greater than or equal to 0.5 when tested in sawdust conditions using COF method 1.

In some exemplary embodiments, the coefficient of friction of the multilayer structure is greater than or equal to 1.3 when tested in dry conditions using COF method 1.

In some exemplary embodiments, the coefficient of friction of the multilayer structure is greater than or equal to 1.4 when tested in dry conditions using COF method 1.

In some exemplary embodiments, the coefficient of friction of the multilayer structure is greater than or equal to 1.5 when tested in dry conditions using COF method 1.

In some exemplary embodiments, the coefficient of friction of the multilayer structure is greater than or equal to 0.9 when tested in wet conditions using COF method 1.

In some exemplary embodiments, the coefficient of friction of the multilayer structure is greater than or equal to 1.05 when tested in wet conditions using COF method 1.

In some exemplary embodiments, the coefficient of friction of the multilayer structure is greater than or equal to 1.2 when tested in wet conditions using COF method 1.

In some exemplary embodiments, the coefficient of friction of the multilayer structure is greater than or equal to 0.55 when tested in sawdust conditions using COF method 1.

In some exemplary embodiments, the coefficient of friction of the multilayer structure is greater than or equal to 0.7 when tested in sawdust conditions using COF method 1.

In some exemplary embodiments, the coefficient of friction of the multilayer structure is greater than or equal to 0.8 when tested in sawdust conditions using COF method 1.

In some exemplary embodiments, the multilayer structure has a retention rate of greater than or equal to 65% in wet conditions when tested using COF method 1.

In some exemplary embodiments, the multilayer structure has a retention rate of greater than or equal to 70% in wet conditions when tested using COF method 1.

In some exemplary embodiments, the multilayer structure has a retention rate of greater than or equal to 75% in wet conditions when tested using COF method 1.

In some exemplary embodiments, the multilayer structure has a retention rate of greater than or equal to 90% in wet conditions when tested using COF method 1.

In some exemplary embodiments, the multilayer structure has a retention rate of greater than or equal to 35% in sawdust conditions when tested using COF method 1.

In some exemplary embodiments, the multilayer structure has a retention rate of greater than or equal to 50% in sawdust conditions when tested using COF method 1.

In some exemplary embodiments, the multilayer structure has a retention rate of greater than or equal to 55% in sawdust conditions when tested using COF method 1.

In some exemplary embodiments, the multilayer structure has a retention rate of greater than or equal to 60% in sawdust conditions when tested using COF method 1.

In some exemplary embodiments, each gripping structure has a height of 10 μm to 600 μm and a maximum cross-sectional dimension of 25 μm to 1,000 μm.

In some exemplary embodiments, the plurality of gripping structures are positioned on at least a portion of the thermoplastic coating at a density of 15 to 10,000 gripping structures per square centimeter.

In some exemplary embodiments, the plurality of gripping structures have a contact area of 5% to 15%.

In some exemplary embodiments, the plurality of gripping structures have a contact area of 13%.

In some exemplary embodiments, the multilayer structure has a tensile strength of greater than or equal to 25 lbf.

In some exemplary embodiments, the multilayer structure has a notched tear strength of greater than or equal to 20 lbf.

In some exemplary embodiments, the multilayer structure is a self-adhered underlayment having a tensile strength of greater than or equal to 25 lbf and a notched tear strength of greater than or equal to 20 lbf.

In some exemplary embodiments, the multilayer structure has a tensile strength of greater than or equal to 20 lbf.

In some exemplary embodiments, the multilayer structure has a trapezoidal tear strength of greater than or equal to 15 lbf.

In some exemplary embodiments, the multilayer structure is a synthetic underlayment having a tensile strength of greater than or equal to 20 lbf and a trapezoidal tear strength of greater than or equal to 15 lbf.

In some exemplary embodiments, the thermoplastic coating and the plurality of gripping structures have a Shore D hardness of about 40 to 100.

In some exemplary embodiments, the film and the plurality of gripping structures have a Shore A hardness of greater than about 90.

In some exemplary embodiments, a pitch between adjacent gripping structures is from 150 μm to 4,000 μm.

In some exemplary embodiments, at least a portion of the plurality of gripping structures have different heights.

In some exemplary embodiments, at least a portion of the plurality of gripping structures have different maximum cross-sectional dimensions.

In some exemplary embodiments, the thermoplastic coating comprises at least one of a polyolefin, a polyacrylate, a polyester, a polyamide, a polyimide, a polycarbonate, a polyurethane, a fluoropolymer, a copolymer of an olefin and an α,β-unsaturated carbonyl, a synthetic rubber, a thermoplastic elastomer, or combinations thereof, and wherein the thermoplastic coating has a basis weight of 10 g/m² to 100 g/m².

In some exemplary embodiments, the reinforcement comprises a mesh structure, a nonwoven structure, a film structure, or combinations thereof.

In some exemplary embodiments, the reinforcement comprises at least one of a polymer or a fiberglass, and wherein the reinforcement has a basis weight of 10 g/m² to 200 g/m².

In some exemplary embodiments, the multilayer structure has a width of 0.6 m to 2 m, a length of 9 m to 100 m, and a thickness of 125 μm to 2,500 μm.

In some exemplary embodiments, the thermoplastic coating is coextruded and comprises a first coextruded layer that includes a U.V. protective component and a second coextruded layer.

In some exemplary embodiments, the plurality of gripping structures are disposed on at least 50% of the thermoplastic coating at a density of 15 to 10,000 gripping structures per square centimeter.

In some exemplary embodiments, the plurality of gripping structures are positioned on 1% to 50% of the thermoplastic coating at a density of 15 to 10,000 gripping structures per square centimeter.

In some exemplary embodiments, the plurality of gripping structures are positioned on 50% to 100% of the thermoplastic coating at a density of 15 to 10,000 gripping structures per square centimeter.

In some exemplary embodiments, the multilayer structure further comprises a bottom coating adhered to the second reinforcement surface.

In some exemplary embodiments, the bottom coating is a coextruded coating comprising a thermoplastic elastomer extrudate and a polyolefin extrudate, wherein the bottom coating has a basis weight of 10 g/m² to 80 g/m², and wherein the polyolefin extrudate is adhered to the second reinforcement surface.

In some exemplary embodiments, the multilayer structure further comprises a bottom coating, and adhesive coating, and an optional release liner. The bottom coating is adhered to the second reinforcement surface. The adhesive coating is adhered to the bottom coating opposite the second reinforcement surface. The optional release liner is optionally adhered to a surface of the adhesive coating opposite the bottom coating.

In some exemplary embodiments, the bottom coating is a coextruded coating comprising a thermoplastic elastomer extrudate and a polyolefin extrudate, wherein the bottom coating has a basis weight of 10 g/m² to 80 g/m², and wherein the polyolefin extrudate is adhered to the second reinforcement surface.

In some exemplary embodiments, the multilayer structure further comprises an adhesive coating adhered to the second reinforcement surface and an optional release liner optionally adhered to a surface of the adhesive coating opposite the second reinforcement surface.

In some exemplary embodiments, the multilayer structure further comprises a first adhesive coating, a second adhesive coating, and an optional liner, and the reinforcement comprises a glass mat. The first adhesive coating is adhered to the second reinforcement surface.

The glass mat is at least partially impregnated with at least one of the first adhesive coating and the second adhesive coating. The optional release liner is optionally adhered to a surface of the second adhesive coating opposite the glass mat.

In some exemplary embodiments, the multilayer structure further comprises a first adhesive coating, a glass mat, a second adhesive coating, and an optional liner. The first adhesive coating is adhered to the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the multilayer structure further comprises a bottom coating, a first adhesive coating, a second adhesive coating, and an optional release liner, and the reinforcement comprises a glass mat. The bottom coating is adhered to the second reinforcement surface. The first adhesive coating is adhered to the bottom coating opposite the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the multilayer structure further comprises a bottom coating, a first adhesive coating, a glass mat, a second adhesive coating, and an optional release liner. The bottom coating is adhered to the second reinforcement surface. The first adhesive coating is adhered to the bottom coating opposite the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the first adhesive coating comprises asphalt.

In some exemplary embodiments, the first adhesive coating comprises a non-asphaltic coating that includes butyl rubber.

In some exemplary embodiments, the first adhesive coating comprises a non-asphaltic acrylic adhesive coating.

In some exemplary embodiments, the second adhesive coating comprises asphalt.

In some exemplary embodiments, the second adhesive coating comprises a non-asphaltic coating that includes butyl rubber.

In some exemplary embodiments, the second adhesive coating comprises a non-asphaltic acrylic adhesive coating.

In some exemplary embodiments, the multilayer structure further comprises at least one of a coating layer or an adhesive layer, where the at least one of the coating layer or the adhesive layer are positioned between the first reinforcement surface and the second film surface.

In some exemplary embodiments, the multilayer structure further comprises comprises an optional coating layer positioned below the reinforcement.

In some exemplary embodiments, the multilayer structure further comprises an optional coating layer positioned below the reinforcement. The multilayer structure further comprises an adhesive coating positioned below the optional coating layer and an optional release liner positioned below the adhesive coating.

In some exemplary embodiments, the multilayer structure further comprises an optional coating layer positioned below the reinforcement. The multilayer structure further comprises a second coating layer positioned below the optional coating layer, a second reinforcement positioned below second coating layer, an adhesive coating positioned below the second reinforcement, and an optional release liner positioned below the adhesive coating.

In accordance with one aspect of the present disclosure, a multilayer structure (e.g., a construction membrane, a roofing membrane, a roofing underlayment, etc.) is provided. The multilayer structure includes a reinforcement having a first reinforcement surface and a second reinforcement surface, a film having a first film surface and a second film surface, and a plurality of gripping structures. The plurality of gripping structures are disposed on at least a portion of the first film surface.

In some exemplary embodiments, the multilayer structure has at least one of the following: a coefficient of friction between about 1.5 and about 2.1 when tested in dry conditions using COF method 2 and a coefficient of friction of between about 1.2 and about 1.8 when tested in wet conditions using COF method 2.

In some exemplary embodiments, the multilayer structure has each of the following: a coefficient of friction between about 1.5 and about 2.1 when tested in dry conditions using COF method 2 and a coefficient of friction of between about 1.2 and about 1.8 when tested in wet conditions using COF method 2.

In some exemplary embodiments, the coefficient of friction of the multilayer structure is between about 1.7 and about 2.05 when tested in dry conditions using COF method 2.

In some exemplary embodiment, the coefficient of friction of the multilayer structure is between about 1.3 and 1.7 when tested in wet conditions using COF method 2.

In some exemplary embodiments, the multilayer structure has at least one of the following: a coefficient of friction of greater than or equal to 1.5 when tested in dry conditions using COF method 2 and a coefficient of friction of greater than or equal to 1.2 when tested in wet conditions using COF method 2.

In some exemplary embodiments, the multilayer structure has each of the following: a coefficient of friction of greater than or equal to 1.5 when tested in dry conditions using COF method 2 and a coefficient of friction of greater than or equal to 1.2 when tested in wet conditions using COF method 2.

In some exemplary embodiments, the coefficient of friction of the multilayer structure is greater than or equal to 1.85 when tested in dry conditions using COF method 2.

In some exemplary embodiments, the coefficient of friction of the multilayer structure is greater than or equal to 1.9 when tested in dry conditions using COF method 2.

In some exemplary embodiments, the coefficient of friction of the multilayer structure is greater than or equal to 1.95 when tested in dry conditions using COF method 2.

In some exemplary embodiments, the coefficient of friction of the multilayer structure is greater than or equal to 2 when tested in dry conditions using COF method 2.

In some exemplary embodiments, the coefficient of friction of the multilayer structure is greater than or equal to 1.3 when tested in wet conditions using COF method 2.

In some exemplary embodiments, the coefficient of friction of the multilayer structure is greater than or equal to 1.45 when tested in wet conditions using COF method 2.

In some exemplary embodiments, the coefficient of friction of the multilayer structure is greater than or equal to 1.5 when tested in wet conditions using COF method 2.

In some exemplary embodiments, the coefficient of friction of the multilayer structure is greater than or equal to 1.6 when tested in wet conditions using COF method 2.

In some exemplary embodiments, the multilayer structure has a retention rate of greater than or equal to 70% in wet conditions when tested using COF method 2.

In some exemplary embodiments, the multilayer structure has a retention rate of greater than or equal to 75% in wet conditions when tested using COF method 2.

In some exemplary embodiments, the multilayer structure has a retention rate of greater than or equal to 80% in wet conditions when tested using COF method 2.

In some exemplary embodiments, the multilayer structure has a retention rate of greater than or equal to 85% in wet conditions when tested using COF method 2.

In some exemplary embodiments, the plurality of gripping structures are disposed on at least a portion of the first film surface at a density of 15 to 10,000 gripping structures per square centimeter.

In some exemplary embodiments, each gripping structure has a height of 10 μm to 600 μm and a maximum cross-sectional dimension of 25 μm to 1,000 μm.

In some exemplary embodiments, the plurality of gripping structures have a contact area of 5% to 15%.

In some exemplary embodiments, the plurality of gripping structures have a contact area of 13%.

In some exemplary embodiments, the multilayer structure has a tensile strength of greater than or equal to 25 lbf.

In some exemplary embodiments, the multilayer structure has a notched tear strength of greater than or equal to 20 lbf.

In some exemplary embodiments, the multilayer structure is a self-adhered underlayment having a tensile strength of greater than or equal to 25 lbf and a notched tear strength of greater than or equal to 20 lbf.

In some exemplary embodiments, the multilayer structure has a tensile strength of greater than or equal to 20 lbf.

In some exemplary embodiments, the multilayer structure has a trapezoidal tear strength of greater than or equal to 15 lbf.

In some exemplary embodiments, the multilayer structure is a synthetic underlayment having a tensile strength of greater than or equal to 20 lbf and a trapezoidal tear strength of greater than or equal to 15 lbf.

In some exemplary embodiments, the film and the plurality of gripping structures have a Shore D hardness of about 40 to 100.

In some exemplary embodiments, the film and the plurality of gripping structures have a Shore A hardness of greater than about 90.

In some exemplary embodiments, a pitch between adjacent gripping structures is from 150 μm to 4,000 μm.

In some exemplary embodiments, at least a portion of the plurality of gripping structures have different heights.

In some exemplary embodiments, at least a portion of the plurality of gripping structures have different maximum cross-sectional dimensions.

In some exemplary embodiments, the film comprises at least one of a polyolefin, a polyester, a polyamide, a polyimide, a polycarbonate, a polyurethane, a fluoropolymer, a copolymer of an olefin and an α,β-unsaturated carbonyl, a synthetic rubber, or a thermoplastic elastomer.

In some exemplary embodiments, the reinforcement comprises a mesh structure, a nonwoven structure, a film structure, or combinations thereof.

In some exemplary embodiments, the multilayer structure further comprises a bonding material, wherein the bonding material adheres the first reinforcement surface to the second film surface.

In some exemplary embodiments, the bonding material comprises an adhesive, and wherein the adhesive has a basis weight of 3 g/m² to 15 g/m².

In some exemplary embodiments, the bonding material comprises a thermoplastic coating, wherein the thermoplastic coating comprises at least one of a polyolefin, a polyacrylate, a polyester, a polyamide, a polyimide, a polycarbonate, a polyurethane, a fluoropolymer, a copolymer of an olefin and an α,β-unsaturated carbonyl, a synthetic rubber, a thermoplastic elastomer, or combinations thereof, and wherein the thermoplastic coating has a basis weight of 6 g/m² to 75 g/m².

In some exemplary embodiments, the reinforcement comprises at least one of a polymer or a fiberglass, and wherein the reinforcement has a basis weight of 10 g/m² to 200 g/m².

In some exemplary embodiments, the multilayer structure has a width of 0.6 m to 2 m, a length of 9 m to 100 m, and a thickness of 125 μm to 2,500 μm.

In some exemplary embodiments, the film is a coextruded film comprising a first coextruded layer that includes a U.V. protective component and a second coextruded layer.

In some exemplary embodiments, the plurality of gripping structures are disposed on at least 50% of the first film surface at a density of 15 to 10,000 gripping structures per square centimeter.

In some exemplary embodiments, the plurality of gripping structures are disposed on 50% to 100% of the first film surface at a density of 15 to 10,000 gripping structures per square centimeter.

In some exemplary embodiments, the multilayer structure further comprises a bottom coating adhered to the second reinforcement surface.

In some exemplary embodiments, the bottom coating is a coextruded coating comprising a thermoplastic elastomer extrudate and a polyolefin extrudate, wherein the bottom coating has a basis weight of 10 g/m² to 80 g/m², and wherein the polyolefin extrudate is adhered to the second reinforcement surface.

In some exemplary embodiments, the multilayer structure further comprises a bottom film adhered to the bottom coating opposite the second reinforcement surface, wherein the bottom coating has a basis weight of 10 g/m² to 80 g/m², and wherein the bottom film comprises at least one of a polyolefin, ethylene-vinyl acetate copolymer, ethylene-methyl acrylate copolymer, or a thermoplastic elastomer.

In some exemplary embodiments, the multilayer structure further comprises a bottom coating, and adhesive coating, and an optional release liner. The bottom coating is adhered to the second reinforcement surface. The adhesive coating is adhered to the bottom coating opposite the second reinforcement surface. The optional release liner is optionally adhered to a surface of the adhesive coating opposite the bottom coating.

In some exemplary embodiments, the bottom coating is a coextruded coating comprising a thermoplastic elastomer extrudate and a polyolefin extrudate, wherein the bottom coating has a basis weight of 10 g/m² to 80 g/m², and wherein the polyolefin extrudate is adhered to the second reinforcement surface.

In some exemplary embodiments, the multilayer structure further comprises an adhesive coating adhered to the second reinforcement surface and an optional release liner optionally adhered to a surface of the adhesive coating opposite the second reinforcement surface.

In some exemplary embodiments, the multilayer structure further comprises a first adhesive coating, a second adhesive coating, and an optional liner, and the reinforcement comprises a glass mat. The first adhesive coating is adhered to the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the multilayer structure further comprises a first adhesive coating, a glass mat, a second adhesive coating, and an optional liner. The first adhesive coating is adhered to the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the multilayer structure further comprises a bottom coating, a first adhesive coating, a second adhesive coating, and an optional release liner, and the reinforcement comprises a glass mat. The bottom coating is adhered to the second reinforcement surface. The first adhesive coating is adhered to the bottom coating opposite the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the multilayer structure further comprises a bottom coating, a first adhesive coating, a glass mat, a second adhesive coating, and an optional release liner. The bottom coating is adhered to the second reinforcement surface. The first adhesive coating is adhered to the bottom coating opposite the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the first adhesive coating comprises a non-asphaltic coating that includes butyl rubber.

In some exemplary embodiments, the first adhesive coating comprises a non-asphaltic acrylic adhesive coating.

In some exemplary embodiments, the second adhesive coating comprises asphalt.

In some exemplary embodiments, the second adhesive coating comprises a non-asphaltic coating that includes butyl rubber.

In some exemplary embodiments, the second adhesive coating comprises a non-asphaltic acrylic adhesive coating.

In some exemplary embodiments, the multilayer structure further comprises at least one of a coating layer or an adhesive layer, where the at least one of the coating layer or the adhesive layer are positioned between the first reinforcement surface and the second film surface.

In some exemplary embodiments, the multilayer structure further comprises at least one of a coating layer or an adhesive layer positioned between the film and the reinforcement, and further comprises an optional coating layer positioned below the reinforcement.

In some exemplary embodiments, the multilayer structure further comprises at least one of a coating layer or an adhesive layer positioned between the film and the reinforcement, and further comprises an optional coating layer positioned below the reinforcement. The multilayer structure further comprises a adhesive coating positioned below the optional coating layer and an optional release liner positioned below the adhesive coating.

In some exemplary embodiments, the multilayer structure further comprises a coating layer positioned between the film and the reinforcement, and further comprises an adhesive coating and an optional release liner positioned below the reinforcement.

In some exemplary embodiments, the multilayer structure further comprises at least one of a coating layer or an adhesive layer positioned between the film and the reinforcement, and further comprises an optional coating layer positioned below the reinforcement. The multilayer structure further comprises a second coating layer positioned below the optional coating layer, a second reinforcement positioned below second coating layer, an adhesive coating positioned below the second reinforcement, and an optional release liner positioned below the adhesive coating.

In accordance with one aspect of the present disclosure, a multilayer structure (e.g., a construction membrane, a roofing membrane, a roofing underlayment, etc.) is provided. The multilayer structure includes a reinforcement having a first reinforcement surface and a second reinforcement surface, and a thermoplastic coating that includes a plurality of gripping structures. The thermoplastic coating is adhered to the first reinforcement surface.

In some exemplary embodiments, the multilayer structure has at least one of the following: a coefficient of friction between about 1.5 and about 2.1 when tested in dry conditions using COF method 2 and a coefficient of friction of between about 1.2 and about 1.8 when tested in wet conditions using COF method 2.

In some exemplary embodiments, the multilayer structure has each of the following: a coefficient of friction between about 1.5 and about 2.1 when tested in dry conditions using COF method 2 and a coefficient of friction of between about 1.2 and about 1.8 when tested in wet conditions using COF method 2.

In some exemplary embodiments, the coefficient of friction of the multilayer structure is between about 1.7 and about 2.05 when tested in dry conditions using COF method 2.

In some exemplary embodiment, the coefficient of friction of the multilayer structure is between about 1.3 and 1.7 when tested in wet conditions using COF method 2.

In some exemplary embodiments, the multilayer structure has at least one of the following: a coefficient of friction of greater than or equal to 1.5 when tested in dry conditions using COF method 2 and a coefficient of friction of greater than or equal to 1.2 when tested in wet conditions using COF method 2.

In some exemplary embodiments, the multilayer structure has each of the following: a coefficient of friction of greater than or equal to 1.5 when tested in dry conditions using COF method 2 and a coefficient of friction of greater than or equal to 1.2 when tested in wet conditions using COF method 2.

In some exemplary embodiments, the coefficient of friction of the multilayer structure is greater than or equal to 1.85 when tested in dry conditions using COF method 2.

In some exemplary embodiments, the coefficient of friction of the multilayer structure is greater than or equal to 1.9 when tested in dry conditions using COF method 2.

In some exemplary embodiments, the coefficient of friction of the multilayer structure is greater than or equal to 1.95 when tested in dry conditions using COF method 2.

In some exemplary embodiments, the coefficient of friction of the multilayer structure is greater than or equal to 2 when tested in dry conditions using COF method 2.

In some exemplary embodiments, the coefficient of friction of the multilayer structure is greater than or equal to 1.3 when tested in wet conditions using COF method 2.

In some exemplary embodiments, the coefficient of friction of the multilayer structure is greater than or equal to 1.45 when tested in wet conditions using COF method 2.

In some exemplary embodiments, the coefficient of friction of the multilayer structure is greater than or equal to 1.5 when tested in wet conditions using COF method 2.

In some exemplary embodiments, the coefficient of friction of the multilayer structure is greater than or equal to 1.6 when tested in wet conditions using COF method 2.

In some exemplary embodiments, the multilayer structure has a retention rate of greater than or equal to 70% in wet conditions when tested using COF method 2.

In some exemplary embodiments, the multilayer structure has a retention rate of greater than or equal to 75% in wet conditions when tested using COF method 2.

In some exemplary embodiments, the multilayer structure has a retention rate of greater than or equal to 80% in wet conditions when tested using COF method 2.

In some exemplary embodiments, the multilayer structure has a retention rate of greater than or equal to 85% in wet conditions when tested using COF method 2.

In some exemplary embodiments, each gripping structure has a height of 10 μm to 600 μm and a maximum cross-sectional dimension of 25 μm to 1,000 μm.

In some exemplary embodiments, the plurality of gripping structures are positioned on at least a portion of the thermoplastic coating at a density of 15 to 10,000 gripping structures per square centimeter.

In some exemplary embodiments, the plurality of gripping structures have a contact area of 5% to 15%.

In some exemplary embodiments, the plurality of gripping structures have a contact area of 13%.

In some exemplary embodiments, the multilayer structure has a tensile strength of greater than or equal to 25 lbf.

In some exemplary embodiments, the multilayer structure has a notched tear strength of greater than or equal to 20 lbf.

In some exemplary embodiments, the multilayer structure is a self-adhered underlayment having a tensile strength of greater than or equal to 25 lbf and a notched tear strength of greater than or equal to 20 lbf.

In some exemplary embodiments, the multilayer structure has a tensile strength of greater than or equal to 20 lbf.

In some exemplary embodiments, the multilayer structure has a trapezoidal tear strength of greater than or equal to 15 lbf.

In some exemplary embodiments, the multilayer structure is a synthetic underlayment having a tensile strength of greater than or equal to 20 lbf and a trapezoidal tear strength of greater than or equal to 15 lbf.

In some exemplary embodiments, the thermoplastic coating and the plurality of gripping structures have a Shore D hardness of about 40 to 100.

In some exemplary embodiments, the film and the plurality of gripping structures have a Shore A hardness of greater than about 90.

In some exemplary embodiments, a pitch between adjacent gripping structures is from 150 μm to 4,000 μm.

In some exemplary embodiments, at least a portion of the plurality of gripping structures have different heights.

In some exemplary embodiments, at least a portion of the plurality of gripping structures have different maximum cross-sectional dimensions.

In some exemplary embodiments, the thermoplastic coating comprises at least one of a polyolefin, a polyacrylate, a polyester, a polyamide, a polyimide, a polycarbonate, a polyurethane, a fluoropolymer, a copolymer of an olefin and an α,β-unsaturated carbonyl, a synthetic rubber, a thermoplastic elastomer, or combinations thereof, and wherein the thermoplastic coating has a basis weight of 10 g/m² to 100 g/m².

In some exemplary embodiments, the reinforcement comprises a mesh structure, a nonwoven structure, a film structure, or combinations thereof.

In some exemplary embodiments, the reinforcement comprises at least one of a polymer or a fiberglass, and wherein the reinforcement has a basis weight of 10 g/m² to 200 g/m².

In some exemplary embodiments, the multilayer structure has a width of 0.6 m to 2 m, a length of 9 m to 100 m, and a thickness of 125 μm to 2,500 μm.

In some exemplary embodiments, the thermoplastic coating is coextruded and comprises a first coextruded layer that includes a U.V. protective component and a second coextruded layer.

In some exemplary embodiments, the plurality of gripping structures are disposed on at least 50% of the thermoplastic coating at a density of 15 to 10,000 gripping structures per square centimeter.

In some exemplary embodiments, the plurality of gripping structures are positioned on 1% to 50% of the thermoplastic coating at a density of 15 to 10,000 gripping structures per square centimeter.

In some exemplary embodiments, the plurality of gripping structures are positioned on 50% to 100% of the thermoplastic coating at a density of 15 to 10,000 gripping structures per square centimeter.

In some exemplary embodiments, the multilayer structure further comprises a bottom coating adhered to the second reinforcement surface.

In some exemplary embodiments, the bottom coating is a coextruded coating comprising a thermoplastic elastomer extrudate and a polyolefin extrudate, wherein the bottom coating has a basis weight of 10 g/m² to 80 g/m², and wherein the polyolefin extrudate is adhered to the second reinforcement surface.

In some exemplary embodiments, the multilayer structure further comprises a bottom coating, and adhesive coating, and an optional release liner. The bottom coating is adhered to the second reinforcement surface. The adhesive coating is adhered to the bottom coating opposite the second reinforcement surface. The optional release liner is optionally adhered to a surface of the adhesive coating opposite the bottom coating.

In some exemplary embodiments, the bottom coating is a coextruded coating comprising a thermoplastic elastomer extrudate and a polyolefin extrudate, wherein the bottom coating has a basis weight of 10 g/m² to 80 g/m², and wherein the polyolefin extrudate is adhered to the second reinforcement surface.

In some exemplary embodiments, the multilayer structure further comprises an adhesive coating adhered to the second reinforcement surface and an optional release liner optionally adhered to a surface of the adhesive coating opposite the second reinforcement surface.

In some exemplary embodiments, the multilayer structure further comprises a first adhesive coating, a second adhesive coating, and an optional liner, and the reinforcement comprises a glass mat. The first adhesive coating is adhered to the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the multilayer structure further comprises a first adhesive coating, a glass mat, a second adhesive coating, and an optional liner. The first adhesive coating is adhered to the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the multilayer structure further comprises a bottom coating, a first adhesive coating, a second adhesive coating, and an optional release liner, and the reinforcement comprises a glass mat. The bottom coating is adhered to the second reinforcement surface. The first adhesive coating is adhered to the bottom coating opposite the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the multilayer structure further comprises a bottom coating, a first adhesive coating, a glass mat, a second adhesive coating, and an optional release liner. The bottom coating is adhered to the second reinforcement surface. The first adhesive coating is adhered to the bottom coating opposite the second reinforcement surface. The glass mat is at least partially impregnated with at least one of the first adhesive coating and the second adhesive coating. The optional release liner is optionally adhered to a surface of the second adhesive coating opposite the glass mat.

In some exemplary embodiments, the first adhesive coating comprises a non-asphaltic coating that includes butyl rubber.

In some exemplary embodiments, the first adhesive coating comprises a non-asphaltic acrylic adhesive coating.

In some exemplary embodiments, the second adhesive coating comprises asphalt.

In some exemplary embodiments, the second adhesive coating comprises a non-asphaltic coating that includes butyl rubber.

In some exemplary embodiments, the second adhesive coating comprises a non-asphaltic acrylic adhesive coating.

In some exemplary embodiments, the multilayer structure further comprises at least one of a coating layer or an adhesive layer, where the at least one of the coating layer or the adhesive layer are positioned between the first reinforcement surface and the second film surface.

In some exemplary embodiments, the multilayer structure further comprises comprises an optional coating layer positioned below the reinforcement.

In some exemplary embodiments, the multilayer structure further comprises an optional coating layer positioned below the reinforcement. The multilayer structure further comprises an adhesive coating positioned below the optional coating layer and an optional release liner positioned below the adhesive coating.

In some exemplary embodiments, the multilayer structure further comprises an optional coating layer positioned below the reinforcement. The multilayer structure further comprises a second coating layer positioned below the optional coating layer, a second reinforcement positioned below second coating layer, an adhesive coating positioned below the second reinforcement, and an optional release liner positioned below the adhesive coating.

Other aspects, advantages, and features of the general inventive concepts will become apparent to those skilled in the art from the following detailed description, when read in light of the accompanying drawings.

### BRIEF DESCRIPTION OF THE DRAWINGS

The general inventive concepts, as well as embodiments and advantages thereof, are described below in greater detail, by way of example, with reference to the drawings in which:

FIG. 1 is a cross-sectional view of a roofing underlayment according to the present disclosure;

FIG. 1A is a cross-sectional view of a roofing underlayment according to the present disclosure;

FIG. 2 is a side elevation view of a portion of a film having a plurality of gripping structures according to the present disclosure;

FIG. 2A is a side elevation view of a portion of a film having a plurality of gripping structures according to the present disclosure;

FIG. 2B is a side elevation view of a portion of a film having a plurality of gripping structures according to the present disclosure;

FIG. 2C is a side elevation view of a portion of a film having a plurality of gripping structures according to the present disclosure;

FIG. 3 is a top plan view of a portion of a film having a plurality of gripping structures according to the present disclosure;

FIG. 3A is a top plan view of a portion of a film having a plurality of gripping structures according to the present disclosure;

FIG. 4 is a top plan view of a portion of a roofing underlayment according to the present disclosure;

FIG. 5 is a side elevation view of a portion of a roofing underlayment according to the present disclosure;

FIG. 6 is a schematic illustration of a method of making a roofing underlayment of the present disclosure;

FIG. 7 is a cross-sectional view of a roofing underlayment according to the present disclosure;

FIG. 8 is a schematic illustration of a method of making a roofing underlayment of the present disclosure;

FIG. 9 is a cross-sectional view of a roofing underlayment according to the present disclosure;

FIG. 9A is a cross-sectional view of a roofing underlayment according to the present disclosure;

FIG. 10 is a cross-sectional view of a roofing underlayment according to the present disclosure;

FIG. 11 is a cross-sectional view of a roofing underlayment according to the present disclosure;

FIG. 12 is a cross-sectional view of a roofing underlayment according to the present disclosure;

FIG. 13 is a cross-sectional view of a roofing underlayment according to the present disclosure;

FIGS. 14-16 illustrate a schematic view of a method for determining a coefficient of friction for a roofing underlayment according to the present disclosure;

FIGS. 17-18 illustrate a tread pattern for footwear used in COF method 1;

FIG. 19 is an interval plot illustrating results of COF method 1 for dry conditions;

FIG. 20 is an interval plot illustrating results for COF method 1 for wet conditions;

FIG. 21 is an interval plot illustrating results for COF method 1 for sawdust conditions;

FIG. 22 is an interval plot illustrating results of COF method 1 for dry conditions;

FIG. 23 is an interval plot illustrating results for COF method 1 for wet conditions;

FIG. 24 is an interval plot illustrating results for COF method 1 for sawdust conditions;

FIG. 25 is a table illustrating results for COF method 1 for dry, wet, and sawdust conditions;

FIG. 26 is a graph illustrating results for COF method 1 for each of dry, wet, and sawdust conditions, where the graph shows coefficient of friction in view of contact area for a portion of the samples;

FIG. 27 is a graph illustrating results for COF method 1 for each of dry, wet, and sawdust conditions, where the graph shows coefficient of friction in view of aspect ratio for a portion of the samples;

FIG. 28 is an interval plot illustrating results of COF method 2 for dry conditions;

FIG. 29 is an interval plot illustrating results for COF method 2 for wet conditions; and

FIG. 30 is a table illustrating results for COF method 2 for dry and wet conditions.

### DETAILED DESCRIPTION

While the general inventive concepts are susceptible of embodiment in many different forms, there are shown in the drawings, and will be described herein in detail, specific embodiments thereof with the understanding that the present disclosure is to be considered as an exemplification of the principles of the general inventive concepts. Accordingly, the general inventive concepts are not intended to be limited to the specific embodiments illustrated herein.

The general inventive concepts relate to roofing underlayments configured to enhance walkability. The term “walkability” as used herein refers to foot traction or the ability of an installer to walk upon a roofing underlayment without slipping. As will be described in further detail below, enhanced walkability is achieved by providing a roofing underlayment that includes a plurality of gripping structures. In addition to walkability, the roofing underlayments also exhibit antiskid properties to help prevent items such as tools and construction materials (e.g., shingle bundles) from sliding when placed on the installed roofing underlayment.

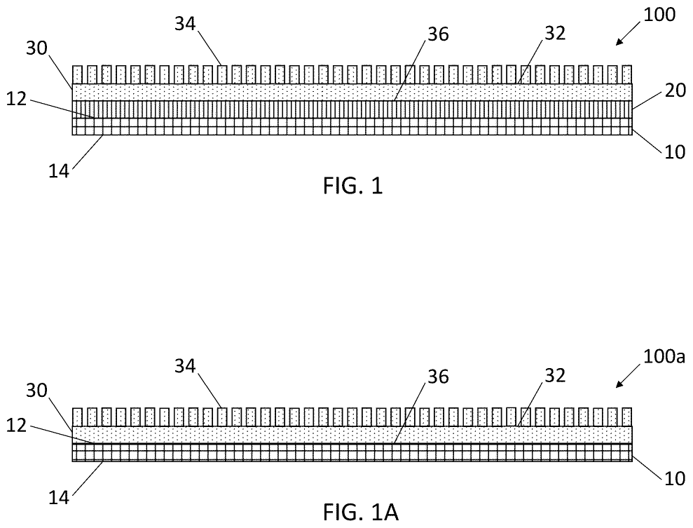

Referring now to FIG. 1, a roofing underlayment 100 according to one aspect of the present disclosure is shown. The roofing underlayment 100 comprises a reinforcement 10 having a first reinforcement surface 12 (e.g., top surface) and a second reinforcement surface 14 (e.g., a bottom surface), a bonding material 20, a film 30 having a first film surface 32 and a second film surface 36 opposite the first film surface 32, and a plurality of gripping structures 34 disposed on the first film surface 32.

The reinforcement 10 of the present disclosure provides strength and reinforcement to the roofing underlayment 100. The reinforcement 10 can be structured in a variety of ways and can be formed of a variety of materials. In certain aspects, the reinforcement 10 comprises a mesh structure that includes yarns or tapes that extend in a machine direction (i.e., warp yarns) and yarns or tapes that extend in a cross-machine direction (i.e., weft yarns). In certain aspects, the reinforcement 10 comprises a nonwoven structure comprising fibers that are bound together (e.g., mechanically, chemically, or both). In certain aspects, the reinforcement 10 comprises a film structure comprising a polymer material (e.g., polyolefin, polyester). Exemplary film structures include, but are not limited to, biaxially oriented films, monoaxially oriented films, cross laminated films, and the like. In certain aspects, the reinforcement 10 comprises at least one of a mesh structure (“mesh scrim”), a nonwoven structure (“nonwoven reinforcement”), and a film structure.

Exemplary materials for forming the mesh scrim of the present disclosure include, but are not limited to, a polymer, a fiberglass, or a combination thereof. In certain aspects, the mesh scrim comprises a polymer. Exemplary polymers suitable for forming the mesh scrim of the present disclosure include, but are not limited to, a polyolefin (e.g., polyethylene, polypropylene), a polyester, a polystyrene, a polyamide, a polyurethane, a polycarbonate, an ethylene-acrylic copolymer, and combinations thereof. The polymer used to form the mesh scrim of the present disclosure may be a virgin material, a recycled/reprocessed material, and combinations thereof. In certain aspects, the mesh scrim comprises a polyolefin. In certain aspects, the mesh scrim comprises at least one of a polypropylene or a polyethylene. The mesh scrim of the present disclosure may also comprise additives such as fillers (e.g., calcium carbonate), colorants, pigments, antioxidants, U.V. stabilizers, fire retardants, and the like.

In certain aspects, the mesh scrim comprises a fiberglass (e.g., fiberglass yarns or rovings). The fiberglass can be made from any type of glass. Exemplary glass types include, but are not limited to, A-type glass, C-type glass, E-type glass, S-type glass, ECR-type glass (e.g., Advantex® glass commercially available from Owens Corning of Toledo, Ohio), HiPer-Tex® glass (commercially available from 3B—The Fibreglass Company of Belgium), high modulus glass (e.g., H-glass and H2 glass available from Owens Corning of Toledo, Ohio), and combinations thereof.

The mesh scrim of the present disclosure can be structured in a variety of ways. For example, the mesh scrim can be a woven scrim or a laid scrim. In a woven scrim, the yarns or tapes that form the woven scrim are woven or knitted together. On the other hand, in a laid scrim, the yarns or tapes that form the laid scrim are bonded to one another using a chemical adhesive or binder, such as polyvinyl alcohol.

In certain aspects, the reinforcement 10 of the present disclosure comprises a woven scrim comprising at least one of a polypropylene or a polyethylene. The woven scrim can be constructed to have a desired weave count as well as a desired weaving pattern. The phrase “weave count,” as used herein, refers to the number of yarns or tapes per inch in both the machine direction (warp) and the cross-machine direction (weft). An example of a weave count for a woven scrim is 2×2, which means that there are 2 warp yarns per inch of the woven scrim and 2 weft yarns per inch of the woven scrim. Assuming a constant yarn or tape width, a woven scrim having a low weave count will have a more open mesh configuration, whereas a woven scrim having a high weave count will have a more closed mesh configuration. In certain aspects, the warp tapes of the woven scrim have a width of 2 mm to 8 mm. In certain aspects, the weft tapes of the woven scrim have a width of 2 mm to 8 mm. In certain aspects, the warp tapes and weft tapes of the woven scrim have the same width. In certain aspects, the warp tapes and weft tapes of the woven scrim have different widths. In certain aspects, the reinforcement 10 is a woven scrim and has a weave count that ranges from 4×2 to 14×12. In certain aspects, the reinforcement 10 is a woven scrim and has a weave count that ranges from 5×5 to 10×10. In certain aspects, the reinforcement 10 is a woven scrim and has a weave count of 5×3.5. In certain aspects, the reinforcement 10 is a woven scrim and has a weave count of 10×5. In certain aspects, the reinforcement 10 is a woven scrim and has a weave count of 10×10. The woven scrim can also be woven using a desired weaving pattern. Exemplary weaving patterns include, but are not limited to, a plain or box weave pattern, a twill weave pattern, or a leno weave pattern. In certain aspects, the reinforcement 10 of the present disclosure is a woven scrim having a plain or box weave pattern.

In certain aspects, the reinforcement 10 of the present disclosure comprises a laid scrim comprising fiberglass (e.g., fiberglass yarns or rovings). The fiberglass used to form the laid scrim can be formed of any of the previously mentioned glasses (e.g., A-glass, E-glass, S-glass, ECR-glass) and can have a linear density of 100 tex to 4,400 tex, including from 300 tex to 2,000 tex, and also including from 600 tex to 1,000 tex. The laid scrim may have a side-by-side construction, an over/under construction, or any other known laid scrim construction. Although not woven, the laid scrim can also be characterized in terms of weave count. In certain aspects, the laid scrim has a weave count of 1×1 to 10×10. In certain aspects, the laid scrim has a weave count of 1.25×1.25 to 5×5, including a weave count of 3×3 to 4.5×4.5. In certain aspects, the laid scrim has a weave count where the number of warp yarns is different than the number of weft yarns. For example, the laid scrim can be constructed to have a weave count of 2.5×4, which means that the laid scrim comprises 2.5 warp yarns per inch of the laid scrim and 4 weft yarns per inch of the laid scrim.

In certain aspects, the reinforcement 10 of the present disclosure comprises a nonwoven reinforcement including fibers, which may be unidirectionally oriented continuous fibers, randomly oriented continuous fibers, or randomly oriented chopped fibers, that are bound together (e.g., mechanically, chemically, or both). Exemplary fibers for forming the nonwoven reinforcement include, but are not limited to, glass fibers, synthetic fibers (e.g., polyester fibers, polyethylene fibers, polypropylene fibers, polyethylene terephthalate fibers, polyamide fibers, aramid fibers, polyaramid fibers), mineral fibers, carbon fibers, ceramic fibers, natural fibers (e.g., cellulose fibers, cotton fibers, jute fibers, bamboo fibers, ramie fibers, bagasse fibers, hemp fibers, coir fibers, linen fibers, kenaf fibers, sisal fibers, flax fibers, henequen fibers), or a blend of two or more different types of fibers.

In certain aspects, the nonwoven reinforcement comprises glass fibers. The glass fibers can be made from any type of glass. Exemplary glass fibers include, but are not limited to, A-type glass fibers, C-type glass fibers, E-type glass fibers, S-type glass fibers, ECR-type glass fibers (e.g., Advantex® glass fibers commercially available from Owens Corning of Toledo, Ohio), Hiper-Tex® glass fibers, wool glass fibers, and combinations thereof.

In certain aspects, the nonwoven reinforcement comprises glass fibers and synthetic fibers. Any of the previously described glass fibers may be used in combination with synthetic fibers to form the nonwoven reinforcement. The synthetic fibers may comprise one or more of polyester fibers, polyethylene fibers, polypropylene fibers, polyethylene terephthalate fibers, polyamide fibers, aramid fibers, and polyaramid fibers. In certain aspects, the nonwoven reinforcement comprises from 50% to 99% by weight glass fibers and from 1% to 50% by weight synthetic fibers, with the weight percentages based on the total weight of fibers. In certain aspects, the nonwoven reinforcement comprises from 70% to 99% by weight glass fibers and from 1% to 30% by weight synthetic fibers, including from 75% to 99% by weight glass fibers and from 1% to 25% by weight synthetic fibers, from 80% to 99% by weight glass fibers and from 1% to 20% by weight synthetic fibers, from 85% to 99% by weight glass fibers and from 1% to 15% by weight synthetic fibers, from 90% to 99% by weight glass fibers and from 1% to 10% by weight synthetic fibers, and also including from 95% to 99% by weight glass fibers and from 1% to 5% by weight synthetic fibers, with the weight percentages based on the total weight of fibers. In certain aspects, the nonwoven reinforcement comprises from 50% to 99% by weight synthetic fibers and from 1% to 50% by weight glass fibers, with the weight percentages based on the total weight of fibers. In certain aspects, the nonwoven reinforcement comprises from 70% to 99% by weight synthetic fibers and from 1% to 30% by weight glass fibers, including from 75% to 99% by weight synthetic fibers and from 1% to 25% by weight glass fibers, from 80% to 99% by weight synthetic fibers and from 1% to 20% by weight glass fibers, from 85% to 99% by weight synthetic fibers and from 1% to 15% by weight glass fibers, from 90% to 99% by weight synthetic fibers and from 1% to 10% by weight glass fibers, and also including from 95% to 99% by weight synthetic fibers and from 1% to 5% by weight glass fibers, with the weight percentages based on the total weight of fibers.

As mentioned above, the nonwoven reinforcement of the present disclosure comprises fibers that are bound together. In certain aspects, the fibers of the nonwoven reinforcement are bound together with a binder composition. Any conventional binder composition used to form nonwoven materials may be used to form the nonwoven reinforcement of the present disclosure including, but not limited to, thermoplastic binder compositions and thermoset binder compositions. Alternatively, the fibers of the nonwoven reinforcement are mechanically bound together or entangled using well-known techniques including, but not limited to, needling, air entanglement, and hydro-entanglement, or thermally bound together using well-known techniques including, but not limited to, calendering, through-air bonding, ultrasonic bonding, and radiant heat bonding.

The reinforcement 10 of the present disclosure may have a wide range of basis weights. In certain aspects, the reinforcement 10 has a total basis weight of 10 g/m² to 200 g/m². In certain aspects, the reinforcement 10 has a total basis weight 20 g/m² to 190 g/m², including a total basis weight of 25 g/m² to 180 g/m², including a total basis weight of 50 g/m² to 150 g/m², a total basis weight of 60 g/m² to 130 g/m², a total basis weight of 70 g/m² to 125 g/m², a total basis weight of 80 g/m² to 120 g/m², a total basis weight of 90 g/m² to 115 g/m², and also including a total basis weight of 95 g/m² to 110 g/m². In certain aspects, the reinforcement 10 has a total basis weight 100 g/m² to 200 g/m², including a total basis weight of 110 g/m² to 200 g/m², including a total basis weight of 125 g/m² to 200 g/m², a total basis weight of 150 g/m² to 200 g/m², a total basis weight of 175 g/m² to 200 g/m², and also including a total basis weight of 185 g/m² to 200 g/m². The foregoing basis weights apply to embodiments where the reinforcement 10 comprises a mesh scrim, a nonwoven reinforcement, a film structure, or combinations thereof.

The reinforcement 10 of the present disclosure may also have a variety of thicknesses. In certain aspects, the reinforcement 10 has a total thickness of 20 μm to 200 μm. In certain aspects, the reinforcement 10 has a total thickness of 25 μm to 175 μm, including a total thickness of 25 μm to 150 μm, including a total thickness of 50 μm to 125 μm, including a total thickness of 75 μm to 125 μm, including a total thickness of 90 μm to 120 μm, a total thickness of 95 μm to 115 μm, and also including a total thickness of 100 μm to 110 μm. In certain aspects, the reinforcement 10 has a total thickness of 20 μm to 190 μm, including a total thickness of 20 μm to 150 μm, a total thickness of 20 μm to 100 μm, and also including a total thickness of 20 μm to 75 μm. The foregoing thicknesses apply to embodiments where the reinforcement 10 comprises a mesh scrim, a nonwoven reinforcement, a film structure, or combinations thereof.

In certain aspects, the reinforcement 10 of the present disclosure comprises a woven scrim comprising a polypropylene and has a weave count ranging from 4×2 to 14× 12, a basis weight of 20 g/m² to 150 g/m², and a thickness of 50 μm to 125 μm. In certain aspects, the reinforcement 10 of the present disclosure comprises a woven scrim comprising 84% to 94% by weight polypropylene, 4% to 14% by weight filler (e.g., calcium carbonate), and 0.25% to 2% by weight U.V. stabilizer, and has a weave count ranging from 4×2 to 14×12, a basis weight of 20 g/m² to 130 g/m² and a thickness of 50 μm to 125 μm. In certain aspects, the reinforcement 10 of the present disclosure comprises a nonwoven reinforcement comprising at least one of glass fibers or synthetic fibers and has a basis weight of 20 g/m² to 150 g/m² and a thickness of 50 μm to 125 μm. In certain aspects, the reinforcement 10 of the present disclosure comprises a film structure comprising a polyolefin and has a basis weight of 25 g/m² to 125 g/m² and a thickness of 25 μm to 130 μm.

With continued reference to FIG. 1, the roofing underlayment 100 includes a bonding material 20 that joins the reinforcement 10 to the film 30 by adhering the reinforcement first surface 12 to the film second surface 36. In certain aspects, the bonding material 20 comprises an adhesive. A variety of adhesives may be used as the bonding material 20. Examples of adhesives suitable for use as the bonding material 20 include, but are not limited to, hot melt adhesives, butyl-based adhesives, and acrylic-based adhesives. The adhesive can be applied to at least one of the reinforcement first surface 12 or the film second surface 36, followed by laminating the surfaces 12, 36 together to adhere the reinforcement 10 to the film 30. The adhesive can have a basis weight of 3 g/m² to 15 g/m², including a basis weight of 3 g/m² to 10 g/m², and also including a basis weight of 3 g/m² to 8 g/m².

In certain aspects, the bonding material 20 comprises a thermoplastic coating. The thermoplastic coating can be introduced between the reinforcement 10 and the film 30 using an extrusion coating process, as described in further detail below. The thermoplastic coating bonds to the reinforcement 10 and the film 30 as a result of being introduced between the reinforcement 10 and the film 30 in a molten, flowable form and subsequently solidifying. Accordingly, the thermoplastic coating adheres the reinforcement 10 to the film 30.

The thermoplastic coating of the present disclosure is generally water impermeable and may be formed from a variety of materials. Exemplary materials suitable for forming the thermoplastic coating of the present disclosure include, but are not limited to, a polyolefin (e.g., polypropylene, polyethylene), a polyacrylate, a polyester (e.g., polyethylene terephthalate), a polyamide, a polyimide, a polycarbonate, a polyurethane, a fluoropolymer, a copolymer of an olefin and an α,β-unsaturated carbonyl (e.g., α,β-unsaturated carboxylic acid, α,β-unsaturated ester, α,β-unsaturated amide), a synthetic rubber, a thermoplastic elastomer, and combinations thereof. In certain aspects, the thermoplastic coating comprises at least one of polypropylene, polyethylene, styrene block copolymer (e.g., styrene-butadiene-styrene, styrene-isoprene-styrene, styrene-ethylene/butylene-styrene, styrene-ethylene/propylene), ethylene-vinyl acetate copolymer, ethylene-acrylate copolymer, ethylene-methyl acrylate copolymer, ethylene-ethyl acrylate copolymer, ethylene-butyl acrylate copolymer, polyvinyl chloride, polycaprolactone, polyvinylidene fluoride, or combinations thereof. The material used to form the thermoplastic coating of the present disclosure may be a virgin material, a recycled/reprocessed material, or combinations thereof. In certain aspects, the thermoplastic coating comprises a polyolefin. In certain aspects, the thermoplastic coating comprises at least one of a polypropylene or a polyethylene.

In addition to the thermoplastic material, the thermoplastic coating of the present disclosure can optionally include one or more additives or one or more filler materials. Exemplary additives include, but are not limited to, fire retardants, dyes, pigments, UV stabilizers, anti-static agents, and so forth. Exemplary filler materials include, but are not limited to, calcium carbonate, alumina trihydrate, barite, silica, talc, kaolin clay, and so forth. Such additives and filler materials are well known to those of ordinary skill in the art. Generally, any such additives used in the thermoplastic coating will typically represent less than 25% by weight of the thermoplastic coating, and any such filler materials will typically represent less than 40% by weight of the thermoplastic coating. Accordingly, the thermoplastic material will typically represent at least 35% by weight of the thermoplastic coating, including at least 50% by weight of the thermoplastic coating, at least 60% by weight of the thermoplastic coating, at least 75% by weight of the thermoplastic coating, at least 85% by weight of the thermoplastic coating, at least 90% by weight of the thermoplastic coating, at least 95% by weight of the thermoplastic coating, and also including 100% by weight of the thermoplastic coating.

When used as the bonding material 20 of the present disclosure, the thermoplastic coating may have a wide range of basis weights. In certain aspects, when used as the bonding material 20, the thermoplastic coating has a basis weight of 6 g/m² to 75 g/m². In certain aspects, when used as the bonding material 20, the thermoplastic coating has a basis weight of 8 g/m² to 60 g/m². In certain aspects, when used as the bonding material 20, the thermoplastic coating has a basis weight of 6 g/m² to 50 g/m², including a basis weight of 8 g/m² to 45 g/m², a basis weight of 10 g/m² to 40 g/m², and also including a basis weight of 18 g/m² to 35 g/m².

When used as the bonding material 20 of the present disclosure, the thermoplastic coating may also have a variety of thicknesses. In certain aspects, when used as the bonding material 20, the thermoplastic coating has a thickness of less than or equal to 75 μm. In certain aspects, when used as the bonding material 20, the thermoplastic coating has a thickness of 5 μm to 75 μm, including a thickness of 10 μm to 70 μm, a thickness of 15 μm to 60 μm, a thickness of 20 μm to 55 μm, a thickness of 25 μm to 50 μm, a thickness of 30 μm to 50 μm, and also including a thickness of 35 μm to 45 μm. In certain aspects, when used as the bonding material 20, the thermoplastic coating has a thickness of 25 μm to 75 μm, including a thickness of 30 μm to 75 μm, a thickness of 40 μm to 75 μm, a thickness of 50 μm to 75 μm, and also including a thickness of 60 μm to 75 μm.

In certain aspects, when used as the bonding material 20, the thermoplastic coating has a basis weight of 6 g/m² to 75 g/m² and comprises at least one of a polypropylene or a polyethylene. In certain aspects, when used as the bonding material 20, the thermoplastic coating has a basis weight of 10 g/m² to 60 g/m² and comprises at least one of a polypropylene or a polyethylene. In certain aspects, when used as the bonding material 20, the thermoplastic coating has a basis weight of 18 g/m² to 35 g/m² and comprises at least one of a polypropylene or a polyethylene. In certain aspects, when used as the bonding material 20, the thermoplastic coating has a basis weight of 6 g/m² to 75 g/m² and comprises 40% to 50% by weight recycled/reprocessed polypropylene, 30% to 40% by weight virgin polypropylene, 10% to 20% by weight low-density polyethylene (LDPE), and 4% to 8% by weight colorant (e.g., color masterbatch), wherein the weight percentages are based on the total weight of the thermoplastic coating. In certain aspects, when used as the bonding material 20, the thermoplastic coating has a basis weight of 10 g/m² to 60 g/m² and comprises 40% to 50% by weight recycled/reprocessed polypropylene, 35% to 45% by weight virgin polypropylene, 5% to 15% by weight LDPE, and 2% to 6% by weight colorant (e.g., color masterbatch), wherein the weight percentages are based on the total weight of the thermoplastic coating. In certain aspects, when used as the bonding material 20, the thermoplastic coating has a basis weight of 6 g/m² to 75 g/m² and comprises a blend of polypropylene and LDPE. In certain aspects, the blend of polypropylene and LDPE comprises from 80% to 95% by weight polypropylene and 5% to 20% by weight LDPE, based on the total weight of polypropylene and LDPE.

Still referring to FIG. 1, the roofing underlayment 100 comprises a film 30 having a first film surface 32 and a second film surface 36 opposite the first film surface 32 and a plurality of gripping structures 34 disposed on the first film surface 32. It should be understood that the plurality of gripping structures 34 are formed integrally with the film 30 such that the film 30 and the plurality of gripping structures 34 are a unitary structure. The film 30 and gripping structures 34 being a unitary structure allows for the gripping structures 34 to hold up to repeated movement thereon by an installer. As shown in FIG. 1, the film 30 and, in particular, the plurality of gripping structures 34 comprise the top surface of the roofing underlayment 100 on which an installer will walk after the roofing underlayment 100 is installed on a roof deck. The material composition, size, spatial distribution, density, and pattern of the plurality of gripping structures 34 on the film 30 can contribute to the enhanced walkability performance exhibited by the roofing underlayment 100 under wet, dry, and/or dirty conditions.

The film 30 of the present disclosure is generally water impermeable and may be formed from a variety of materials. Exemplary materials suitable for forming the film 30 (including the plurality of gripping structures 34) of the present disclosure include, but are not limited to, a polyolefin (e.g., polypropylene, polyethylene), a polyacrylate, a polyester (e.g., polyethylene terephthalate), a polyamide, a polyimide, a polycarbonate, a polyurethane, a fluoropolymer, a copolymer of an olefin and an α,β-unsaturated carbonyl (e.g., α,β-unsaturated carboxylic acid, α,β-unsaturated ester, α,β-unsaturated amide), a synthetic rubber, a thermoplastic elastomer, and combinations thereof. In certain aspects, the film 30 comprises at least one of polypropylene, polyethylene, styrene block copolymer (e.g., styrene-butadiene-styrene, styrene-isoprene-styrene, styrene-ethylene/butylene-styrene, styrene-ethylene/propylene), ethylene-vinyl acetate copolymer, ethylene-acrylate copolymer, ethylene-methyl acrylate copolymer, ethylene-ethyl acrylate copolymer, ethylene-butyl acrylate copolymer, polyvinyl chloride, polycaprolactone, polyvinylidene fluoride, or combinations thereof. The material used to form the film 30 of the present disclosure may be a virgin material, a recycled/reprocessed material, or combinations thereof. In certain aspects, the film 30 comprises a polyolefin. In certain aspects, the film 30 comprises at least one of a polypropylene or a polyethylene. In certain aspects, the film 30 comprises a polyester. In certain aspects, the film 30 comprises polyethylene terephthalate.

The film 30, including the plurality of gripping structures 34, can be characterized in terms of its hardness. In general, the film 30, including the plurality of gripping structures 34, has a Shore A hardness of about 90 to 100 or a Shore D hardness of about 40 to 100. In certain aspects, the film 30, including the plurality of gripping structures 34, has a Shore A hardness of 95 to 100. In certain aspects, the film 30, including the plurality of gripping structures 34, has a Shore D hardness of 60 to 98, including a Shore D hardness of 65 to 90, and also including a Shore D hardness of 70 to 85. The hardness of the film 30 and gripping structures 34 is configured to be greater than a hardness of a shoe sole that may contact the film 30 and gripping structures 34. Typical hardness values for a shoe sole that may contact the film 30 and gripping structures 34 may range from about 50 to 90 on the Shore A hardness scale. Because the hardness of the film 30 and gripping structures 34 is greater than the hardness of the shoe sole, the gripping structures 34 indent into the shoe sole (e.g., when a worker wearing the shoes stands or walks on the film 30/gripping structures 34). Due to the difference in hardness, the shoe sole will slightly deform around the gripping structures 34 to provide greater surface area contact and mechanical anchoring, which enables high shear forces and lateral grip, even in wet and/or dirty conditions. Although high shear forces are created, the peel or tensile forces are negligible, which results in the provision of excellent traction while also allowing the shoe wearer to lift their foot off the film 30/gripping structures 34 without any resistance (such as would be experienced if the film surface utilized an adhesive material, hook and loop fasteners, or any other feature that would provide traction while also having peel or tensile forces that are meaningful).

The film 30 of the present disclosure may have a wide range of thicknesses. In certain aspects, the film 30 (including the plurality of gripping structures 34) has a total thickness of 100 μm to 1,000 μm. In certain aspects, the film 30 has a total thickness of 650 μm to 1,000 μm, including a total thickness of 700 μm to 950 μm, and also including a total thickness of 725 μm to 850 μm. In certain aspects, the film 30 has a total thickness of 100 μm to 650 μm, including a total thickness of 100 μm to 500 μm, a total thickness of 100 μm to 400 μm, a total thickness of 100 μm to 350 μm, and also including a total thickness of 100 μm to 300 μm. In certain aspects, the film 30 has a total thickness of 250 μm to 350 μm. The term “height” is used interchangeably herein with the term “thickness” when describing the film 30 (and the plurality of gripping structures 34).

The film 30 of the present disclosure may be configured with a wide range of basis weights. In certain aspects, the film 30 has a basis weight of 25 g/m² to 150 g/m². In certain aspects, the film 30 has a basis weight of 30 g/m² to 70 g/m². In certain aspects, the film 30 has a basis weight of 35 g/m² to 65 g/m², including a basis weight of 40 g/m² to 60 g/m², and also including a basis weight of 45 g/m² to 55 g/m².

The film 30, including the plurality of gripping structures 34, may be made using conventional film forming technologies. In certain aspects, the film 30 is formed using a cast film extrusion process. In certain aspects, the film 30 is formed using a blown film process. In certain aspects, the film 30 is formed using a coextrusion process such that the film 30 is a multi-layer film. In certain aspects, a coextrusion process is used to produce a film 30 having a first coextruded layer that includes a U.V. protective component and a second coextruded layer. It is contemplated that additional coextruded layers beyond a second coextruded layer could be present. Accordingly, the term “second coextruded layer” refers to any number of coextruded layers after the first coextruded layer (i.e., top layer) that includes the U.V. protective component. The first coextruded layer of the film 30 may include any one or more of the materials previously mentioned as being suitable for forming the film 30. The second coextruded layer of the film 30 may include any one or more of the materials previously mentioned as being suitable for forming the film 30. In certain aspects, the material used to form the first coextruded layer of the film 30 (not considering the U.V. protective component) may be the same as the material used to form the second coextruded layer of the film 30. In certain aspects, the material used to form the first coextruded layer of the film 30 (not considering the U.V. protective component) may be different from the material used to form the second coextruded layer of the film 30. In certain aspects, the first coextruded layer of the film 30 may have a basis weight of 3 g/m² to 150 g/m². In certain aspects, the second coextruded layer of the film 30 may have a basis weight of 10 g/m² to 150 g/m².

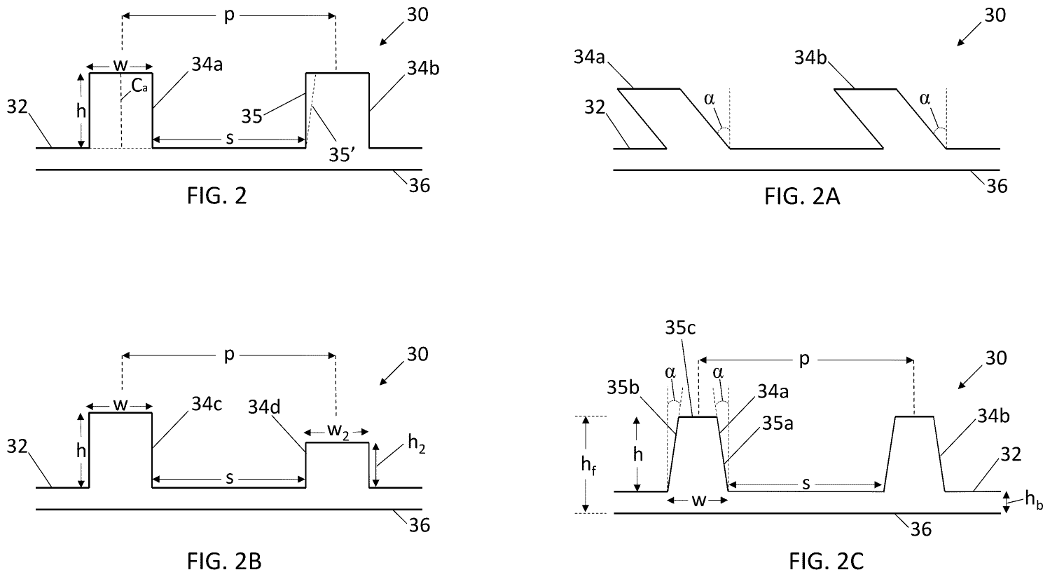

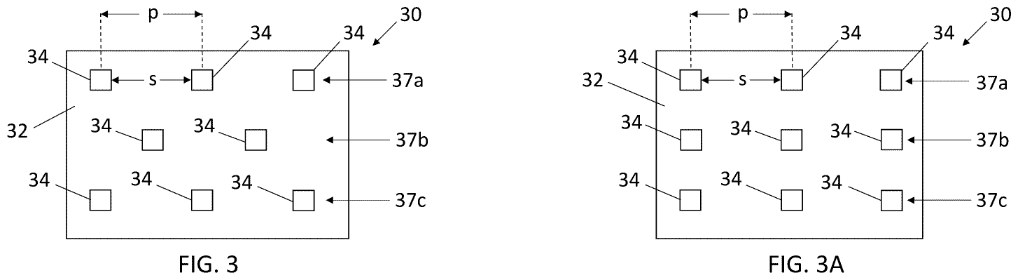

Referring now to FIGS. 2 to 3A, portions of a film 30 are shown that illustrate various aspects of the gripping structures 34 (e.g., 34a, 34b, and so forth) of the present disclosure. A side elevation view of two gripping structures 34a, 34b is shown in FIG. 2. The adjacent gripping structures 34a, 34b have a height h and a maximum cross-sectional dimension w and are separated from one another by a spacing distance s, which refers to the distance from a sidewall of one gripping structure 34a to a sidewall of an adjacent gripping structure 34b as measured at the first film surface 32. The separation of adjacent gripping structures 34a, 34b may also be characterized by a pitch p, which refers to the distance from a center of one gripping structure 34a to a center of an adjacent gripping structure 34b.

The gripping structures 34a, 34b of the present disclosure have a height of 10 μm to 600 μm and a maximum cross-sectional dimension of 25 μm to 1,000 μm. In certain aspects, the gripping structures 34a, 34b have a height of 15 μm to 500 μm, including a height of 20 μm to 400 μm, a height of 30 μm to 400 μm, a height of 50 μm to 400 μm, a height of 75 μm to 400 μm, a height of 100 μm to 400 μm, a height of 100 μm to 300 μm, a height of 100 μm to 275 μm, a height of 100 μm to 225 μm, a height of 100 μm to 200 μm, a height of 125 μm to 175 μm, and also including a height of 140 μm to 160 μm, and have a maximum cross-sectional dimension of 25 μm to 750 μm, including a maximum cross-sectional dimension of 30 μm to 700 μm, a maximum cross-sectional dimension of 40 μm to 350 μm, a maximum cross-sectional dimension of 50 μm to 675 μm, a maximum cross-sectional dimension of 100 μm to 650 μm, a maximum cross-sectional dimension of 125 μm to 500 μm, a maximum cross-sectional dimension of 150 μm to 400 μm, a maximum cross-sectional dimension of 175 μm to 350 μm, a maximum cross-sectional dimension of 180 μm to 300 μm, and also including a maximum cross-sectional dimension of 190 μm to 250 μm. In certain aspects, the gripping structures 34a, 34b have a height of 180 μm to 220 μm and a maximum cross-sectional dimension of 180 μm to 300 μm. In some examples, the height h of each of the plurality of gripping structures 34 can be consistent such that there is little variation amongst the plurality of gripping structures 34. In certain aspects, the height of each gripping structure 34 is within 15% of an average height of the plurality of gripping structures 34, including within 10% of an average height of the plurality of gripping structures 34, including within 5% of an average height of the plurality of gripping structures 34, including within 3% of an average height of the plurality of gripping structures 34, and also including within 1% of an average height of the plurality of gripping structures 34. In certain aspects, the gripping structures 34a, 34b have an aspect ratio (i.e., ratio of height to maximum cross-sectional dimension) of 0.05:1 to 5:1, including an aspect ratio of 0.1:1 to 4.75:1, an aspect ratio of 0.2:1 to 4.5:1, an aspect ratio of 0.3:1 to 4:1, an aspect ratio of 0.4:1 to 3:1, an aspect ratio of 0.5:1 to 2:1, an aspect ratio of 0.6:1 to 1.5:1, and also including an aspect ratio of 0.8:1 to 1.3:1. In certain aspects, the gripping structures 34a, 34b have an aspect ratio of 0.3:1 to 1.5:1.

In certain aspects, the plurality of gripping structures 34 have a pitch p of 150 μm to 4,000 μm. In certain aspects, the plurality of gripping structures 34 have a pitch p of 200 μm to 3,500 μm, including a pitch p of 250 μm to 3,000 μm, a pitch p of 300 μm to 2,500 μm, a pitch p of 350 μm to 2,000 μm, a pitch p of 400 μm to 1,500 μm, a pitch p of 450 μm to 1,000 μm, and also including a pitch p of 450 μm to 750 μm. In certain aspects, the plurality of gripping structures 34 have a pitch p of 450 μm 550 μm. In certain aspects, the plurality of gripping structures 34 have a pitch p of 600 μm to 1,200 μm. In certain aspects, the plurality of gripping structures 34 are separated from one another by a spacing distance s of 25 μm to 3,000 μm. In certain aspects, the plurality of gripping structures 34 are separated from one another by a spacing distance s of 40 μm to 2,900 μm, a spacing distance s of 50 μm to 2,800 μm, a spacing distance s of 60 μm to 2,700 μm, a spacing distance s of 75 μm to 2,600 μm, a spacing distance s of 100 μm to 2,500 μm, and also including a spacing distance s of 125 μm to 2,000 μm. In certain aspects, the plurality of gripping structures 34 are separated from one another by a spacing distance s of 100 μm to 650 μm, including a spacing distance s of 175 μm to 300 μm. In general, the pitch p of the gripping structures 34 is greater than the spacing distance s of the gripping structures 34.

The gripping structures 34 are generally sized and arranged on at least a portion of the first film surface 32 at a density of 15 to 10,000 gripping structures 34 per square centimeter. In certain aspects, the plurality of gripping structures 34 are disposed on at least a portion of the first film surface 32 at a density of 15 to 7,500 gripping structures 34 per square centimeter. In certain aspects the plurality of gripping structures 34 are disposed on at least a portion of the first film surface 32 at a density of 15 to 5,000 gripping structures 34 per square centimeter. In certain aspects, the plurality of gripping structures 34 are disposed on at least a portion of the first film surface 32 at a density of 15 to 2,500 gripping structures 34 per square centimeter. In certain aspects, the plurality of gripping structures 34 are disposed on at least a portion of the first film surface 32 at a density of 50 to 1,000 gripping structures 34 per square centimeter. In certain aspects, the plurality of gripping structures 34 are disposed on at least a portion of the first film surface 32 at a density of 100 to 750 gripping structures 34 per square centimeter. In certain aspects, the plurality of gripping structures 34 are disposed on at least a portion of the first film surface 32 at a density of 250 to 500 gripping structures 34 per square centimeter.

In certain aspects, the plurality of gripping structures 34 are disposed on at least 50% of the first film surface 32 at a density of 15 to 10,000 gripping structures 34 per square centimeter, including any of the previously mentioned density ranges. Accordingly, in certain aspects, at least half of the first film surface 32 can include gripping structures 34 at a density of 15 to 10,000 gripping structures 34 per square centimeter, including any of the previously mentioned density ranges. In certain aspects, the plurality of gripping structures 34 are disposed on 1% to 50% of the first film surface at a density of 15 to 10,000 gripping structures 34 per square centimeter, including any of the previously mentioned density ranges. In certain aspects, the plurality of gripping structures 34 are disposed on 50% to 100% of the first film surface at a density of 15 to 10,000 gripping structures 34 per square centimeter, including any of the previously mentioned density ranges. When the plurality of gripping structures 34 are disposed on 100% of the first film surface 32 at a density of 15 to 10,000 gripping structures 34 per square centimeter (including any of the previously mentioned density ranges), every square centimeter of the first film surface 32 will include 15 to 10,000 gripping structures 34 (including any of the previously mentioned ranges, e.g., 15 to 2,500 gripping structures 34, 100 to 750 gripping structures 34, and 250 to 500 gripping structures 34). Similarly, when the plurality of gripping structures 34 are disposed on 50% of the first film surface 32 at a density of 15 to 10,000 gripping structures 34 per square centimeter (including any of the previously mentioned density ranges), 50% of the total number of square centimeters present on the first film surface 32 will include 15 to 10,000 gripping structures 34.

In certain aspects, the plurality of gripping structures 34 are configured to have a contact area of 1% to 50%. The phrase “contact area,” as used herein, refers to the total area of the topmost surface of the plurality of gripping structures 34 as a percentage of the total area of the film 30. In certain aspects, the plurality of gripping structures 34 are configured to have a contact area of 1% to 40%, including a contact area of 1% to 30%, including a contact area of 3% to 20%, including a contact area of 3% to 15%, including a contact area of 5% to 15%, including a contact area of 5% to 13%, and also including a contact area of about 13%. By way of example only, and to illustrate the concept of “contact area,” the film 30 illustrated in FIG. 3 (top plan view, not to scale) would have a contact area of about 6.9% (calculated by adding the area of each gripping structure 34 to determine a total area of the gripping structures 34 and dividing the total area of the gripping structures 34 by the area of the film 30 in which gripping structures are disposed).

As seen in FIG. 2, the gripping structures 34a, 34b can include a sidewall 35. In certain aspects, the sidewall 35 of the gripping structures 34a, 34b can be tapered, as illustrated by the dashed line 35′ in FIG. 2. In certain aspects, the gripping structures 34a, 34b are perpendicular to the film 30 with a central axis Ca of the gripping structures 34a, 34b forming a 90° angle to the first film surface 32, as shown in FIG. 2. In certain aspects, the gripping structures 34a, 34b are tilted at an angle α from vertical measured at the first film surface 32, as shown in FIG. 2A. In certain aspects, the gripping structures 34a, 34b are tilted at an angle α of up to 30° from vertical, including an angle α of 3° to 30° from vertical, including an angle α of 3° to 20° from vertical, and also including an angle α of 3° to 10° from vertical. In certain aspects, all of the gripping structures 34 are tilted in the same direction at the same angle α from vertical. In certain aspects, different gripping structures 34 can be tilted in different directions and at different angles α from vertical. In certain aspects, individual gripping structures 34 can include sides that are disposed at different angles α (e.g., a gripping structure 34 can have a first angle in the machine direction and a second angle in the cross-machine direction, where the first and second angles are different), where the sides can be tilted or not tilted (e.g., tilted in the machine direction and not-tilted in the cross-machine direction).

In certain aspects, the plurality of gripping structures 34 comprise a plurality of first gripping structures 34c (only one shown) and a plurality of second gripping structures 34d (only one shown), as illustrated in FIG. 2B. The plurality of first gripping structures 34c have a height h and a maximum cross-sectional dimension w and the plurality of second gripping structures 34d have a height h₂ and a maximum cross-sectional dimension w₂. The height h of each of the plurality of first gripping structures 34c is consistent such that there is little variation amongst the plurality of first gripping structures 34c. In certain aspects, the height of each first gripping structure 34c is within 15% of an average height of the plurality of first gripping structures 34c, including within 10% of an average height of the plurality of first gripping structures 34c, including within 5% of an average height of the plurality of first gripping structures 34c, including within 3% of an average height of the plurality of first gripping structures 34c, and also including within 1% of an average height of the plurality of first gripping structures 34c. Similarly, the height h₂ of each of the plurality of second gripping structures 34d is consistent such that there is little variation amongst the plurality of second gripping structures 34d. In certain aspects, that the height of each second gripping structure 34d is within 15% of an average height of the plurality of second gripping structures 34d, including within 10% of an average height of the plurality of second gripping structures 34d, including within 5% of an average height of the plurality of second gripping structures 34d, including within 3% of an average height of the plurality of second gripping structures 34d, and also including within 1% of an average height of the plurality of second gripping structures 34d.

In general, the height h of the plurality of first gripping structures 34c is greater than the height h₂ of the plurality of second gripping structures 34d. In certain aspects, a ratio of the height h of the plurality of first gripping structures 34c to the height h₂ of the plurality of second gripping structures 34d is from 1.1:1 to 5:1, including a ratio of 1.5:1 to 5:1, a ratio of 2:1 to 5:1, a ratio of 3:1 to 5:1, and also including a ratio of 4:1 to 5:1. The maximum cross-sectional dimension w of the plurality of first gripping structures 34c can be the same as or different from the maximum cross-sectional dimension w₂ of the plurality of second gripping structures 34d. In certain aspects, a ratio of the maximum cross-sectional dimension w of the plurality of first gripping structures 34c to the maximum cross-sectional dimension w₂ of the plurality of second gripping structures 34d is from 1:2 to 5:1, including a ratio of 3:5 to 5:1, a ratio of 1:1 to 5:1, a ratio of 2:1 to 5:1, a ratio of 3:1 to 5:1, and also including a ratio of 4:1 to 5:1. In certain aspects, the plurality of first gripping structures 34c have a first aspect ratio (i.e., ratio of height h to maximum cross-sectional dimension w) of 1:5 to 5:1, including a first aspect ratio of 1:5 to 4:1, a first aspect ratio of 2:5 to 3:1, a first aspect ratio of 1:2 to 2:1, a first aspect ratio of 3:5 to 1.5:1, and also including a first aspect ratio of 4:5 to 1.3:1. In certain aspects, the plurality of second gripping structures 34d have a second aspect ratio (i.e., ratio of height h₂ to maximum cross-sectional dimension w₂) of 1:5 to 5:1, including a second aspect ratio of 1:5 to 4:1, a second aspect ratio of 2:5 to 3:1, a second aspect ratio of 1:2 to 2:1, a second aspect ratio of 3:5 to 1.5:1, and also including a second aspect ratio of 4:5 to 1.3:1. In certain aspects, a ratio of the first aspect ratio to the second aspect ratio is from 1:5 to 5:1, including from 1:2 to 4:1, from 8:10 to 3:1, and also including from 1:1 to 2:1.

Referring now to FIG. 2C, the gripping structures 34a, 34b can include sidewalls 35a, 35b and a top wall 35c. In certain aspects, the sidewalls 35a, 35b of the gripping structures 34a, 34b can be tapered or tilted at an angle α of up to 30° from vertical. In certain aspects, the gripping structures 34a, 34b have sidewalls 35a, 35b that are tapered or tilted at an angle α of 3° to 20° from vertical, including from 3° to 15° from vertical, and also including from 3° to 10° from vertical. In certain aspects, various of the gripping structures 34a, 34b can take different forms (e.g., resulting from the manufacturing process for the gripping structures 34a, 34b). As seen in FIG. 2C, the gripping structures 34a, 34b may include a top wall 35c having a cross-sectional dimension (e.g., width) that is less than the maximum cross-sectional dimension w of the gripping structures 34a, 34b. In certain aspects, a ratio of the top wall cross-sectional dimension to the maximum cross-sectional dimension w for the gripping structures 34a, 34b is from 0.05:1 to 0.99:1, including from 0.1:1 to 0.95:1, including from 0.4:1 to 0.95:1, including from 0.5:1 to 0.95:1, and also including from 0.7:1 to 0.9:1. As seen in FIG. 2C, the film 30 has a height hr, also referred to herein as thickness, that is measured from the second film surface 36 to the top wall 35c of the gripping structures 34a, 34b. As previously discussed, the film 30 may have a height hr, or thickness, of 100 μm to 1,000 μm, including any of the ranges previously described. The height h, the maximum cross-sectional dimension w, the pitch p, and the spacing distance s of the gripping structures 34a, 34b of the film 30 illustrated in FIG. 2C may be any of the values for those parameters as previously described herein. Furthermore, as seen in FIG. 2C, the film 30 may have a base height h_{b} that is measured from the second film surface 36 to the first film surface 32, not including the height h of the gripping structures 34a, 34b. In certain aspects, the film 30 has a base height h_{b} of 40 μm to 800 μm, including a base height h_{b} of 60 μm to 600 μm, a base height h_{b} of 60 μm to 400 μm, a base height h_{b} of 60 μm to 200 μm, a base height h_{b} of 50 μm to 200 μm, a base height h_{b} of 50 μm to 175 μm, a base height h_{b} of 50 μm to 150 μm, a base height h_{b} of 50 μm to 125 μm, a base height h_{b} of 50 μm to 100 μm, and also including a base height h_{b} of 50 μm to 75 μm. In certain aspects, the film 30 has a base height h_{b} of 85 μm to 200 μm, including a base height h_{b} of 85 μm to 180 μm, a base height h_{b} of 85 μm to 150 μm, and also including a base height h_{b} of 85 μm to 120 μm. In certain aspects, the film 30 has a base height h_{b} that varies from a minimum height to a maximum height. In certain aspects, the film 30 may have a minimum base height of 40 μm to 120 μm and a maximum base height 90 μm to 200 μm, wherein the minimum base height is less than the maximum base height. In certain aspects, the film 30 may have a minimum base height of 40 μm to 80 μm and a maximum base height 90 μm to 150 μm, wherein the minimum base height is less than the maximum base height. In certain aspects, the film 30 may have a minimum base height of 80 μm to 115 μm and a maximum base height 130 μm to 185 μm, wherein the minimum base height is less than the maximum base height.

The gripping structures 34 may be arranged in various patterns. Referring now to FIGS. 3 and 3A, the gripping structures 34 can be arranged in rows 37a, 37b, 37c. The row 37b can be offset so that the gripping structures 34 align vertically in alternating rows 37a, 37c and the gripping structures 34 of intermediate row 37b are disposed between the gripping structures 34 of the adjacent rows 37a, 37c, as shown in FIG. 3. In certain aspects, the gripping structures 34 can be arranged in a regular grid pattern so that the gripping structures 34 align vertically in rows 37a, 37b, and 37c, as illustrated in FIG. 3A. The gripping structures 34 can be arranged in a regular pattern or an irregular or random pattern. Exemplary patterns in which the gripping structures 34 can be arranged also include, but are not limited to, square, triangular, rectangular, hexagonal, diagonal, or sinusoidal.

The gripping structures 34 may also have a variety of shapes. As seen in FIG. 3, the gripping structures 34 are cuboids or square prisms. Other shapes that may be utilized include, but are not limited to, cylinders (e.g., circular cylinder, elliptic cylinder, domed-top cylinder), cones, pyramids, truncated cones (as shown in FIG. 2C), truncated pyramids, triangular prisms, hexagonal prisms, and octagonal prisms. In certain aspects, at least a portion of the gripping structures 34 have different shapes. For example, in certain aspects, a portion of the gripping structures 34 are shaped as cylinders and a portion of the gripping structures 34 are shaped as cuboids.

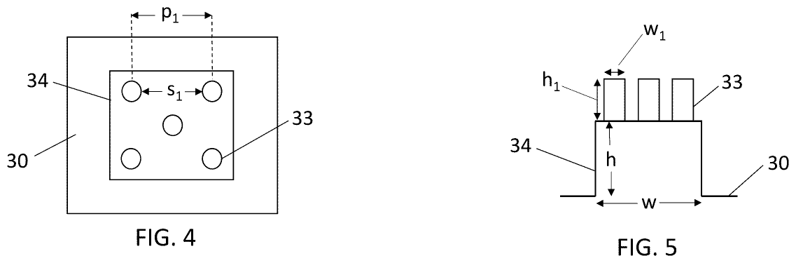

In certain aspects, at least a portion of the gripping structures 34 include a plurality of secondary gripping structures 33 formed on at least one surface (e.g., a top surface) of the gripping structures 34, as illustrated in FIGS. 4 and 5. In certain aspects, all of the gripping structures 34 include a plurality of secondary gripping structures 33 formed on at least one surface (e.g., a top surface) of the gripping structures 34. The secondary gripping structures 33 may have a pitch pi of 10 μm to 25 μm, a spacing distance si of 5 μm to 20 μm, a height h₁ of 5 μm to 20 μm, and a maximum cross-sectional dimension w₁ of 5 μm to 15 μm. The secondary gripping structures 33 can be arranged in any of the patterns and have any of the shapes described above with respect to the gripping structures 34. In certain aspects, the secondary gripping structures 33 have the same shape as the gripping structures 34. In certain aspects, the secondary gripping structures 33 have a different shape as the gripping structures 34, as illustrated in FIG. 4 where the secondary gripping structures 33 are cylinders and the gripping structures 34 are cuboids. In certain aspects, the secondary gripping structures 33 are arranged in the same pattern as the gripping structures 34. In certain aspects, the secondary gripping structures 33 are arranged in a different pattern from the gripping structures 34.

The gripping structures 34 can increase the surface area of the film 30 by 3% to 300% compared to a film without gripping structures (i.e., a flat film). In certain aspects, the gripping structures 34 increase the surface area of the film 30 by 3% to 200%. In certain aspects, the gripping structures 34 increase the surface area of the film 30 by 3% to 100%. In certain aspects, the gripping structures 34 increase the surface area of the film 30 by 10% to 90%. In certain aspects, the gripping structures 34 increase the surface area of the film 30 by 25% to 75%. In certain aspects, the gripping structures 34 increase the surface area of the film 30 by 35% to 55%. In certain aspects, the gripping structures 34 increase the surface area of the film by 100% to 200%, including by 125% to 200%, including by 140% to 200%, and also including by 150% to 200%. In certain aspects, the gripping structures 34 increase the surface area of the film by 60% to 120%, including by 70% to 110%, including by 75% to 100%, and also including by 80% to 95%.

The gripping structures 34 can be formed on the film 30 in a variety of ways. Exemplary methods of forming the gripping structures 34 on the film 30 include, but are not limited to, embossing, stamping, etching, casting, and molding.

Referring now to FIG. 1A, a roofing underlayment 100a according to one aspect of the present disclosure is shown. The roofing underlayment 100a comprises a reinforcement 10 having a first reinforcement surface 12 (e.g., top surface) and a second reinforcement surface 14 (e.g., a bottom surface) and a film 30 having a first film surface 32 and a second film surface 36 opposite the first film surface 32, and a plurality of gripping structures 34 disposed on the first film surface 32. The roofing underlayment 100a can include any configuration of the reinforcements 10, films 30, and gripping structures 34 previously described herein. Accordingly, for the sake of brevity, a detailed description of the reinforcements 10, films 30, and gripping structures 34 will not be repeated with respect to the roofing underlayment 100a illustrated in FIG. 1A.

A difference between the roofing underlayment 100a illustrated in FIG. 1A and the roofing underlayment 100 illustrated in FIG. 1 is the absence of a bonding material 20 between the reinforcement 10 and the film 30. In the roofing underlayment 100a, the first reinforcement surface 12 is adhered to the second film surface 36 without the use of a bonding material 20 (e.g., adhesive, thermoplastic coating). The exclusion of a bonding material 20 can provide a roofing underlayment 100a that is lighter (i.e., lower basis weight) than the roofing underlayment 100 illustrated in FIG. 1. Instead of using a bonding material 20, the reinforcement 10 and the film 30 are adhered using techniques including, but not limited to, calendering, heat pressing, or flame lamination. In such techniques, the reinforcement 10, the film 30, or both may be heated to soften the materials of the reinforcement 10, the film 30, or both, which may then be pressed together (e.g., via a nip) and cooled (e.g., via a cooled roller) to adhere the reinforcement 10 to the film 30.

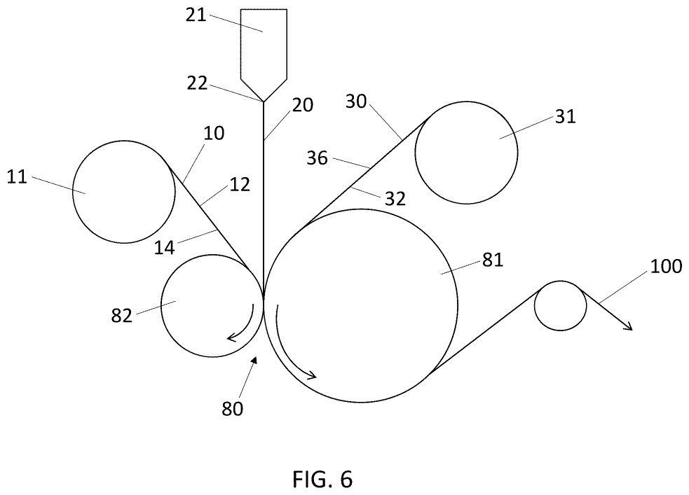

Referring now to FIG. 6, a method of making the roofing underlayment 100 of the present disclosure is shown schematically. As seen in FIG. 6, a reinforcement 10 having a first reinforcement surface 12 and a second reinforcement surface 14 and a film 30 having a first film surface 32 and a second film surface 36 with a plurality of gripping structures (not shown) disposed on the first film surface 32 are unwound from respective supply rolls 11, 31 and directed into a laminating device 80. In addition, a molten thermoplastic coating 20 is directed into the laminating device 80 such that the molten thermoplastic coating 20 is directed between the first reinforcement surface 12 and the second film surface 36. The reinforcement 10, the molten thermoplastic coating 20, and the film 30 are laminated together in the laminating device 80 to form the roofing underlayment 100. The method illustrated in FIG. 6 can be operated in a continuous manner.

In certain aspects, the molten thermoplastic coating 20 is formed by heating and mixing a thermoplastic material in an extruder 21 and extruding a molten thermoplastic from a die 22 (e.g., a slot die) to form the molten thermoplastic coating 20. In certain aspects, the laminating device 80 comprises a nip defined by a pair of counter-rotating rolls 81, 82. As seen in FIG. 6, the molten thermoplastic coating 20 is brought directly into contact with the reinforcement 10 and the film 30, and the molten thermoplastic in pressed into intimate engagement with the reinforcement 10 and the film 30 by directing the materials through the nip defined by the pair of counter-rotating rolls 81, 82. In certain aspects, at least one of the rolls 81, 82 is cooled (e.g., water cooled, thermoelectric cooled) such that the molten thermoplastic cools and solidifies to form the thermoplastic coating 20 that adheres the first reinforcement surface 12 to the second film surface 36, thereby forming the roofing underlayment 100. The at least one roll 81, 82 that is cooled may have a temperature of 21° ° C. to 55° C., including a temperature of 30° C. to 50° C., and also including a temperature of 35° ° C. to 45° C. The roofing underlayment 100 can be collected by winding the roofing underlayment 100 onto a collection roll (not shown) or can be fed to a downstream process that adds one or more additional materials to the roofing underlayment 100 on the second reinforcement surface 14.

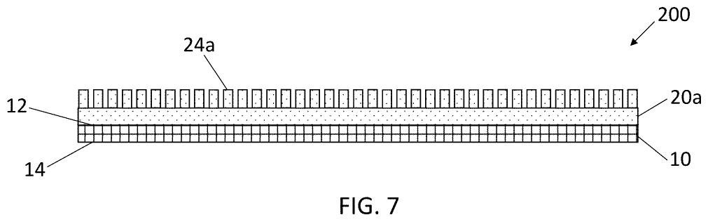

Referring now to FIG. 7, a roofing underlayment 200 of the present disclosure is shown. The roofing underlayment 200 comprises a reinforcement 10 having a first reinforcement surface 12 (e.g., top surface) and a second reinforcement surface 14 (e.g., a bottom surface), and a thermoplastic coating 20a that includes a plurality of gripping structures 24a.

The reinforcement 10 used in the roofing underlayment 200 shown in FIG. 7 may correspond to any one of the reinforcements 10 used in the roofing underlayment 100 shown in FIG. 1 and described in detail above. Accordingly, for the sake of brevity, a detailed description of the reinforcement 10 used in the roofing underlayment 200 will not be repeated.

As seen in FIG. 7, the thermoplastic coating 20a is adhered to the first reinforcement surface 12. The thermoplastic coating 20a can be applied to the reinforcement 10 using an extrusion coating process (including a coextrusion coating process), as described in further detail below. The thermoplastic coating 20a adheres to the first reinforcement surface 12 as a result of being applied to the first reinforcement surface 12 in a molten, flowable form and subsequently solidifying.

The thermoplastic coating 20a of the present disclosure is generally water impermeable and may be formed from a variety of materials. Exemplary materials suitable for forming the thermoplastic coating 20a of the present disclosure include, but are not limited to, a polyolefin (e.g., polypropylene, polyethylene), a polyacrylate, a polyester (e.g., polyethylene terephthalate), a polyamide, a polyimide, a polycarbonate, a polyurethane, a fluoropolymer, a copolymer of an olefin and an α,β-unsaturated carbonyl (e.g., α,β-unsaturated carboxylic acid, α,β-unsaturated ester, α,β-unsaturated amide), a synthetic rubber, a thermoplastic elastomer, and combinations thereof. In certain aspects, the thermoplastic coating 20a comprises at least one of polypropylene, polyethylene, styrene block copolymer (e.g., styrene-butadiene-styrene, styrene-isoprene-styrene, styrene-ethylene/butylene-styrene, styrene-ethylene/propylene), ethylene-vinyl acetate copolymer, ethylene-acrylate copolymer, ethylene-methyl acrylate copolymer, ethylene-ethyl acrylate copolymer, ethylene-butyl acrylate copolymer, polyvinyl chloride, polycaprolactone, polyvinylidene fluoride, or combinations thereof. The material used to form the thermoplastic coating 20a of the present disclosure may be a virgin material, a recycled/reprocessed material, or combinations thereof. In certain aspects, the thermoplastic coating 20a comprises a polyolefin. In certain aspects, the thermoplastic coating 20a comprises at least one of a polypropylene or a polyethylene. In certain aspects, the thermoplastic coating 20a includes multiple layers (e.g., a first coextruded layer and a second coextruded layer, as previously described herein with respect to film 30).

In addition to the thermoplastic material, the thermoplastic coating 20a of the present disclosure can optionally include one or more additives. Exemplary additives include, but are not limited to, fire retardants, dyes, pigments, U.V. stabilizers, anti-static agents, fillers, and so forth. Such additives are well known by those of ordinary skill in the art. Generally, any such additives used in the thermoplastic coating 20a will typically represent less than 25% by weight of the thermoplastic coating 20a. Accordingly, the thermoplastic material will typically represent at least 75% by weight of the thermoplastic coating 20a, including 80% by weight of the thermoplastic coating 20a, 90% by weight of the thermoplastic coating 20a, 95% by weight of the thermoplastic coating 20a, and also including 100% by weight of the thermoplastic coating 20a.

The thermoplastic coating 20a of the present disclosure may have a wide range of basis weights. In certain aspects, the thermoplastic coating 20a has a basis weight of 10 g/m² to 200 g/m². In certain aspects, the thermoplastic coating 20a has a basis weight of 50 g/m² to 195 g/m². In certain aspects, the thermoplastic coating 20a has a basis weight of 75 g/m² to 185 g/m², including a basis weight of 80 g/m² to 175 g/m², a basis weight of 90 g/m² to 150 g/m², a basis weight of 100 g/m² to 140 g/m², and also including a basis weight of 110 g/m² to 125 g/m². In certain aspects, the thermoplastic coating 20a has a basis weight of 15 g/m² to 90 g/m². In certain aspects, the thermoplastic coating 20a has a basis weight of 20 g/m² to 80 g/m², including a basis weight of 25 g/m² to 75 g/m², a basis weight of 30 g/m² to 70 g/m², a basis weight of 35 g/m² to 60 g/m², and also including a basis weight of 40 g/m² to 55 g/m².

In certain aspects, the thermoplastic coating 20a has a basis weight of 10 g/m² to 200 g/m² and comprises at least one of a polypropylene or a polyethylene. In certain aspects, the thermoplastic coating 20a has a basis weight of 50 g/m² to 195 g/m² and comprises 40% to 50% by weight recycled/reprocessed polypropylene, 30% to 40% by weight virgin polypropylene, 10% to 20% by weight LDPE, and 4% to 8% by weight colorant (e.g., color masterbatch), wherein the weight percentages are based on the total weight of the thermoplastic coating 20a. In certain aspects, the thermoplastic coating 20a has a basis weight of 100 g/m² to 200 g/m² and comprises 40% to 50% by weight recycled/reprocessed polypropylene, 35% to 45% by weight virgin polypropylene, 5% to 15% by weight LDPE, and 2% to 6% by weight colorant (e.g., color masterbatch), wherein the weight percentages are based on the total weight of the thermoplastic coating 20a.

The thermoplastic coating 20a of the present disclosure may also have a variety of thicknesses. In certain aspects, the thermoplastic coating 20a (including the plurality of gripping structures 24a) has a total thickness of 20 μm to 1,200 μm. In certain aspects, the film 30 has a total thickness of 50 μm to 1,100 μm, including a total thickness of 100 μm to 1,000 μm, a total thickness of 250 μm to 750 μm, a total thickness of 300 μm to 500 μm, a total thickness of 350 μm to 450 μm, and also including a total thickness of 375 μm to 425 μm. In certain aspects, the thermoplastic coating 20a (including the plurality of gripping structures 24a) has a total thickness of 500 μm to 1,200 μm, including a total thickness of 600 μm to 1,200 μm, a total thickness of 700 μm to 1,200 μm, a total thickness of 800 μm to 1,200 μm, and also including a total thickness of 1,000 μm to 1,200 μm. In certain aspects, the thermoplastic coating 20a (including the plurality of gripping structures 24a) has a total thickness of 20 μm to 100 μm, including a total thickness of 25 μm to 80 μm, a total thickness of 25 μm to 75 μm, a total thickness of 30 μm to 60 μm, and also including a total thickness of 35 μm to 50 μm.

The thermoplastic coating 20a, including the plurality of gripping structures 24a, can be characterized in terms of its hardness. In general, the thermoplastic coating 20a, including the plurality of gripping structures 24a, has a Shore A hardness of about 90 to 100 or a Shore D hardness of about 40 to 100. In certain aspects, the thermoplastic coating 20a, including the plurality of gripping structures 24a, has a Shore A hardness of 95 to 100. In certain aspects, the thermoplastic coating 20a, including the plurality of gripping structures 24a, has a Shore D hardness of 60 to 95, including a Shore D hardness of 65 to 85, and also including a Shore D hardness of 70 to 85.

As seen in FIG. 7, a plurality of gripping structures 24a are positioned on at least a portion of the thermoplastic coating 20a. The above description of the properties (e.g., height, maximum cross-sectional dimension, shape, hardness), arrangements (e.g., pattern, pitch, spacing distance, density, contact area), and other features (e.g., presence of secondary gripping structures) of the gripping structures 34, 34a, 34b, 34c, 34d, 33 of the roofing underlayment 100 illustrated in FIGS. 1 and 2-5 applies equally to the gripping structures 24a of the roofing underlayment 200 illustrated in FIG. 7. Accordingly, for the sake of brevity, a detailed description of the gripping structures 24a of the roofing underlayment 200 shown in FIG. 7 will not be provided separately.

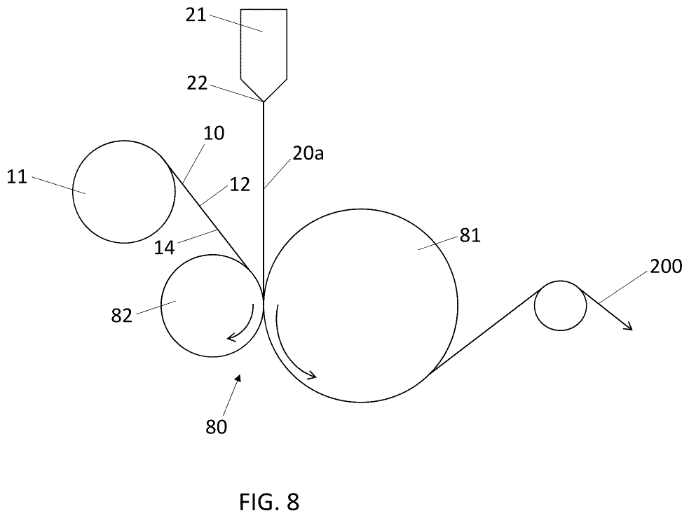

Referring now to FIG. 8, a method of making the roofing underlayment 200 of the present disclosure is shown schematically. As seen in FIG. 8, a reinforcement 10 having a first reinforcement surface 12 and a second reinforcement surface 14 is unwound from a supply roll 11 and directed into a laminating device 80. In addition, a molten thermoplastic coating 20a is directed into the laminating device 80 such that the molten thermoplastic coating 20a is applied to the first reinforcement surface 12. The reinforcement 10 and the molten thermoplastic coating 20a are laminated together in the laminating device 80 to form the roofing underlayment 200. The method illustrated in FIG. 8 can be operated in a continuous manner.

In certain aspects, the molten thermoplastic coating 20a is formed by heating and mixing a thermoplastic material in an extruder 21 and extruding a molten thermoplastic from a die 22 (e.g., a slot die) to form the molten thermoplastic coating 20a. In certain aspects, a coextrusion process is used to form the molten thermoplastic coating 20a. In certain aspects, a coextrusion process is used to produce a molten thermoplastic coating 20a having a first coextruded layer that includes a U.V. protective component and a second coextruded layer. It is contemplated that additional coextruded layers beyond a second coextruded layer could be present. Accordingly, the term “second coextruded layer” refers to any number of coextruded layers after the first coextruded layer (i.e., top layer) that includes the U.V. protective component. The first coextruded layer of the thermoplastic coating 20a may include any one or more of the materials previously mentioned as being suitable for forming the thermoplastic coating 20a. The second coextruded layer of the thermoplastic coating 20a may include any one or more of the materials previously mentioned as being suitable for forming the thermoplastic coating 20a. In certain aspects, the material used to form the first coextruded layer of the thermoplastic coating 20a (not considering the U.V. protective component) may be the same as the material used to form the second coextruded layer of the thermoplastic coating 20a. In certain aspects, the material used to form the first coextruded layer of the thermoplastic coating 20a (not considering the U.V. protective component) may be different from the material used to form the second coextruded layer of the thermoplastic coating 20a. In certain aspects, the first coextruded layer of the thermoplastic coating 20a may have a basis weight of 3 g/m² to 150 g/m². In certain aspects, the second coextruded layer of the thermoplastic coating 20a may have a basis weight of 10 g/m² to 150 g/m².

In certain aspects, the laminating device 80 comprises a nip defined by a pair of counter-rotating rolls 81, 82. As seen in FIG. 8, the molten thermoplastic coating 20a is brought directly into contact with the reinforcement 10 and the molten thermoplastic is pressed into intimate engagement with the reinforcement 10 by directing the materials through the nip defined by the pair of counter-rotating rolls 81, 82.

The roll 81 may have on its outer surface a desired pattern for transference to the molten thermoplastic coating 20a as it contacts the roll 81. In certain aspects, the outer surface of the roll 81 has a plurality of cavities adapted to form a plurality of gripping structures having desired characteristics (e.g., height, maximum cross-sectional dimension, pitch, spacing distance, density, contact area). The cavities may be arranged, sized, and shaped as required to form the plurality of gripping structures with the molten thermoplastic coating 20a. The cavities may be formed on the roll 81 in any suitable manner including, but not limited to, drilling, machining, laser drilling, water jet machining, casting, etching, electroforming, die punching, turning, engraving, knurling, and the like. Alternatively, the cavities may be formed on a secondary material (e.g., a shim) (not shown) that is fixedly or removably attached to the roll 81.

In certain aspects, at least one of the rolls 81, 82 is cooled (e.g., water cooled, thermoelectric cooled) such that that molten thermoplastic cools and solidifies to form the thermoplastic coating 20a including a plurality of gripping structures that adheres to the first reinforcement surface 12, thereby forming the roofing underlayment 200. The at least one roll 81, 82 that is cooled may have a temperature of 21° C. to 55° C., including a temperature of 30° C. to 50° C., and also including a temperature of 35° C. to 45° C. The roofing underlayment 200 can be collected by winding the roofing underlayment 200 onto a collection roll (not shown) or can be fed to a downstream process that adds one or more additional materials to the roofing underlayment 200 on the second reinforcement surface 14.

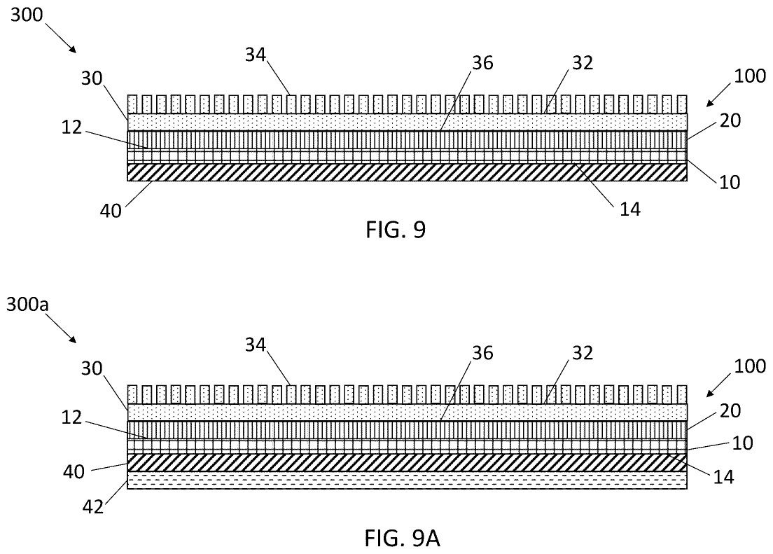

In certain aspects, the roofing underlayments 100, 100a, 200 of the present disclosure include a bottom coating 40 adhered to the second reinforcement surface 14. As seen in FIG. 9, a roofing underlayment 300 includes the structure of roofing underlayment 100, as previously described herein, with a bottom coating 40 adhered to the second reinforcement surface 14. Although not shown, the roofing underlayment 300 could instead include the structure of roofing underlayments 100a, 200, as previously described herein, with a bottom coating 40 adhered to the second reinforcement surface 14.

The bottom coating 40 of the present disclosure is generally water impermeable and may be formed from a variety of materials. Exemplary materials suitable for forming the bottom coating 40 of the present disclosure include, but are not limited to, a polyolefin (e.g., polypropylene, polyethylene), a polyacrylate, a polyester (e.g., polyethylene terephthalate), a polyamide, a polyimide, a polycarbonate, a polyurethane, a fluoropolymer, a copolymer of an olefin and an α,β-unsaturated carbonyl (e.g., α,β-unsaturated carboxylic acid, α,β-unsaturated ester, α,β-unsaturated amide), a synthetic rubber, a thermoplastic elastomer, or combinations thereof. In certain aspects, the bottom coating 40 comprises at least one of polypropylene, polyethylene, styrene block copolymer (e.g., styrene-butadiene-styrene, styrene-isoprene-styrene, styrene-ethylene/butylene-styrene, styrene-ethylene/propylene), ethylene-vinyl acetate copolymer, ethylene-acrylate copolymer, ethylene-methyl acrylate copolymer, ethylene-ethyl polyvinylidene fluoride, or combinations thereof. The material used to form the bottom coating 40 of the present disclosure may be a virgin material, a recycled/reprocessed material, or combinations thereof. In certain aspects, the bottom coating 40 comprises at least one of a polyolefin or a thermoplastic elastomer. In certain aspects, the bottom coating 40 comprises at least one of a polypropylene, a polyethylene, or a thermoplastic elastomer.

In addition, the bottom coating 40 of the present disclosure can optionally include one or more additives. Exemplary additives include, but are not limited to, fire retardants, dyes, pigments, UV stabilizers, anti-static agents, fillers, and so forth. Such additives are well known by those of ordinary skill in the art. Generally, any such additives used in the bottom coating 40 will typically represent less than 25% by weight of the bottom coating 40, including less than 20% by weight of the bottom coating 40, including less than 15% by weight of the bottom coating, including less than 10% by weight of the bottom coating 40, and also including less than 5% by weight of the bottom coating 40.

In certain aspects, the bottom coating 40 is a coextruded coating comprising a thermoplastic elastomer extrudate and a polyolefin extrudate. In certain aspects, the thermoplastic elastomer extrudate of the bottom coating 40 comprises a thermoplastic elastomer and a polyolefin, such as a polypropylene and/or a polyethylene. In certain aspects, the polyolefin extrudate of the bottom coating 40 comprises at least one of a polypropylene and a polyethylene. The thermoplastic elastomer extrudate and/or the polyolefin extrudate of the bottom coating 40 of the present disclosure may also comprise additives such as colorants, pigments, antioxidants, U.V. stabilizers, fire retardants, fillers, and the like.

In certain aspects, the bottom coating 40 is applied to the second reinforcement surface 14 of the roofing underlayment 100 (or roofing underlayments 100a, 200) as a curtain of molten material comprising a thermoplastic elastomer extrudate and a polyolefin extrudate, which are laminated together to form the roofing underlayment 300. Preferably, the polyolefin extrudate of the bottom coating 40 is adhered to the second reinforcement surface 14 and the thermoplastic elastomer extrudate of the bottom coating 40 forms an exterior surface (i.e., the surface intended to contact a roof deck or other substrate) of the roofing underlayment 300. Because of the rubbery nature and gripping ability associated with thermoplastic elastomer materials, including a thermoplastic elastomer as a portion of the bottom coating 40 that forms an exterior surface of the roofing underlayment 300 can provide enhanced traction between the roofing underlayment 300 and a roof deck or other substrate.

In certain aspects, the bottom coating 40 of the present disclosure has a basis weight of 10 g/m² to 150 g/m². In certain aspects, the bottom coating 40 has a basis weight of 15 g/m² to 75 g/m². In certain aspects, the bottom coating 40 has a basis weight of 20 g/m² to 50 g/m². In certain aspects, the bottom coating 40 has a basis weight of 20 g/m² to 30 g/m².

Referring now to FIG. 9A, a roofing underlayment 300a is illustrated that includes a bottom coating 40 and a bottom film 42. As illustrated in FIG. 9A, the roofing underlayment 300a includes the structure of roofing underlayment 100, as previously described herein, with the bottom coating 40 functioning to adhere the bottom film 42 to the second reinforcement surface 14. Although not shown, the roofing underlayment 300a could instead include the structure of roofing underlayments 100a, 200, as previously described herein, with a bottom coating 40 that adheres a bottom film 42 to the second reinforcement surface 14. The bottom coating 40 of the roofing underlayment 300a may comprise any of the materials and features described above with respect to the roofing underlayment 300.

The bottom film 42 of the present disclosure is generally water impermeable and may be formed from a variety of materials. Thus, the addition of the bottom film 42 may improve the water resistance of the roofing underlayment 300a. Exemplary materials suitable for forming the bottom film 42 of the present disclosure include, but are not limited to, a polyolefin (e.g., polypropylene, polyethylene), a polyacrylate, a polyester (e.g., polyethylene terephthalate), a polyamide, a polyimide, a polycarbonate, a polyurethane, a fluoropolymer, a copolymer of an olefin and an α,β-unsaturated carbonyl (e.g., α,β-unsaturated carboxylic acid, α,β-unsaturated ester, α,β-unsaturated amide), a synthetic rubber, a thermoplastic elastomer, and combinations thereof. In certain aspects, the bottom film 42 comprises at least one of polypropylene, polyethylene, styrene block copolymer (e.g., styrene-butadiene-styrene, styrene-isoprene-styrene, styrene-ethylene/butylene-styrene, styrene-ethylene/propylene), ethylene-vinyl acetate copolymer, ethylene-acrylate copolymer, ethylene-methyl acrylate copolymer, ethylene-ethyl polyvinylidene fluoride, or combinations thereof. In certain aspects, the bottom film 42 comprises a polyolefin. In certain aspects, the bottom film 42 comprises at least one of a polypropylene or a polyethylene. In certain aspects, the bottom film 42 comprises at least one of ethylene-vinyl acetate (EVA) copolymer, ethylene-methyl acrylate (EMA) copolymer, and a thermoplastic elastomer (TPE).

The bottom film 42 of the present disclosure may be configured with a wide range of basis weights. In certain aspects, the bottom film 42 has a basis weight of 10 g/m² to 150 g/m². In certain aspects, the bottom film 42 has a basis weight of 20 g/m² to 60 g/m². In certain aspects, the bottom film 42 has a basis weight of 25 g/m² to 60 g/m², including a basis weight of 30 g/m² to 55 g/m², and also including a basis weight of 35 g/m² to 50 g/m².

The roofing underlayments 300, 300a shown in FIGS. 9 and 9A generally have a planar bottom surface formed by the bottom coating 40 or the bottom film 42 to maximize surface contact with a substrate (e.g., a roofing deck). Accordingly, the roofing underlayments 300, 300a have a bottom surface area defined by the dimensions (i.e., length and width) of the roofing underlayments 300, 300a. The roofing underlayments 300, 300a have a top surface that is defined by the first film surface 32 that includes the plurality of gripping structures 34. Thus, the roofing underlayments 300, 300a have a top surface area that includes the surface area of each gripping structure 34 and the surface area of the first film surface 32 that is not occupied by a gripping structure 34. In certain aspects, the roofing underlayments 300, 300a are configured such that a ratio of a top surface area of the roofing underlayments 300, 300a to a bottom surface area of the roofing underlayments is from 1.03:1 to 3:1. In certain aspects, the roofing underlayments 300, 300a are configured such that a ratio of a top surface area of the roofing underlayments 300, 300a to a bottom surface area of the roofing underlayments is from 1.05:1 to 1.9:1. In certain aspects, the roofing underlayments 300, 300a are configured such that a ratio of a top surface area of the roofing underlayments 300, 300a to a bottom surface area of the roofing underlayments is from 1.1:1 to 1.5:1. In certain aspects, the roofing underlayments 300, 300a are configured such that a ratio of a top surface area of the roofing underlayments 300, 300a to a bottom surface area of the roofing underlayments is from 2:1 to 3:1. In certain aspects, the roofing underlayments 300, 300a are configured such that a ratio of a top surface area of the roofing underlayments 300, 300a to a bottom surface area of the roofing underlayments is from 2.3:1 to 3:1. In certain aspects, the roofing underlayments 300, 300a are configured such that a ratio of a top surface area of the roofing underlayments 300, 300a to a bottom surface area of the roofing underlayments is from 2.6:1 to 3:1.

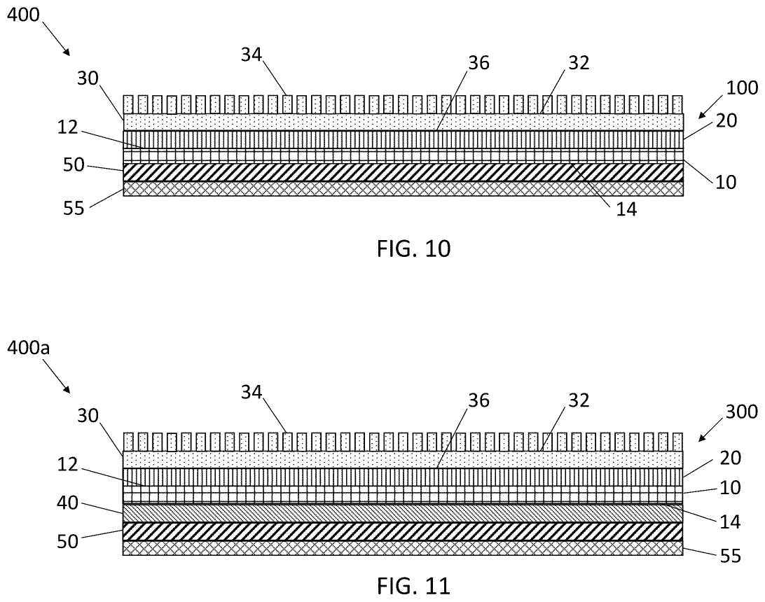

The roofing underlayments 100, 100a, 200, 300, 300a of the present disclosure can be attached to a substrate, such as a roof deck, using conventional fasteners (e.g., nails, staples). Alternatively, the roofing underlayments 100, 100a, 200, 300, 300a of the present disclosure may be configured as self-adhered (e.g., peel and stick) underlayments such that no fasteners are required to attach the underlayment to a substrate, such as a roof deck. Examples of self-adhered underlayments 400, 400a, 500, 500a are illustrated in FIGS. 10, 11, 12, and 13, respectively.

As seen in FIG. 10, a roofing underlayment 400 includes the structure of roofing underlayment 100, as previously described herein, and has an adhesive coating 50 adhered to the second reinforcement surface 14 and an optional release liner 55 optionally adhered to a surface of the adhesive coating 50 opposite the second reinforcement surface 14. Although not shown, the roofing underlayment 400 could instead include the structure of roofing underlayments 100a, 200, as previously described herein, with an adhesive coating 50 adhered to the second reinforcement surface 14 and an optional release liner 55 optionally adhered to a surface of the adhesive coating 50 opposite the second reinforcement surface 14. The adhesive coating 50 may comprise a variety of materials. Exemplary materials for forming the adhesive coating 50 include, but are not limited to, an asphalt-based material, a butyl-based adhesive, an acrylic-based adhesive, a hot melt adhesive, and so forth.

As seen in FIG. 11, a roofing underlayment 400a includes the structure of roofing underlayment 300 (which can include the structure of roofing underlayments 100, 100a, or 200), as previously described herein, and has an adhesive coating 50 adhered to the bottom coating 40 and an optional release liner 55 optionally adhered to a surface of the adhesive coating 50 opposite the bottom coating 40.

In certain aspects, the adhesive coating 50 of the present disclosure comprises a polymer modified asphalt that functions as an adhesive. The polymer modified asphalt may comprise any suitable asphalt and any suitable polymer, or any suitable mixture of different asphalts and/or different polymers. Exemplary polymer materials include, but are not limited to, elastomeric polymers, which are natural or synthetic rubbers and include butyl rubber, polybutadiene rubber, polyisoprene rubber, and polyisobutene rubber, styrene/butadiene copolymers such as styrene/butadiene/styrene triblock copolymer (SBS) and styrene/ethylene-butylene/styrene triblock copolymer (SEBS), styrene/isoprene copolymer, epoxy modified acrylate copolymer, ethylene/vinyl acetate copolymer (EVA), ethylene/propylene/diene terpolymer (EPDM), polyacrylate, polymethacrylate, and polychloroprene. In certain aspects, the polymer materials include, but are not limited to, non-elastomeric materials such as polyolefins. In certain aspects, the adhesive coating 50 of the present disclosure comprises an asphalt layer and a polymer modified asphalt layer. In certain aspects, the asphalt layer is applied to the second reinforcement surface 14 or the bottom coating 40 and the polymer modified asphalt layer is applied to the asphalt layer opposite the second reinforcement surface 14 or the bottom coating 40. In certain aspects, the asphalt layer of the adhesive coating 50 has a thickness of 0.12 mm to 0.8 mm, including a thickness of 0.2 mm to 0.7 mm, a thickness of 0.3 mm to 0.6 mm, and also including a thickness of 0.35 mm to 0.5 mm. In certain aspects, the polymer modified asphalt layer of the adhesive coating 50 has a thickness of 0.25 mm to 1.55 mm, including a thickness of 0.35 mm to 1.4 mm, a thickness of 0.5 mm to 1.1 mm, and also including a thickness of 0.7 mm to 1 mm. In certain aspects, the adhesive coating 50 has a total thickness of 0.254 mm to 2.3 mm, including a total thickness of 0.35 mm to 2.1 mm, a total thickness of 0.5 mm to 1.95 mm, a total thickness of 0.55 mm to 1.85 mm, a total thickness of 0.6 mm to 1.75 mm, and also including a total thickness of 0.75 mm to 1.5 mm. In certain aspects, the adhesive coating 50 of the present disclosure comprises a non-asphaltic coating that includes butyl rubber. In certain aspects, the adhesive coating 50 of the present disclosure comprises a non-asphaltic acrylic adhesive coating.

Referring to FIGS. 10 and 11, the roofing underlayments 400, 400a may include a release liner 55. In certain aspects, the release liner 55 comprises at least one of a paper, a polypropylene, a polyethylene, or a polyester that is treated with a release material (e.g., silicone resin) on a surface thereof (i.e., the surface that contacts the adhesive coating 50). In certain aspects, the release liner 55 is a contiguous sheet. In certain aspects, the release liner 55 is a split sheet.

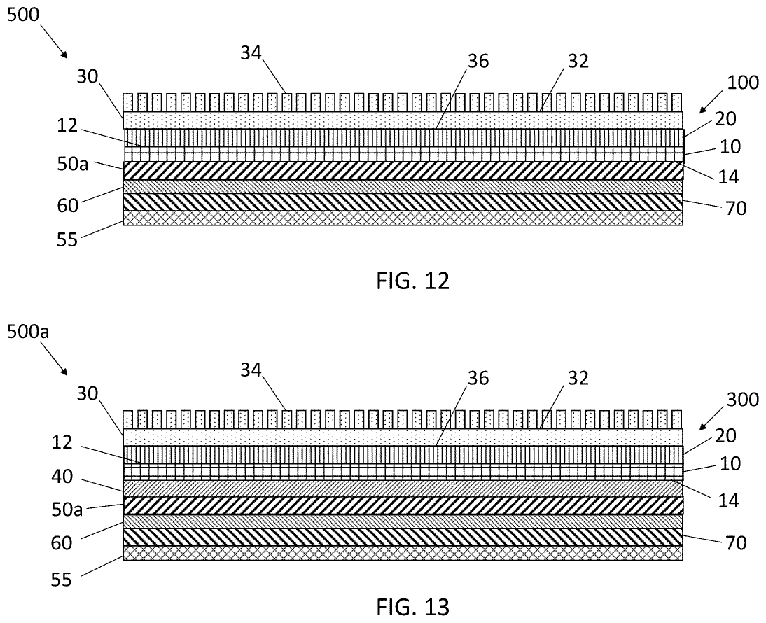

Referring to FIG. 12, a roofing underlayment 500 includes the structure of roofing underlayment 100, as previously described herein, and also includes a first asphalt coating 50a, a glass mat 60, a second asphalt coating 70, and an optional release liner 55. As seen in FIG. 12, the first asphalt coating 50a is adhered to the second reinforcement surface 14 and the glass mat 60 is positioned between the first asphalt coating 50a and the second asphalt coating 70. With this arrangement, the glass mat 60 is typically at least partially impregnated with the first asphalt coating 50a, the second asphalt coating 70, or a combination of the first and second asphalt coatings 50a, 70. In certain aspects, the glass mat 60 is fully impregnated (or saturated) with the first asphalt coating 50a, the second asphalt coating 70, or a combination of the first and second asphalt coatings 50a, 70. The first asphalt coating 50a and the second asphalt coating 70 each may be a polymer modified asphalt coating material or a non-polymer modified asphalt coating material. In certain aspects, the first asphalt coating 50a and the second asphalt coating 70 comprise the same asphalt coating material. In certain aspects, the first asphalt coating 50a and the second asphalt coating 70 comprise different asphalt coating materials. When present, the release liner 55 is adhered to a surface of the second asphalt coating 70 opposite the glass mat 60. Although not shown, the roofing underlayment 500 could instead include the structure of roofing underlayments 100a, 200, as previously described herein, with the first asphalt coating 50a adhered to the second reinforcement surface 14, the glass mat 60 positioned between the first asphalt coating 50a and the second asphalt coating 70, and the optional release liner 55 optionally adhered to the surface of the second asphalt coating 70 opposite the glass mat 60. While the roofing underlayment 500 is shown having a glass mat 60, in alternative aspects, the glass mat 60 can be replaced with at least one of a polyester mat, a mesh, or a film. While the roofing underlayment 500 is shown with reinforcement 10 and bonding material 20, in alternative aspects, the roofing underlayment 500 may take the form shown in FIG. 12 but without the reinforcement 10 and the bonding material 20.

Referring to FIG. 13, a roofing underlayment 500a includes the structure of roofing underlayment 300 (which can include the structure of roofing underlayments 100, 100a, or 200), as previously described herein, and also includes a first asphalt coating 50a, a glass mat 60, a second asphalt coating 70, and an optional release liner 55. As seen in FIG. 13, the first asphalt coating 50a is adhered to the bottom coating 40 and the glass mat 60 is positioned between the first asphalt coating 50a and the second asphalt coating 70. With this arrangement, the glass mat 60 is typically at least partially impregnated with the first asphalt coating 50a, the second asphalt coating 70, or a combination of the first and second asphalt coatings 50a, 70. In certain aspects, the glass mat 60 is fully impregnated (or saturated) with the first asphalt coating 50a, the second asphalt coating 70, or a combination of the first and second asphalt coatings 50a, 70. The first asphalt coating 50a and the second asphalt coating 70 each may be a polymer modified asphalt coating material or a non-polymer modified asphalt coating material. In certain aspects, the first asphalt coating 50a and the second asphalt coating 70 comprise the same asphalt coating material. In certain aspects, the first asphalt coating 50a and the second asphalt coating 70 comprise different asphalt coating materials. When present, the release liner 55 is adhered to a surface of the second asphalt coating 70 opposite the glass mat 60. While the roofing underlayment 500a is shown having a glass mat 60, in alternative aspects, the glass mat 60 can be replaced with at least one of a polyester mat, a mesh, or a film. While the roofing underlayment 500a is shown with reinforcement 10, bonding material 20, and bottom coating 40, in alternative aspects, the roofing underlayment 500a may take the form shown in FIG. 13 but without the reinforcement 10, the bonding material 20, and the bottom coating 40.

In certain aspects, the first asphalt coating 50a of the present disclosure comprises a polymer modified asphalt that functions as an adhesive for joining the glass mat 60 to the reinforcement 10 (as seen in FIG. 12) or to the bottom coating 40 (as seen in FIG. 13). The polymer modified asphalt may comprise any suitable asphalt and any suitable polymer, or any suitable mixture of different asphalts and/or different polymers. Any of the previously described polymers discussed above with respect to the asphalt coating 50 may be used to form the polymer modified asphalt used in the first asphalt coating 50a. In certain aspects, the first asphalt coating 50a has a thickness of 0.05 mm to 0.525 mm, including a thickness of 0.1 mm to 0.5 mm, a thickness of 0.15 mm to 0.4 mm, and also including a thickness of 0.2 mm to 0.3 mm.

As mentioned above, the roofing underlayments 500, 500a include a glass mat 60. The glass mat 60 can impart strength and stiffness to the roofing underlayments 500, 500a. The glass mat 60 can be a nonwoven glass mat or a woven glass mat and can be formed of any of the previously mentioned glasses (e.g., A-glass, E-glass, S-glass, ECR-glass). In certain aspects, the glass mat 60 is a nonwoven glass mat. In certain aspects, the glass mat 60 has a basis weight of 48 g/m² to 150 g/m², including a basis weight of 55 g/m² to 90 g/m², a basis weight of 65 g/m² to 85 g/m², and also including a basis weight of 70 g/m² to 76 g/m².

As seen in FIGS. 12 and 13, the roofing underlayments 500, 500a include a second asphalt coating 70. In certain aspects, the second asphalt coating 70 of the present disclosure comprises a polymer modified asphalt that functions as an adhesive. The polymer modified asphalt may comprise any suitable asphalt and any suitable polymer, or any suitable mixture of different asphalts and/or different polymers. Any of the previously described polymers discussed above with respect to the asphalt coating 50 may be used to form the polymer modified asphalt used in the second asphalt coating 70. In certain aspects, the second asphalt coating 70 of the present disclosure comprises a non-polymer modified asphalt layer and a polymer modified asphalt layer. In certain aspects, the non-polymer modified asphalt layer is applied to the glass mat 60 opposite the first asphalt coating 50a and the polymer modified asphalt layer is applied to the non-polymer modified asphalt layer opposite the glass mat 60. In certain aspects, the non-polymer modified asphalt layer of the second asphalt coating 70 has a thickness of 0.05 mm to 0.8 mm, including a thickness of 0.12 mm to 0.8 mm, a thickness of 0.1 mm to 0.7 mm, a thickness of 0.1 mm to 0.5 mm, a thickness of 0.1 mm to 0.3 mm, a thickness of 0.2 mm to 0.7 mm, a thickness of 0.3 mm to 0.6 mm, and also including a thickness of 0.35 mm to 0.5 mm. In certain aspects, the polymer modified asphalt layer of the second asphalt coating 70 has a thickness of 0.2 mm to 1.55 mm, including a thickness of 0.3 mm to 1.55 mm, a thickness of 0.3 mm to 1.4 mm, a thickness of 0.3 mm to 1 mm, a thickness of 0.3 mm to 0.7 mm, a thickness of 0.35 mm to 1.4 mm, a thickness of 0.5 mm to 1.1 mm, and also including a thickness of 0.7 mm to 1 mm. In certain aspects, the second asphalt coating 70 has a total thickness of 0.35 mm to 2.3 mm, including a total thickness of 0.35 mm to 2.1 mm, a total thickness of 0.5 mm to 1.95 mm, a total thickness of 0.55 mm to 1.85 mm, a total thickness of 0.6 mm to 1.75 mm, and also including a total thickness of 0.75 mm to 1.5 mm.

With continued reference to FIGS. 12 and 13, the roofing underlayments 500, 500a may include a release liner 55. In certain aspects, the release liner 55 comprises at least one of a paper, a polypropylene, a polyethylene, or a polyester that is treated with a release material (e.g., silicone resin) on a surface thereof (i.e., the surface that contacts the second asphalt coating 70). In certain aspects, the release liner 55 is a contiguous sheet. In certain aspects, the release liner 55 is a split sheet.

The roofing underlayments 100, 100a, 200, 300, 300a, 400, 400a, 500, 500a of the present disclosure are typically provided for use in a rolled configuration. The roofing underlayments 100, 100a, 200, 300, 300a, 400, 400a, 500, 500a of the present disclosure generally have a width of 0.6 meters (m) to 2 m, a length of 9 m to 100 m, and a thickness of 125 μm to 2,500 μm.

While the term “roofing underlayment” is used herein to describe the various multilayer structures illustrated in the figures and described in detail, it is contemplated that the multilayer structures, particularly the structures 100, 100a, 200, 300, and 300a, can be used in a variety of applications where walkability and slip resistance may be important. A non-limiting list of potential applications for the multilayer structures illustrated and described herein include other construction applications (e.g., flooring underlayments, flooring protection, structural panels, decking, etc.) and packaging applications (e.g., lumber wrap, lumber covers, steel wrap, etc.).

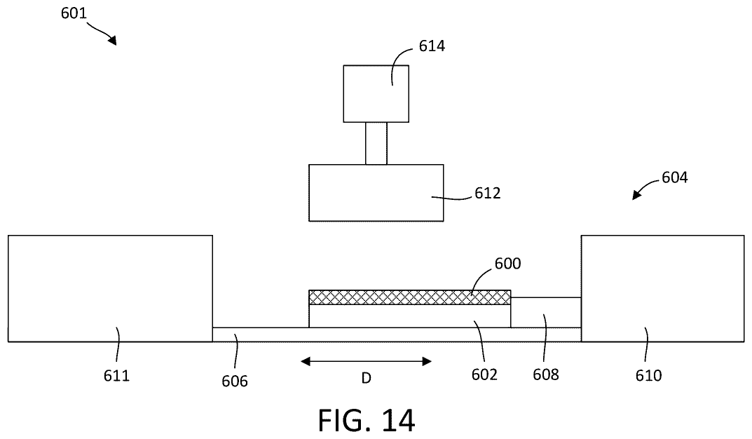

FIGS. 14-16 illustrate a schematic view of an example method for determining a coefficient of friction for a roofing underlayment 600. In the illustrated example, the method is performed using a testing device 601. However, it should be understood that the method can be performed by any other suitable means that allows for the coefficient of friction of the roofing underlayment 600 to be calculated. The method can be performed to determine a coefficient of friction for any roofing underlayment, such as, for example, any roofing underlayment described in the present application. This method is a modified version of a standard test method developed by SATRA Technology Centre titled “Measuring the Coefficient of Friction for Evaluation of Slip Performance of Footwear and Test Surfaces/Flooring Using a Whole Shoe Tester,” which is described in the ASTM F2913-19. It should be understood that the example method described in the present application includes the conditions and features described in ASTM F2913-19 unless otherwise provided in the present application or contradictory with the method described herein.

Referring to FIG. 14, a roofing underlayment 600 is secured to an underfoot surface 602 such that the roofing underlayment 600 is substantially prevented from moving relative to the underfoot surface 602 during performance of the method. The roofing underlayment 600 can be attached to the underfoot surface 602 by an adhesive (e.g., hot melt adhesives, butyl-based adhesives, and acrylic-based adhesives, etc.), another type of fastener (e.g., a staple, a nail, etc.), or any combination thereof. The connection between the roofing underlayment 600 and the underfoot surface must be strong enough and fastened sufficiently that it does not move, tear, stretch, etc. as the method is being performed. The reasons that the connection needs to be sufficiently strong is because the device 601 measures a force that resists motion of the sliding member 606 (described below) and reports the measured force as a coefficient of friction for the underlayment 600 (or other type of sample), which means that it is important that the only portion of the underlayment 600 resisting motion is the coefficient of friction and not stretching or movement of the underlayment relative to the underfoot surface 602. The underfoot surface 602 can take any suitable form, such as any form described in ASTM F2913-19. In some examples, the underfoot surface 602 can be an upper surface of an oriented strand board (OSB). However, it should be understood that the underfoot surface 602 can take any other suitable form.

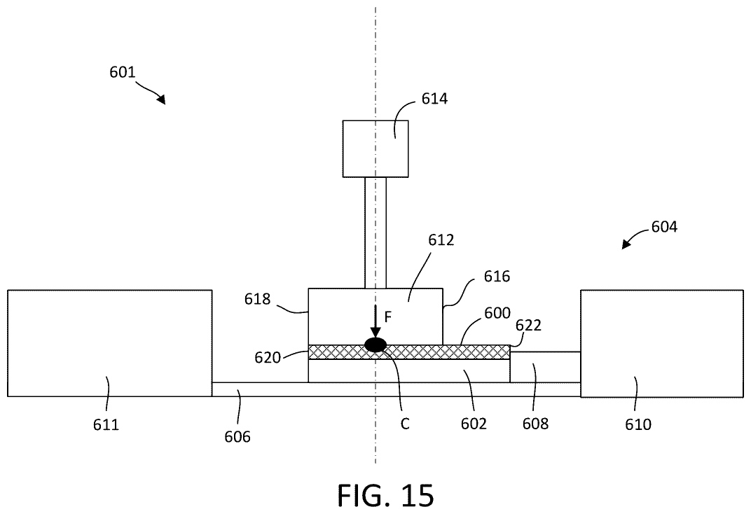

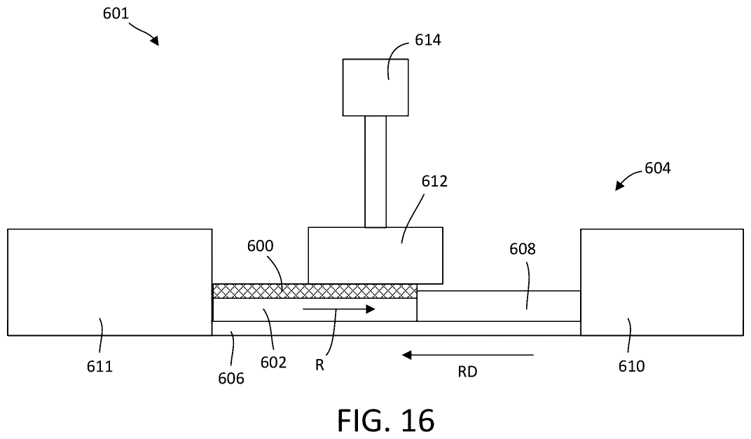

The underfoot surface 602 and attached roofing underlayment 600 can be placed onto a sliding table 604 that includes a sliding member 606 and an engagement element 608. The sliding member 606 and engagement element 608 are movable in a horizontal direction D between a first position (as shown in FIGS. 14 and 15) and a second position (as shown in FIG. 16). The table 604 can optionally have a first housing 610 and/or a second housing 611 that are configured to receive portions of the sliding member 606 during movement of the sliding member 606 in the direction D. The device 601 can include an actuation mechanism (not shown), which can take any suitable form that is capable of moving the sliding member 606 and engagement element 608 between the first and second positions.

Footwear 612 is placed onto a holding device 614 that is capable of holding the footwear 612 in a desired position relative to the underfoot surface 602 and the roofing underlayment 600. The footwear 612 is movable between a disengaged position (as shown in FIG. 14) in which the footwear 612 is not engaging the roofing underlayment 600 and an engaged position (as shown in FIGS. 15-16) in which the footwear 612 is engaging the roofing underlayment 600. In order for the testing results of different underlayments to be consistent, the same or substantially same type of footwear should be used for the testing of each roofing underlayment. The connection between the footwear 612 and the holding device 614 can take any suitable form that allows for the footwear 612 to be engaged with the roofing underlayment to obtain a coefficient of friction of the roofing underlayment. For example, the connection between the footwear 612 and the holding device 614 can take any suitable form described with reference to ASTM F2913-19. Similar to the connection described above between the roofing underlayment 600 and the underfoot surface 602, the connection between the footwear 612 and the holding device 614 must be strong enough and fastened sufficiently such that the footwear does not slip or otherwise move as the method is being performed. The device 601 can include an actuation mechanism (not shown), which can take any suitable form that is capable of moving the footwear 612 between the disengaged and engaged positions.

Referring to FIG. 14, the footwear 612 is disposed in the disengaged position above the roofing underlayment 600. Referring to FIG. 15, the footwear 612 is moved to the engaged position (via an actuation mechanism of the holding device 614) such that the footwear 612 is engaging the underlayment 600. The footwear 612 is positioned in forward flat slip mode as defined in ASTM F2913-19. In various examples, a rear end 618 of the footwear 612 is substantially aligned with a rear edge 620 of the underlayment 600 and underfoot surface 602, and the front surface 616 is positioned closer to a front end 622 of the underfoot surface 602 as compared to the rear edge 618 of the footwear 612, when the sliding member 606 of the sliding table 604 is in the first position (as shown in FIGS. 14 and 15). In other examples, the rear end 618 of the footwear 612 can be positioned further inward relative to the underfoot surface 602 when in the engaged position with the sliding member 606 of the sliding table 604 in the first position.

The holding device 614 can be configured to provide a force F at a center point of contact C between the footwear 612 and underfoot surface 602 (via the contact between the footwear 612 and the roofing underlayment 600). For example, the actuation mechanism of the device 600 that moves the footwear 612 between the engaged and disengaged positions can be configured to provide the force F at contact point C by pushing down on the footwear 612.

Referring to FIG. 16, after the footwear 612 is moved to the engaged position such that the force F is provided onto the roofing underlayment 600 at point C (as shown in FIG. 15), the sliding member 606 and engagement element 608 are moved in the rearward direction RD such that the engagement between the underlayment 600 and the footwear 612 creates a frictional force R on the underlayment 600. The engagement element 608 engages the underfoot surface 602 to ensure that the underfoot surface 602 and underlayment 600 move with the sliding member 606 as the sliding member moves from the first position to the second position. In various examples, the sliding member 606 is configured to move at a speed consistent with the method described in ASTM F2913-19.

The coefficient of friction is calculated by the device 601. The engagement between the roofing underlayment 600 and the footwear 612 (with the force F at contact point C) and the movement of the sliding member 606 in the rearward direction RD allows the device 601 to measure a force that resists motion of the sliding member 606. This measured force is then used to determine the coefficient of friction of the underlayment 600 because of the secure connection between the underlayment 600 and underfoot surface 602, the secure connection between the footwear 612 and the holding device 614. When all of the variables for the device 601 and footwear 612 are consistent, but different underlayments 600 are tested, the measured coefficient of friction for each underlayment can be compared to each other. That is, if the only different variable during testing trials is the roofing underlayment 600, the device 601 can provide measured coefficient of frictions that allow for the underlayments to be compared to each other.

The method described with reference to FIGS. 14-16 can be performed to determine the coefficient of friction for various types of roofing underlayments (as well as other types of flooring materials). The method can also be modified based on potential weather and/or working conditions at which the roofing underlayment will be used. For example, the underlayment 600 can be tested under dry, wet, and sawdust conditions. For dry and wet conditions, the method can take any form described with reference to ASTM F2913-19. A condition that typically occurs with roofing underlayments is “sawdust conditions,” which takes into account sawdust that is typically on worksites in which roofing underlayments are used. For sawdust conditions, between a particular amount of sawdust is applied over the roofing underlayment prior to testing. In various examples, sawdust is not reapplied or respread on the roofing underlayment in between runs on of the same sample. A difference between the method described with reference to FIGS. 14-16 and the method of ASTM F2913-19 is that the method of the present application does not include cleaning a surface of the underlayment 600 with soap and water because such cleaning affects the surface of the underlayment 600 and is not representative of the field conditions in which the roofing underlayment is used. However, the footwear 512 is cleaned prior to performing the method.

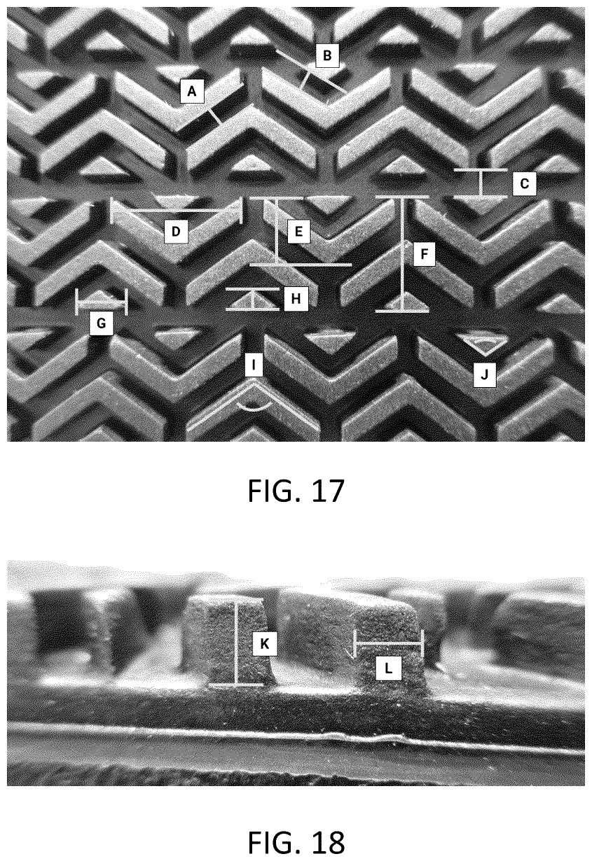

Several trials were conducted using the method described herein with reference to FIGS. 14-16 to determine the coefficient of friction (COF) for different types of roofing underlayments. A higher coefficient of friction provides for an enhanced walkability by a user over the underlayment. Information will be provided below regarding the specific variables used for a first testing method of the trials. The first testing method using these variables will be referred to throughout this application, including the claims, as “COF method 1”. For the COF method 1, the footwear 612 was a Fila Men's Vulc 13 Low Slip Resistant Shoe (right shoe, US size 11), referred to herein as “testing shoe 1,” which has a tread pattern as shown in FIGS. 17-18. From the testing methods of ASTM D412 and D2240, testing shoe 1 has a shore A hardness of 65, a tensile strength of 428 psi, an elongation at break of 203%, and a modulus of elasticity of 186 psi. From the testing method of ASTM D5992, a temperature sweep was performed on testing shoe 1 from 25° C. to 125° C. in tension with a strain of 0.02% and frequency of 1 Hz, and a frequency sweep was performed on testing shoe 1 from 3 Hz to 20 Hz at 20° C. and 0.50 dynamic strain, with testing shoe 1 being tested to have a Tan Delta of 0.1-0.2 and a Storage Modulus (G′) of 1-2 MPa. From the testing methods of ASTM D3677 (prepped by film pyrolysis) and E1131 (with ramp from 25-850° C. at 10° C./min and switching from nitrogen to air at 550° C.), testing shoe 1 was determined to have the following composition: 57% polymers (with a blend of 60% polybutadiene, 25% styrene butadiene rubber, and 15% polyisoprene), 29% inorganics/ash (with 75%-80% silica), 11% volatiles (e.g., oils process aids, plasticizers), and 3% combustibles (e.g., carbon black, calcium carbonate). Various dimensions for the tread pattern of testing shoe 1 are listed in Table 1 below with reference to FIGS. 17-18.

TABLE 1

| Dimension Reference | | |
|---|---|---|
| Character Shown in | Dimension | |
| FIGS. 17-18 | Measurement | |
| A | 2.0 | mm |
| B | 2.0 | mm |
| C | 2.5 | mm |
| D | 12.5 | mm |
| E | 6.5 | mm |
| F | 10.5 | mm |
| G | 4.5 | mm |
| H | 2.0 | mm |
| I | 70° | |
| J | 70° | |
| K | 3.5 | mm |
| L | 2.0 | mm |

The underfoot surface 602 was an OSB having dimensions of 7 in by 14 in by 0.5 in. Each roofing underlayment 600 is connected to an underfoot surface 602 in the same manner. In particular, an adhesive spray (i.e., 3M Hi-Strength 90 adhesive spray) is applied to a top surface of the underfoot surface 602, and an underside of the roofing underlayment 600 is then adhered to the top surface of the underfoot surface 602 by the adhesive spray. The roofing underlayment 600 is gently pressed on to smooth out any wrinkles and help adhere the roofing underlayment to the underfoot surface 602, and an 8.5 lb roller is used to roll out the roofing underlayment 600. The roofing underlayment 600 is then folded over the front and rear ends of the underfoot surface such that a first portion of the roofing underlayment 600 extends across a rear side of the underfoot surface 602 proximate the first end and a second portion of the roofing underlayment 600 extends across a rear side of the underfoot surface 602 proximate the second end. A staple gun is then used to secure the first and second portions of the roofing underlayment 600 to the rear side of the underfoot surface 602.

The amount of force F provided at contact point C via the footwear 612 and holding device 614 was 500 N±25 N (which is from ASTM F2913-19 for the size of the footwear 612 used during these trials). The sliding member 606 was moved at a speed such that a relative speed between the footwear 612 and the underlayment 600 was 0.3 m/s±0.03 m/s, which commenced in 0.2 seconds after the force F was provided at contact point C, and which is consistent with ASTM F2913-19. Any other variables not explicitly described are consistent with ASTM F2913-19.

COF method 1 was conducted in dry, wet, and sawdust conditions. For the wet conditions, the water was applied consistently with ASTM F2913-19. For the sawdust conditions, about 1.5 g of sawdust was applied over a 48 in² surface area. The sawdust was from sawing pine OSB with the sawdust particle diameter being generally between about 100 μm and 2000 μm with a median particle diameter (based one volume %) being between about 470 μm and about 480 μm. A 2 mm sieve was used to filter out large chunks such that less than about 1% of the sawdust had a particle diameter greater than 2000 μm, and less than about 1% of the sawdust had a particle diameter less than 100 μm. For the sawdust testing, sawdust was not reapplied or respread on the roofing underlayment for testing runs of the same sample.

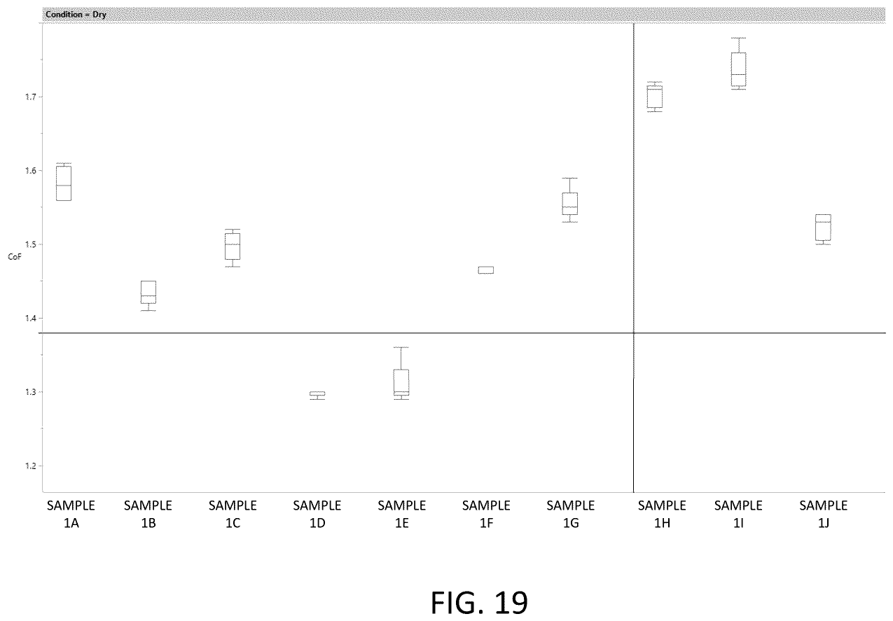

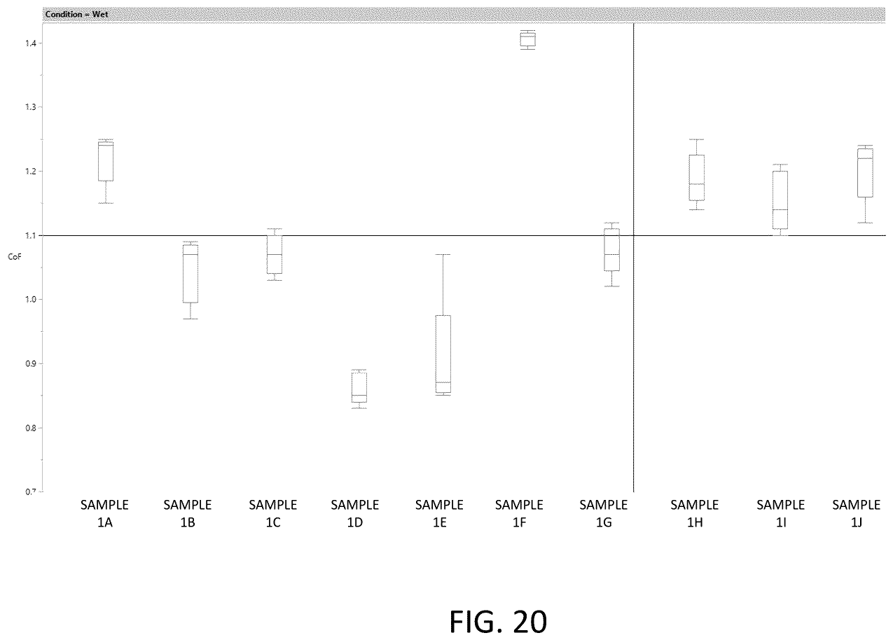

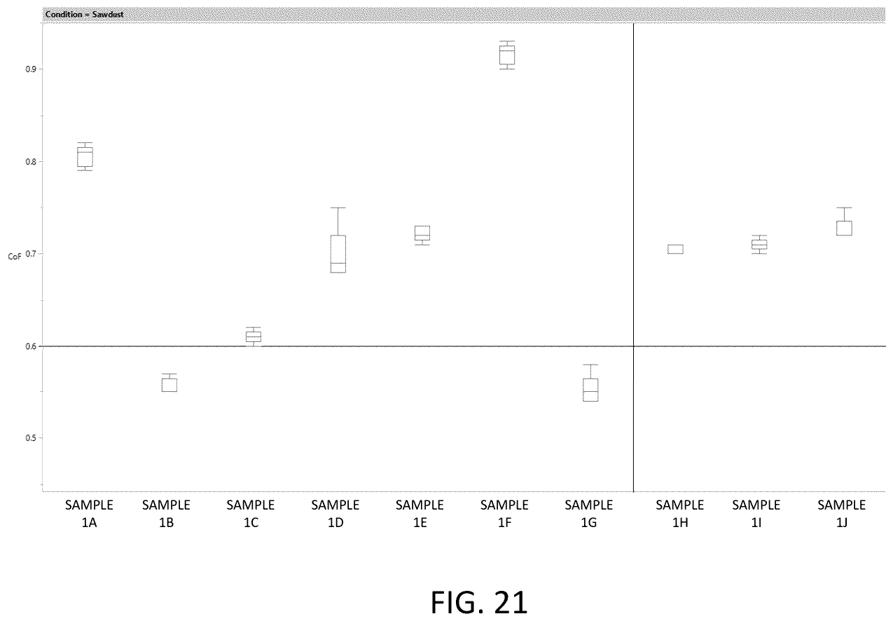

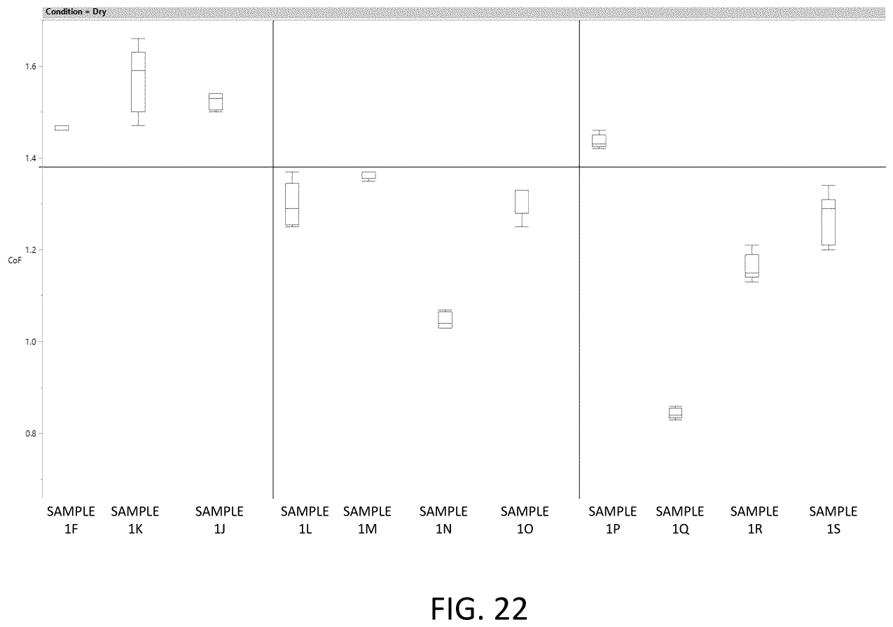

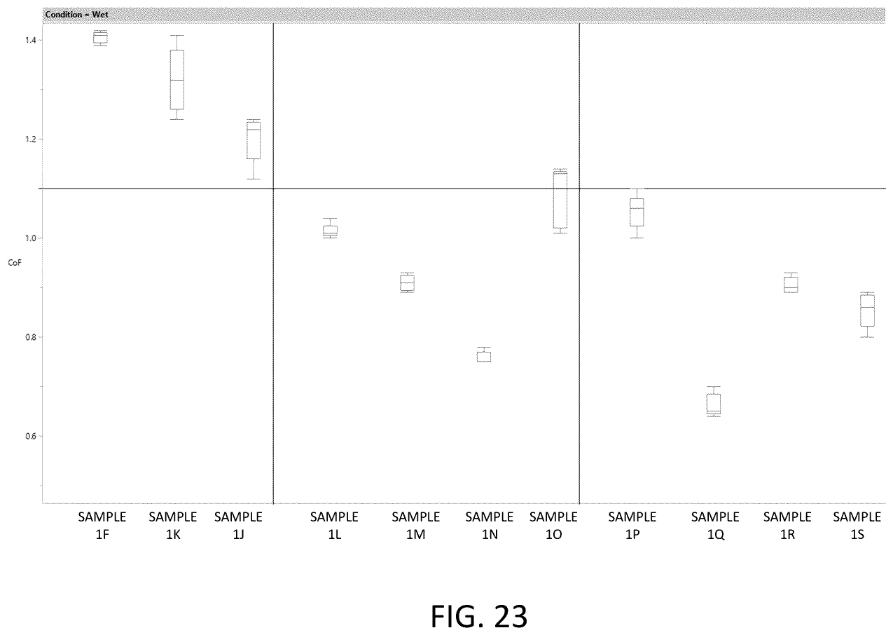

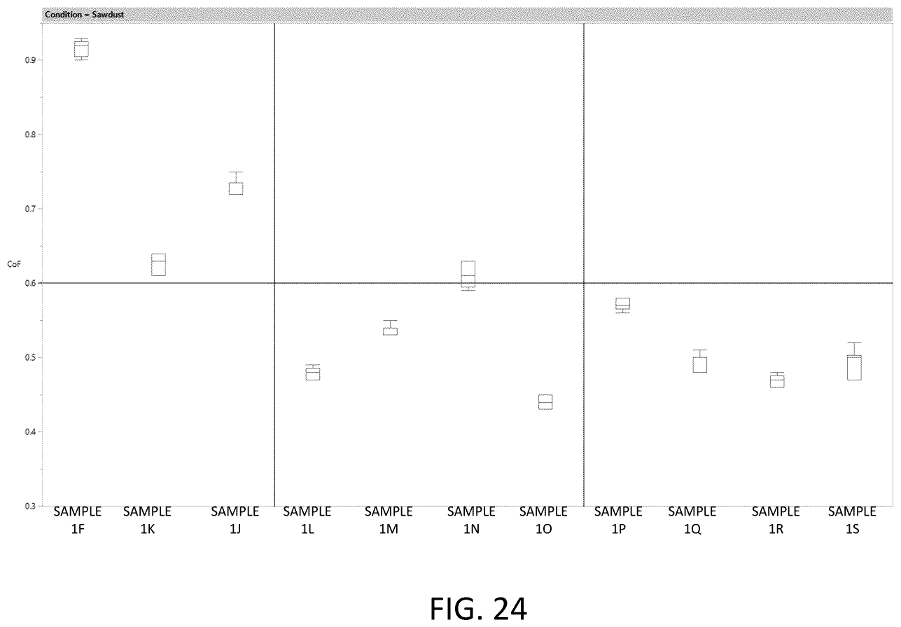

In a first trial, twenty-two (22) samples were evaluated (i.e., Samples 1A-1V shown in FIGS. 19-27) using COF method 1 to determine a coefficient of friction for each sample. The results of the first trial are shown in FIGS. 19-27. Samples 1A-1V are detailed in Table 2 below.

TABLE 2

| Sample # | Type of Underlayment |
|---|---|
| 1A | Microstructured |
| 1B | Microstructured |
| 1C | Microstructured |
| 1D | Microstructured |
| 1E | Microstructured |
| 1F | Microstructured |
| 1G | Microstructured |
| 1H | Microstructured |
| 1I | Microstructured |
| 1J | Microstructured |
| 1K | Microstructured |
| 1L | Self-Adhered |
| 1M | Self-Adhered |
| 1N | Self-Adhered |
| 1O | Self-Adhered |
| 1P | Synthetic |
| 1Q | Synthetic |
| 1R | Synthetic |
| 1S | Synthetic |
| 1T | Microstructured |
| 1U | Microstructured |
| 1V | Microstructured |

Samples 1A-1K and 1T-1V are various examples of microstructured underlayments according to the present invention (e.g., underlayments having one or more of the features described with reference to FIGS. 1-13 of the present application), and samples 1L-1S are conventional, known roofing underlayments. The microstructured underlayments can include gripping structures that are configured to contribute to enhanced walkability by a user over the underlayments. The gripping structures can take any suitable form, such as, for example, any form described in the present application for gripping structures 34.

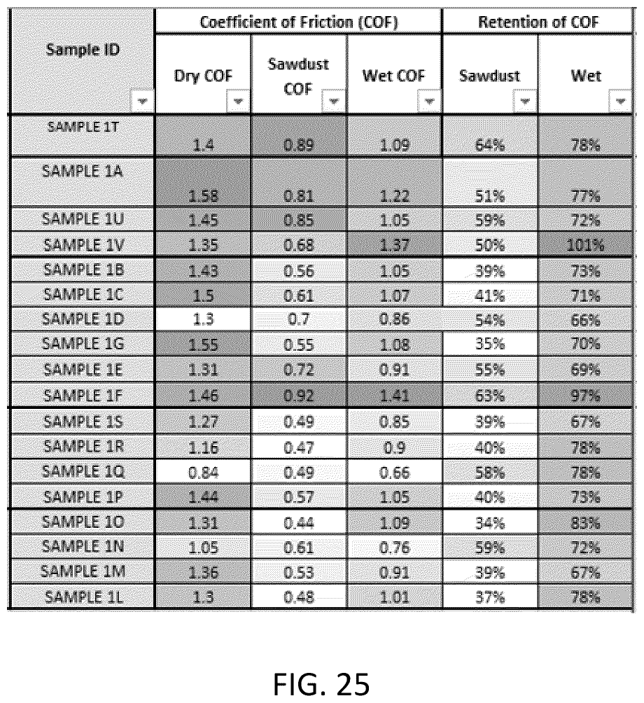

The various samples were tested using COF method 1 for comparison of example microstructured roofing underlayments of the present invention (e.g., Samples 1A-1K and 1T-1V) to roofing underlayments that are known in the roofing industry (e.g., Samples 2I-2P). The coefficient of friction was calculated for each of these samples in dry, wet, and sawdust conditions (as shown in FIGS. 19-27). The retention rate for wet conditions (i.e., coefficient of friction in wet conditions/coefficient of friction in dry conditions) and the retention rate for sawdust conditions (i.e., coefficient of friction in sawdust conditions/coefficient of friction in dry conditions) were also calculated for some of these samples (as shown in FIG. 25).

Sample 1A is a microstructured underlayment that includes gripping structures having a height of about 200 μm, a taper angle of about 7 degrees, a base diameter of about 249 μm, a pitch (center to center) of about 500 μm, a top diameter of about 200 μm, a contact area of about 13%, and an aspect ratio of about 0.8:1. Sample 1A includes a microstructured compression molded film. For dry conditions, Sample 1A was calculated to have a coefficient of friction of approximately 1.58. For wet conditions, Sample 1A was calculated to have a coefficient of friction of approximately 1.22. For sawdust conditions, Sample 1A was calculated to have a coefficient of friction of approximately 0.81. In addition, referring to FIG. 25, Sample 1A had a 68% retention rate for sawdust conditions and an 89% retention rate for wet conditions.

Sample 1B is a microstructured underlayment that includes gripping structures having a height of about 50 μm, a taper angle of about 7 degrees, a base diameter of about 212 μm, a pitch (center to center) of about 500 μm, a top diameter of about 200 μm, a contact area of about 13%, and an aspect ratio of about 0.24:1. Sample 1B includes a microstructured compression molded film. For dry conditions, Sample 1B was calculated to have a coefficient of friction of approximately 1.43. For wet conditions, Sample 1B was calculated to have a coefficient of friction of approximately 1.05. For sawdust conditions, Sample 1B was calculated to have a coefficient of friction of approximately 0.56. In addition, referring to FIG. 25, Sample 1B had a 39% retention rate for sawdust conditions and a 73% retention rate for wet conditions.

Sample 1C is a microstructured underlayment that includes gripping structures having a height of about 100 μm, a taper angle of about 7 degrees, a base diameter of about 225 μm, a pitch (center to center) of about 500 μm, a top diameter of about 200 μm, a contact area of about 13%, and an aspect ratio of about 0.44:1. Sample 1C includes a microstructured compression molded film. For dry conditions, Sample 1C was calculated to have a coefficient of friction of approximately 1.50. For wet conditions, Sample 1C was calculated to have a coefficient of friction of approximately 1.07. For sawdust conditions, Sample 1C was calculated to have a coefficient of friction of approximately 0.61. In addition, referring to FIG. 25, Sample 1C had a 41% retention rate for sawdust conditions and a 71% retention rate for wet conditions.

Sample 1D is a microstructured underlayment that includes gripping structures having a height of about 200 μm, a taper angle of about 10 degrees, a base diameter of about 150 μm, a pitch (center to center) of about 500 μm, a top diameter of about 125 μm, a contact area of about 5%, and an aspect ratio of about 0.75:1. Sample 1D includes a microstructured compression molded film. For dry conditions, Sample 1D was calculated to have a coefficient of friction of approximately 1.30. For wet conditions, Sample 1D was calculated to have a coefficient of friction of approximately 0.86. For sawdust conditions, Sample 1D was calculated to have a coefficient of friction of approximately 0.70. In addition, referring to FIG. 25, Sample 1D had a 54% retention rate for sawdust conditions and a 66% retention rate for wet conditions.

Sample 1E is a microstructured underlayment that includes gripping structures having a height of about 200 μm, a taper angle of about 7 degrees, a base diameter of about 249 μm, a pitch (center to center) of about 1000 μm, a top diameter of about 200 μm, a contact area of about 3%, and an aspect ratio of about 0.80:1. Sample 1E includes a microstructured compression molded film. For dry conditions, Sample 1E was calculated to have a coefficient of friction of approximately 1.31. For wet conditions, Sample 1E was calculated to have a coefficient of friction of approximately 0.91. For sawdust conditions, Sample 1E was calculated to have a coefficient of friction of approximately 0.72. In addition, referring to FIG. 25, Sample 1E had a 55% retention rate for sawdust conditions and a 69% retention rate for wet conditions.

Sample 1F is a microstructured underlayment that includes gripping structures having a height of about 200 μm, a taper angle of about 7 degrees, a base diameter of about 449 μm, a pitch (center to center) of about 1000 μm, a top diameter of about 400 μm, a contact area of about 13%, and an aspect ratio of about 0.45:1. Sample 1F includes a microstructured compression molded film. For dry conditions, Sample 1F was calculated to have a coefficient of friction of approximately 1.46. For wet conditions, Sample 1F was calculated to have a coefficient of friction of approximately 1.41. For sawdust conditions, Sample 1F was calculated to have a coefficient of friction of approximately 0.92. In addition, referring to FIG. 25, Sample 1F had a 63% retention rate for sawdust conditions and a 97% retention rate for wet conditions.

Sample 1G is a microstructured underlayment that includes gripping structures having a height of about 200 μm, a taper angle of about 7 degrees, a base diameter of about 249 μm, a pitch (center to center) of about 300 μm, a top diameter of about 200 μm, a contact area of about 35%, and an aspect ratio of about 0.80:1. Sample 1G includes a microstructured compression molded film. For dry conditions, Sample 1G was calculated to have a coefficient of friction of approximately 1.55. For wet conditions, Sample 1G was calculated to have a coefficient of friction of approximately 1.08. For sawdust conditions, Sample 1G was calculated to have a coefficient of friction of approximately 0.55. In addition, referring to FIG. 25, Sample 1G had a 35% retention rate for sawdust conditions and a 70% retention rate for wet conditions.

Sample 1H is a microstructured underlayment that includes gripping structures having a height of about 157 μm, a taper angle of about 5-15 degrees, a base diameter of about 185 μm, a pitch (center to center) of about 500 μm, a top diameter of about 100 μm, a contact area of about 3%, and an aspect ratio of about 0.85:1. Sample 1H is glass reinforced self-adhered underlayment with a microstructured cast film. More specifically, Sample 1H has a top layer having a top layer having a microstructured cast film, a second layer having a polymer modified asphalt, a third layer having a glass nonwoven material, a fourth layer having a polymer modified asphalt, and a fifth layer having a release liner. For dry conditions, Sample 1H was calculated to have a coefficient of friction of approximately 1.71. For wet conditions, Sample 1H was calculated to have a coefficient of friction of approximately 1.20. For sawdust conditions, Sample 1H was calculated to have a coefficient of friction of approximately 0.71.

Sample 1I is a microstructured underlayment that includes gripping structures having a height of about 157 μm, a taper angle of about 5-15 degrees, a base diameter of about 185 μm, a pitch (center to center) of about 500 μm, a top diameter of about 100 μm, a contact area of about 3%, and an aspect ratio of about 0.85:1. Sample 1I is polypropylene woven mesh scrim reinforced self-adhered underlayment with a microstructured cast film. More specifically, Sample 1I has a top layer having a top layer having a microstructured cast film, a second layer having a polypropylene coating, a third layer having a polypropylene woven mesh scrim, a fourth layer having a polypropylene coating, a fifth layer having a polymer modified asphalt, and a sixth layer having a release liner. For dry conditions, Sample 1I was calculated to have a coefficient of friction of approximately 1.73. For wet conditions, Sample 1I was calculated to have a coefficient of friction of approximately 1.16. For sawdust conditions, Sample 1I was calculated to have a coefficient of friction of approximately 0.71.

Sample 1J is a microstructured underlayment that includes gripping structures having a height of about 157 μm, a taper angle of about 5-15 degrees, a base diameter of about 185 μm, a pitch (center to center) of about 500 μm, a top diameter of about 100 μm, a contact area of about 3%, and an aspect ratio of about 0.85:1. Sample 1J is a polypropylene woven mesh scrim reinforced mechanically fastened underlayment that includes a microstructured cast film. More specifically, Sample 1J has a top layer having a top layer having a microstructured cast film, a second layer having a polypropylene coating, a third layer having a polypropylene woven mesh scrim, and a fourth layer having a polypropylene coating. For dry conditions, Sample 1J was calculated to have a coefficient of friction of approximately 1.52. For wet conditions, Sample 1J was calculated to have a coefficient of friction of approximately 1.21. For sawdust conditions, Sample 1J was calculated to have a coefficient of friction of approximately 0.74.

Sample 1K is a microstructured underlayment that includes gripping structures having a height of about 200 μm, no taper angle, a base diameter of about 200 μm, a pitch (center to center) of about 500 μm, a top diameter of about 130 μm, a contact area of about 5%, and an aspect ratio of about 1:1. Sample 1K is a synthetic mechanically fastened underlayment having a polypropylene woven mesh scrim with a microstructured cast film. More specifically, Sample 1K has a top layer having a top layer having a microstructured cast film, a second layer having a polypropylene coating, a third layer having a polypropylene woven mesh scrim, and a fourth layer having a polypropylene coating. For dry conditions, Sample 1K was calculated to have a coefficient of friction of approximately 1.59. For wet conditions, Sample 1K was calculated to have a coefficient of friction of approximately 1.32. For sawdust conditions, Sample 1K was calculated to have a coefficient of friction of approximately 0.65.

Sample 1T is a microstructured underlayment that includes gripping structures having a height of about 200 μm, no taper angle, a base diameter of about 200 μm, a pitch (center to center) of about 500 μm, a top diameter of about 130 μm, a contact area of about 5%, and an aspect ratio of about 1:1. Sample 1T includes a microstructured thick cast film that is laminated to a polypropylene woven mesh scrim. For dry conditions, Sample 1T was calculated to have a coefficient of friction of approximately 1.40. For wet conditions, Sample 1T was calculated to have a coefficient of friction of approximately 1.09. For sawdust conditions, Sample 1T was calculated to have a coefficient of friction of approximately 0.89. In addition, referring to FIG. 25, Sample 1T had a 64% retention rate for sawdust conditions and a 78% retention rate for wet conditions.

Sample 1U is a microstructured underlayment that includes gripping structures having a height of about 200 μm, a taper angle of about 7 degrees, a base diameter of about 249 μm, a pitch (center to center) of about 500 μm, a top diameter of about 200 μm, a contact area of about 13%, and an aspect ratio of about 0.80:1. Sample 1U includes a microstructured compression molded film. For dry conditions, Sample 1U was calculated to have a coefficient of friction of approximately 1.45. For wet conditions, Sample 1U was calculated to have a coefficient of friction of approximately 1.05. For sawdust conditions, Sample 1U was calculated to have a coefficient of friction of approximately 0.85. In addition, referring to FIG. 25, Sample 1U had a 59% retention rate for sawdust conditions and a 72% retention rate for wet conditions.

Sample 1V is a microstructured underlayment that includes gripping structures having a height of about 157 μm, a taper angle of about 5-15 degrees, a base diameter of about 185 μm, a pitch (center to center) of about 500 μm, a top diameter of about 100 μm, a contact area of about 3%, and an aspect ratio of about 0.85:1. Sample 1V includes a microstructured compression molded film. For dry conditions, Sample 1V was calculated to have a coefficient of friction of approximately 1.35. For wet conditions, Sample 1V was calculated to have a coefficient of friction of approximately 1.37. For sawdust conditions, Sample 1V was calculated to have a coefficient of friction of approximately 0.68. In addition, referring to FIG. 25, Sample 1V had a 50% retention rate for sawdust conditions and a 101% retention rate for wet conditions.

Samples 1L-1S are conventional, known roofing underlayments. These samples were tested for comparison to the microstructured samples described above using COF method 1. Sample 1L is a self-adhered underlayment and, more specifically, an otherwise non-reinforced self-adhered underlayment having a printed traction surface on a film material. Sample 1L has a top layer having a printed traction surface on a film, a second layer having a polymer modified asphalt, and a third layer having a release paper. For dry conditions, Sample 1L was calculated to have a coefficient of friction of approximately 1.30. For wet conditions, Sample 1L was calculated to have a coefficient of friction of approximately 1.01. For sawdust conditions, Sample 1L was calculated to have a coefficient of friction of approximately 0.48. In addition, referring to FIG. 25, Sample 1L had a 37% retention rate for sawdust conditions and a 78% retention rate for wet conditions.

Sample 1M is self-adhered underlayment and, more particularly, a self-adhered underlayment having a mesh surfaced coated woven material. Sample 1M has a top layer having a mesh material, a second layer having a polypropylene coating, a third layer having a polypropylene woven mesh scrim, a fourth layer having a polypropylene coating, a fifth layer having a polymer modified asphalt, and a sixth layer having a release liner. For dry conditions, Sample 1M was calculated to have a coefficient of friction of approximately 1.36. For wet conditions, Sample 1M was calculated to have a coefficient of friction of approximately 0.91. For sawdust conditions, Sample 1M was calculated to have a coefficient of friction of approximately 0.53. In addition, referring to FIG. 25, Sample 1M had a 39% retention rate for sawdust conditions and a 67% retention rate for wet conditions.

Sample 1N is self-adhered underlayment and, more particularly, an otherwise non-reinforced self-adhered underlayment having a thick polyester non-woven material. Sample 1N has a top layer having a thick polyester non-woven material, a second layer having a polymer modified asphalt, and a third layer having a release liner. For dry conditions, Sample 1N was calculated to have a coefficient of friction of approximately 1.05. For wet conditions, Sample 1N was calculated to have a coefficient of friction of approximately 0.76. For sawdust conditions, Sample 1N was calculated to have a coefficient of friction of approximately 0.61. In addition, referring to FIG. 25, Sample 1N had a 59% retention rate for sawdust conditions and a 72% retention rate for wet conditions.

Sample 10 is a self-adhered underlayment and, more particularly, an otherwise non-reinforced self-adhered underlayment having a printed traction surface on a film material. Sample 10 has a top layer having a printed traction surface on film material, a second layer having a polymer modified asphalt, and a third layer having a release paper. For dry conditions, Sample 10 was calculated to have a coefficient of friction of approximately 1.31. For wet conditions, Sample 10 was calculated to have a coefficient of friction of approximately 1.09. For sawdust conditions, Sample 10 was calculated to have a coefficient of friction of approximately 0.44. In addition, referring to FIG. 25, Sample 10 had a 34% retention rate for sawdust conditions and a 83% retention rate for wet conditions.

Sample 1P is a synthetic underlayment and, more particularly, a high loft embossed nonwoven surfaced coated woven mechanically fastened underlayment. Sample 1P has a top layer having a high loft embossed nonwoven material, a second layer having a polypropylene coating, a third layer having a polypropylene woven mesh scrim, and a fourth layer having a polypropylene coating. For dry conditions, Sample 1P was calculated to have a coefficient of friction of approximately 1.44. For wet conditions, Sample 1P was calculated to have a coefficient of friction of approximately 1.05. For sawdust conditions, Sample 1P was calculated to have a coefficient of friction of approximately 0.57. In addition, referring to FIG. 25, Sample 1P had a 40% retention rate for sawdust conditions and a 73% retention rate for wet conditions.

Sample 1Q is a synthetic underlayment and, more particularly, a nonwoven surfaced with dots deposited on top for traction on a coated woven mechanically fastened underlayment. Sample 1Q has a top layer having dots deposited on a nonwoven material, a second layer having a polypropylene coating, a third layer having a polypropylene woven mesh scrim, and a fourth layer having a polypropylene coating. For dry conditions, Sample 1Q was calculated to have a coefficient of friction of approximately 0.84. For wet conditions, Sample 1Q was calculated to have a coefficient of friction of approximately 0.66. For sawdust conditions, Sample 1Q was calculated to have a coefficient of friction of approximately 0.49. In addition, referring to FIG. 25, Sample 1Q had a 58% retention rate for sawdust conditions and a 78% retention rate for wet conditions.

Sample 1R is a synthetic underlayment and, more particularly, a nonwoven surfaced coated woven mechanically fastened underlayment. Sample 1R has a top layer having a nonwoven material, a second layer having a polypropylene coating, a third layer having a polypropylene woven mesh scrim, and a fourth layer having a polypropylene coating. For dry conditions, Sample 1R was calculated to have a coefficient of friction of approximately 1.16. For wet conditions, Sample 1R was calculated to have a coefficient of friction of approximately 0.90. For sawdust conditions, Sample 1R was calculated to have a coefficient of friction of approximately 0.47. In addition, referring to FIG. 25, Sample 1R had a 40% retention rate for sawdust conditions and a 78% retention rate for wet conditions.

Sample 1S is a synthetic underlayment and, more particularly, a mesh surfaced coated woven mechanically fastened underlayment. Sample 1S has a top layer having a mesh material, a second layer having a polypropylene coating, a third layer having a polypropylene woven mesh scrim, and a fourth layer having a polypropylene coating. For dry conditions, Sample 1S was calculated to have a coefficient of friction of approximately 1.27. For wet conditions, Sample 1S was calculated to have a coefficient of friction of approximately 0.85. For sawdust conditions, Sample 1S was calculated to have a coefficient of friction of approximately 0.49. In addition, referring to FIG. 25, Sample 1S had a 39% retention rate for sawdust conditions and a 67% retention rate for wet conditions.

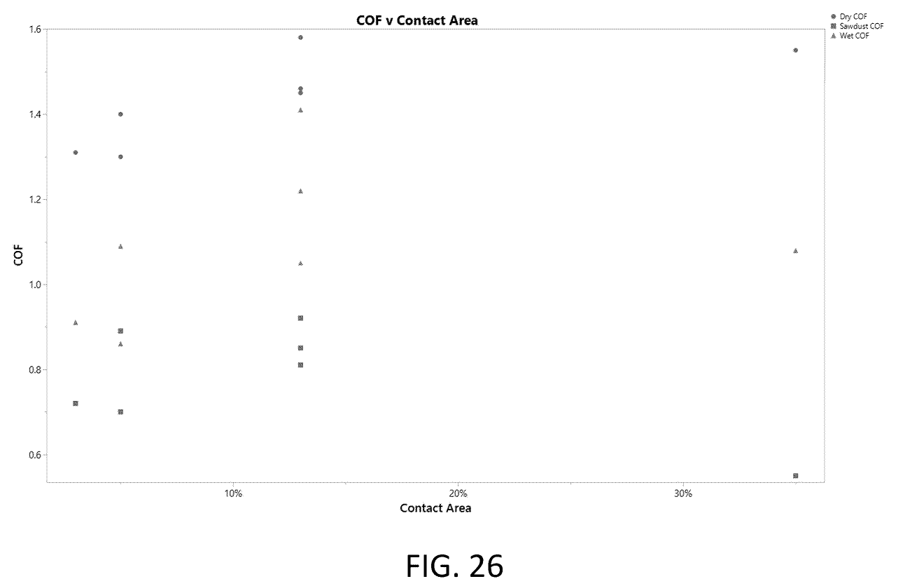

FIG. 26 illustrates a comparison of various samples of the microstructured underlayments of the present invention to show the calculated coefficient of friction results of these samples in view of the contact area of each sample. FIG. 26 shows this comparison for each of dry, wet, and sawdust conditions, where each of the compared samples have gripping structures with a height of about 200 μm. In particular, FIG. 26 compares Sample 1E (which has a contact area of about 3%), Sample 1D (which has a contact area of about 5%), Sample 1T (which has a contact area of about 5%), Sample 1A (which has a contact area of about 13%), Sample 1F (which has a contact area of about 13%), Sample 1U (which has a contact area of about 13%), and Sample 1G (which has a contact area of about 35%).

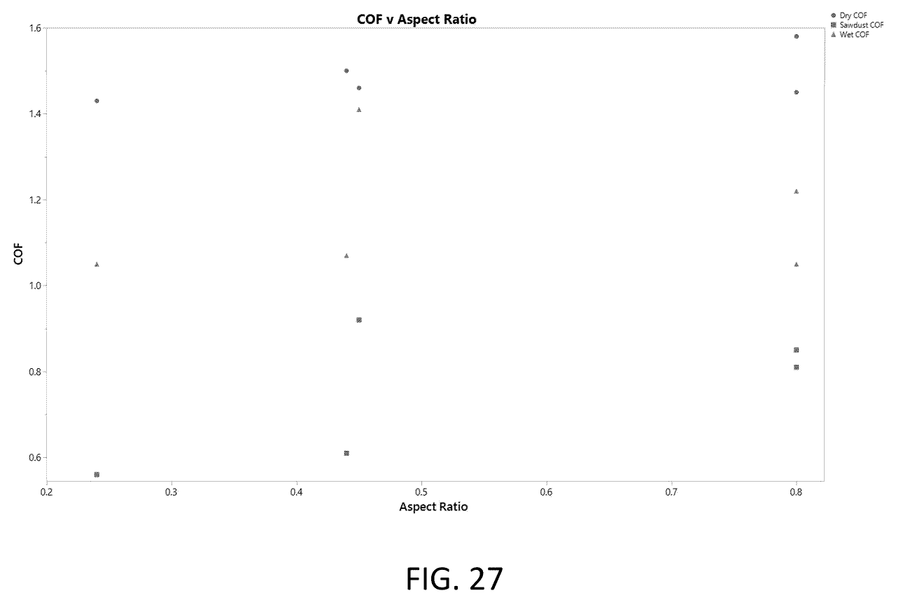

FIG. 27 illustrates a comparison of various samples of the microstructured underlayments of the present invention to show the calculated coefficient of friction results of these samples in view of the aspect ratio of each sample. FIG. 27 shows this comparison for each of dry, wet, and sawdust conditions, where each of the compared samples have gripping structures with a contact area of about 13%. In particular, FIG. 27 compares Sample 1B (which has an aspect ratio of about 0.24:1), Sample 1C (which has an aspect ratio of about 0.44:1), Sample 1F (which has an aspect ratio of about 0.45:1), Sample 1A (which has an aspect ratio of about 0.80:1), and Sample 1U (which has an aspect ratio of about 0.80:1).

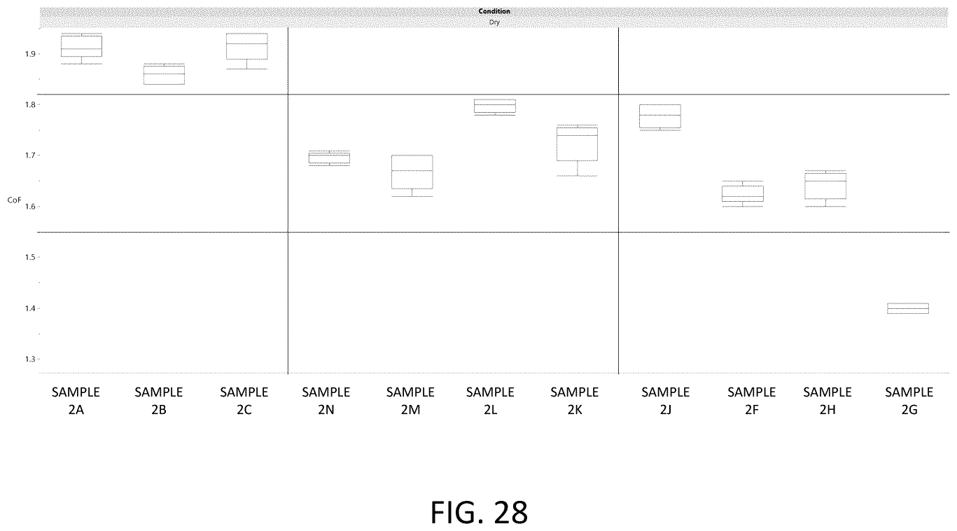

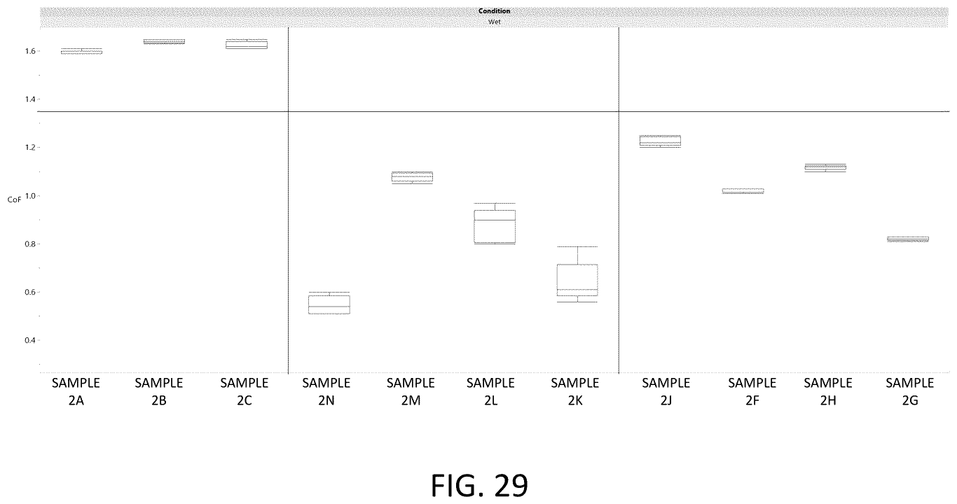

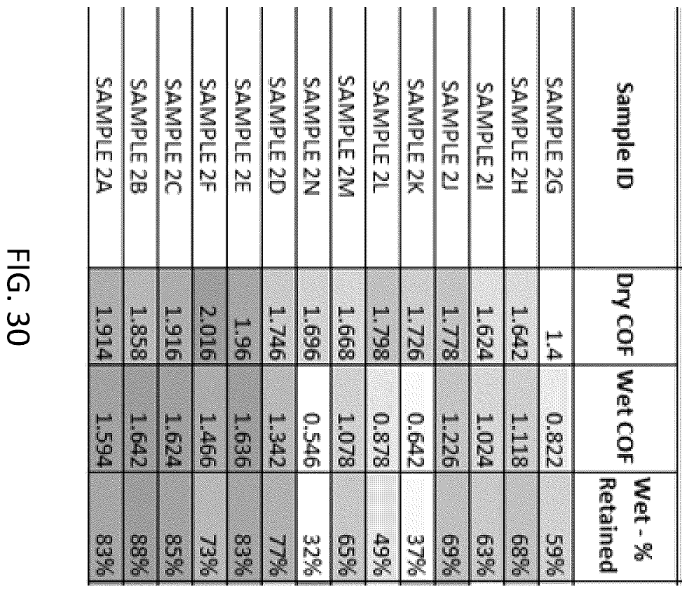

In a second trial, fourteen (14) samples were evaluated (i.e., Samples 2A-2N shown in FIGS. 28-30) using a second testing method, which will be referred to throughout this application (including the claims) as “COF method 2,” to determine a coefficient of friction (COF) for each sample. COF method 2 is identical to COF method 1 except for the footwear that was used during the method. For COF method 2, the footwear 612 (FIGS. 14-16) was a Courgar Paws Peak Performance Roofing Boot shoe (right shoe, size 11), referred to herein as “testing shoe 2”. Testing shoe 2 was tested with Cougar Paws Peak Performance Boot Replacement Pads attached to the sole of the shoe. Testing shoe 2 was determined to have a shore A hardness of 13.2 from testing method ASTM D2240. From the testing method of ASTM D1056, testing shoe 2 was determined to have a density of 28.3 lbs/ft³ and a compression deflection of 11.1-11.4 psi when compressed at 1.25 in/min to 25% released for 8 seconds and compressed 25%. From the testing method of ASTM D5992, a temperature sweep was performed on testing shoe 2 from 25° C. to 100° C. in tension with a strain of 0.02% and frequency of 1 Hz, and a strain sweep was formed on testing shoe 2 from 0.0005 to 0.5 dynamic strain at 30 C and 1 Hz, with testing shoe 2 being tested to have a Tan Delta of 0.04-0.20 and a Storage Modulus of 0.1 to 0.3 MPa and a Compression Storage Modulus (G′) of 0.25-0.4 MPa. From the testing methods of ASTM D3677 (prepped by pyrolysis) and E1131 (with ramp from 25° C. to 850° C. at 10° C./min and switching from nitrogen to air at 550° C.), testing shoe 2 was determined to have the following composition: 45% polymers (polyisoprene), 30% inorganics/ash, 15% volatiles (e.g., oils process aids, plasticizers), and 10% combustibles (e.g., carbon black, calcium carbonate). The results of the second trial are shown in FIGS. 28-30. Samples 2A-2N are detailed in Table 3 below.

TABLE 3

| Sample # | Type of Underlayment |
|---|---|
| 2A | Microstructured |
| 2B | Microstructured |
| 2C | Microstructured |
| 2D | Microstructured |
| 2E | Microstructured |
| 2F | Microstructured |
| 2G | Synthetic |
| 2H | Synthetic |
| 2I | Synthetic |
| 2J | Synthetic |
| 2K | Self-Adhered |
| 2L | Self-Adhered |
| 2M | Self-Adhered |
| 2N | Self-Adhered |

Samples 2A-2F are various examples of microstructured underlayments according to the present invention (e.g., underlayments having one or more of the features described with reference to FIGS. 1-13 of the present application), and samples 2G-2N are conventional, known roofing underlayments. The microstructured underlayments can include gripping structures that are configured to contribute to enhanced walkability by a user over the underlayments. The gripping structures can take any suitable form, such as, for example, any form described in the present application for gripping structures 34.

The various samples were tested using COF method 2 for comparison of example microstructured roofing underlayments of the present invention (e.g., Samples 2A-2F) to roofing underlayments that are known in the roofing industry (e.g., Samples 2G-2N). The coefficient of friction was calculated for each of these samples in dry and wet conditions. The retention rate for wet conditions was also calculated for some of these samples (as shown in FIG. 30).

Sample 2A is a microstructured underlayment that includes gripping structures having a height of about 157 μm, a taper angle of about 5-15 degrees, a base diameter of about 185 μm, a pitch (center to center) of about 500 μm, a top diameter of about 100 μm, a contact area of about 3%, and an aspect ratio of about 0.85:1. Sample 2A is glass reinforced self-adhered underlayment with a microstructured cast film. More specifically, Sample 2A has a top layer having a microstructured cast film, a second layer having a polymer modified asphalt, a third layer having a glass nonwoven material, a fourth layer having a polymer modified asphalt, and a fifth layer having a release liner. Sample 2A is identical to Sample 1H described in the present application. For dry conditions, Sample 2A was calculated to have a coefficient of friction of approximately 1.914. For wet conditions, Sample 2A was calculated to have a coefficient of friction of approximately 1.594. In addition, referring to FIG. 30, Sample 2A had an 83% retention rate for wet conditions.

Sample 2B is a microstructured underlayment that includes gripping structures having a height of about 157 μm, a taper angle of about 5-15 degrees, a base diameter of about 185 μm, a pitch (center to center) of about 500 μm, a top diameter of about 100 μm, a contact area of about 3%, and an aspect ratio of about 0.85:1. Sample 2B is polypropylene woven mesh scrim reinforced self-adhered underlayment with a microstructured cast film. More specifically, Sample 2B has a top layer having a top layer having a microstructured cast film, a second layer having a polypropylene coating, a third layer having a polypropylene woven mesh scrim, a fourth layer having a polypropylene coating, a fifth layer having a polymer modified asphalt, and a sixth layer having a release liner. Sample 2B is identical to Sample 1I described in the present application. For dry conditions, Sample 2B was calculated to have a coefficient of friction of approximately 1.858. For wet conditions, Sample 2B was calculated to have a coefficient of friction of approximately 1.642. In addition, referring to FIG. 30, Sample 2B had an 88% retention rate for wet conditions.

Sample 2C is a microstructured underlayment that includes gripping structures having a height of about 157 μm, a taper angle of about 5-15 degrees, a base diameter of about 185 μm, a pitch (center to center) of about 500 μm, a top diameter of about 100 μm, a contact area of about 3%, and an aspect ratio of about 0.85:1. Sample 2C is a polypropylene woven mesh scrim reinforced mechanically fastened underlayment that includes a microstructured cast film More specifically, Sample 2C has a top layer having a top layer having a microstructured cast film, a second layer having a polypropylene coating, a third layer having a polypropylene woven mesh scrim, and a fourth layer having a polypropylene coating. Sample 2C is identical to Sample 1J described in the present application. For dry conditions, Sample 2C was calculated to have a coefficient of friction of approximately 1.916. For wet conditions, Sample 2C was calculated to have a coefficient of friction of approximately 1.624. In addition, referring to FIG. 30, Sample 2C had an 85% retention rate for wet conditions.

Sample 2D is a microstructured underlayment that includes gripping structures having a height of about 200 μm, no taper angle, a base diameter of about 200 μm, a pitch (center to center) of about 500 μm, a top diameter of about 130 μm, a contact area of about 5%, and an aspect ratio of about 1:1. Sample 2D is a synthetic mechanically fastened underlayment having a polypropylene woven mesh scrim with a microstructured cast film. More specifically, Sample 2D has a top layer having a top layer having a microstructured cast film, a second layer having a polypropylene coating, a third layer having a polypropylene woven mesh scrim, and a fourth layer having a polypropylene coating. Sample 2D is identical to Sample 1K described in the present application. For dry conditions, Sample 2D was calculated to have a coefficient of friction of approximately 1.746. For wet conditions, Sample 2D was calculated to have a coefficient of friction of approximately 1.342. In addition, referring to FIG. 30, Sample 2D had a 77% retention rate for wet conditions.

Sample 2E is a microstructured underlayment that includes gripping structures having a height of about 200 μm, a taper angle of about 7 degrees, a base diameter of about 249 μm, a pitch (center to center) of about 500 μm, a top diameter of about 200 μm, a contact area of about 13%, and an aspect ratio of about 0.80:1. Sample 2E includes a microstructured compression molded film having a thickness of 280 μm. For dry conditions, Sample 2E was calculated to have a coefficient of friction of approximately 1.96. For wet conditions, Sample 2E was calculated to have a coefficient of friction of approximately 1.636. In addition, referring to FIG. 30, Sample 2E had an 83% retention rate for wet conditions.

Sample 2F is a microstructured underlayment that includes gripping structures having a height of about 157 μm, a taper angle of about 5-15 degrees, a base diameter of about 185 μm, a pitch (center to center) of about 500 μm, a top diameter of about 100 μm, a contact area of about 3%, and an aspect ratio of about 0.85:1. Sample 2F includes only a microstructured cast film. For dry conditions, Sample 2F was calculated to have a coefficient of friction of approximately 2.016. For wet conditions, Sample 2F was calculated to have a coefficient of friction of approximately 1.466. In addition, referring to FIG. 30, Sample 2F had a 73% retention rate for wet conditions.

Samples 2G-2N are conventional, known roofing underlayments. These samples were tested for comparison to the microstructured samples described above using COF method 2. Sample 2G is a synthetic underlayment and, more particularly, a mesh surfaced coated woven mechanically fastened underlayment. Sample 2G has a top layer having a mesh material, a second layer having a polypropylene coating, a third layer having a polypropylene woven mesh scrim, and a fourth layer having a polypropylene coating. Sample 2G is identical to Sample 1S described in the present application. For dry conditions, Sample 2G was calculated to have a coefficient of friction of approximately 1.4. For wet conditions, Sample 2G was calculated to have a coefficient of friction of approximately 0.822. In addition, referring to FIG. 30, Sample 2G had a 59% retention rate for wet conditions.

Sample 2H is a synthetic underlayment and, more particularly, a nonwoven surfaced coated woven mechanically fastened underlayment. Sample 2H has a top layer having a nonwoven material, a second layer having a polypropylene coating, a third layer having a polypropylene woven mesh scrim, and a fourth layer having a polypropylene coating. Sample 2H is identical to Sample 1R described in the present application. For dry conditions, Sample 2H was calculated to have a coefficient of friction of approximately 1.642. For wet conditions, Sample 2H was calculated to have a coefficient of friction of approximately 1.118. In addition, referring to FIG. 30, Sample 2H had a 68% retention rate for wet conditions.

Sample 2I is a synthetic underlayment and, more particularly, a nonwoven surfaced with dots deposited on top for traction on a coated woven mechanically fastened underlayment. Sample 2I has a top layer having dots deposited on a nonwoven material, a second layer having a polypropylene coating, a third layer having a polypropylene woven mesh scrim, and a fourth layer having a polypropylene coating. Sample 2I is identical to Sample 1Q described in the present application. For dry conditions, Sample 2I was calculated to have a coefficient of friction of approximately 1.624. For wet conditions, Sample 2I was calculated to have a coefficient of friction of approximately 1.024. In addition, referring to FIG. 30, Sample 2I had a 63% retention rate for wet conditions.

Sample 2J is a synthetic underlayment and, more particularly, a high loft embossed nonwoven surfaced coated woven mechanically fastened underlayment. Sample 2J has a top layer having a high loft embossed nonwoven material, a second layer having a polypropylene coating, a third layer having a polypropylene woven mesh scrim, and a fourth layer having a polypropylene coating. Sample 2J is identical to Sample 1P described in the present application. For dry conditions, Sample 2J was calculated to have a coefficient of friction of approximately 1.778. For wet conditions, Sample 2J was calculated to have a coefficient of friction of approximately 1.226. In addition, referring to FIG. 30, Sample 2J had a 69% retention rate for wet conditions.

Sample 2K is a self-adhered underlayment and, more particularly, an otherwise non-reinforced self-adhered underlayment having a printed traction surface on a film material. Sample 2K has a top layer having a printed traction surface on film material, a second layer having a polymer modified asphalt, and a third layer having a release paper. Sample 2K is identical to Sample 10 described in the present application. For dry conditions, Sample 2K was calculated to have a coefficient of friction of approximately 1.726. For wet conditions, Sample 2K was calculated to have a coefficient of friction of approximately 0.642. In addition, referring to FIG. 30, Sample 2K had a 37% retention rate for wet conditions.

Sample 2L is self-adhered underlayment and, more particularly, an otherwise non-reinforced self-adhered underlayment having a thick polyester non-woven material. Sample 2L has a top layer having a thick polyester non-woven material, a second layer having a polymer modified asphalt, and a third layer having a release liner. Sample 2L is identical to Sample 1N described in the present application. For dry conditions, Sample 2L was calculated to have a coefficient of friction of approximately 1.798. For wet conditions, Sample 2L was calculated to have a coefficient of friction of approximately 0.878. In addition, referring to FIG. 30, Sample 2L had a 49% retention rate for wet conditions.

Sample 2M is self-adhered underlayment and, more particularly, a self-adhered underlayment having a mesh surfaced coated woven material. Sample 2M has a top layer having a mesh material, a second layer having a polypropylene coating, a third layer having a polypropylene woven mesh scrim, a fourth layer having a polypropylene coating, a fifth layer having a polymer modified asphalt, and a sixth layer having a release liner. Sample 2M is identical to Sample 1M described in the present application. For dry conditions, Sample 2M was calculated to have a coefficient of friction of approximately 1.668. For wet conditions, Sample 2M was calculated to have a coefficient of friction of approximately 1.078. In addition, referring to FIG. 30, Sample 2M had a 65% retention rate for wet conditions.

Sample 2N is a self-adhered underlayment and, more specifically, an otherwise non-reinforced self-adhered underlayment having a printed traction surface on a film material. Sample 2N has a top layer having a printed traction surface on a film, a second layer having a polymer modified asphalt, and a third layer having a release paper. Sample 2N is identical to Sample 1L described in the present application. For dry conditions, Sample 2N was calculated to have a coefficient of friction of approximately 1.696. For wet conditions, Sample 2N was calculated to have a coefficient of friction of approximately 0.546. In addition, referring to FIG. 30, Sample 2N had a 32% retention rate for wet conditions.

The roofing underlayments 100, 100a, 200, 300, 300a, 400, 400a, 500, 500a of the present disclosure are designed such that the roofing underlayments meet roofing application needs in addition to having a desired coefficient of friction. In certain aspects, a thickness of the roofing underlayments can be configured such that the roofing underlayments can be cut and flexible to conform in valleys and tight corners of a roof. For example, the film 30 of the roofing underlayments have a thickness of 50 μm to 400 μm, including a thickness of 100 μm to 350 μm, a thickness of 100 μm to 300 μm, a thickness of 150 μm to 300 μm, and also a thickness of 200 μm to 300 μm.

In certain aspects, the roofing underlayments 100, 100a, 200, 300, 300a, 400, 400a, 500, 500a of the present disclosure may include a reinforcement (e.g., a polypropylene woven mesh scrim, a glass nonwoven, or any other reinforcement described in the present application) to enable tear resistance to prevent the roofing underlayments from tearing during installation. For self-adhered underlayments of the present disclosure, the roofing underlayments may have, for example, a tensile strength of greater than or equal to 25 lbf (using the testing methods of ASTM D1970-21 (ASTM D5147)) and a notched tear strength of greater than or equal to 20 lbf (using the testing methods of ASTM D1970-21 (ASTM D4073)). For synthetic underlayments of the present disclosure, the roofing underlayments may have, for example, a tensile strength of greater than or equal to 20 lbf (using the testing methods of ASTM D5035) and a trapezoidal tear strength of greater than or equal to 15 lbf (using the testing methods of ASTM D4533 (using “typical” rectangular die”)).

In certain aspects, the roofing underlayments 100, 100a, 200, 300, 300a, 400, 400a, 500, 500a of the present disclosure may be sealed at end lap seams without addition of mastic or primer so the ASTM D1970 lap seal integrity test is modified to test the end lap seams (not the side lap seams). The roofing underlayments may be configured with a minimized seam width between microstructured tiles, which allows for the roofing underlayments to pass the ASTM D1970 lap seal integrity test.

In certain aspects, the roofing underlayments 100, 100a, 200, 300, 300a, 400, 400a, 500, 500a of the present disclosure are configured for durability in response to repeated foot traffic (e.g., the type of foot traffic that may occur to roofing underlayments as the roofing underlayments are being installed on a roof). For example, multilayered structures having gripping structures 34 (e.g., roofing underlayments 100, 100a, 200, 300, 300a, 400, 400a, 500, 500a of the present disclosure or any other multilayered structure having gripping structures) can be tested using a testing device in accordance with ASTM F2913-19 (e.g., testing device 601 described with reference to FIGS. 14-16 of the present application) to determine a percentage height maintained for the gripping structures 34. The repeated foot traffic is created by testing the multilayered structures in a first direction and a second direction (where the second direction is 180 degrees relative to the first direction) using the method described with reference to FIGS. 14-16 to apply force to the gripping structures in each direction. In certain aspects, roofing underlayments having a plurality of gripping structures 34 with a large contact area causes a higher percentage height of the gripping structures to be maintained due to the force being distributed over more gripping structures. In certain aspects, the roofing underlayments of the present disclosure having gripping structures with a contact area of 5% or greater to distribute the force over various gripping structures, including a contact area of 6.9% or greater, a contact area of 10% or greater, a contact area of 13% or greater, a contact area of 33% or greater. In certain aspects, the percentage height maintained of the gripping structures for roofing underlayments of the present disclosure are 30% or greater, such as 50% or greater, such as 90% or greater, such as 93% or greater, such as 95% or greater. The percentage height maintained is based on testing the gripping structures of multilayered structures in dry test conditions with testing shoe 1, where 30 slips (or movements) are to be completed in the first direction and 20 slips (or movements) are to be completed in the second direction.

While the present application describes various embodiments of multilayer structures, including roofing underlayments, it should be understood that the various features described in the present application can be applied to any suitable type of roofing underlayment or other multilayer structure. Table 4 below provides examples of roofing underlayments or other multilayer structures in which the various features described in the present application can be applied to.

TABLE 4

| | Structure 1 | Structure 2 | Structure 3 | Structure 4 | Structure 5 | Structure 6 | Structure 7 |
|---|---|---|---|---|---|---|---|
| Layers | Microstructured | Microstructured | Structure | Structure | Microstruct | Structure | Structure |
| from top | Film | Coating | 1 | 2 | Film | 1 | 2 |
| to | Coating OR | Reinforcement | Adhesive | Adhesive | Coating | Coating | Coating |
| bottom: | Adhesive | | Coating (1 or | Coating (1 or | (asphaltic, | (asphaltic, | (asphaltic, |
| | | | more layers | more layers | butyl, or other | butyl, or other | butyl, or other |
| | | | of asphaltic, | of asphaltic, | coating) | coating) | coating) |
| | | | butyl, or other | butyl, or other | | | |
| | | | adhesive) | adhesive) | | | |
| | Reinforcement | Optional | Optional | Optional | Reinforcement | Reinforcement | Reinforcement |
| | | Coating | Release Liner | Release Liner | (optionally | (optionally | (optionally |
| | | | | | partially | partially | partially |
| | | | | | impregnated | impregnated | impregnated |
| | | | | | with one or | with one or | with one or |
| | | | | | more coating) | more coating) | more coating) |
| | Optional | | | | Adhesive | Adhesive | Adhesive |
| | Coating | | | | Coating | Coating | Coating |
| | | | | | (asphaltic, | (asphaltic, | (asphaltic, |
| | | | | | butyl, or other | butyl, or other | butyl, or other |
| | | | | | adhesive) | adhesive) | adhesive) |
| | | | | | Optional | Optional | Optional |
| | | | | | Release Liner | Release Liner | Release Liner |

Referring to Table 4, a first structure (“Structure 1”) can include the following layers from top to bottom: a microstructured film (e.g., any film 30 having gripping structures 34 disposed thereon described in the present application), a coating or adhesive (e.g., any coating or adhesive described in the present application), a reinforcement (e.g., any reinforcement described in the present application), and an optional coating (e.g., any coating described in the present application).

Still referring to Table 4, a second structure (“Structure 2”) can include the following layers from top to bottom: a microstructured coating (e.g., any thermoplastic coating 20a having gripping structures 24a described in the present application), a reinforcement (e.g., any reinforcement described in the present application), and an optional coating (e.g., any coating described in the present application).

A third structure (“Structure 3”) includes the layers from Structure 1 as described from top to bottom, and further includes the following layers positioned below the layers of Structure 1 from top to bottom: an adhesive coating (e.g., one or more layers of an asphaltic coating, a butyl coating, and/or any other adhesive coating described in the present application) and an optional release liner (e.g., any release liner described in the present application).

A fourth structure (“Structure 4”) includes the layers from Structure 2 as described from top to bottom, and further includes the following layers positioned below the layers of Structure 2 from top to bottom: an adhesive coating (e.g., one or more layers of an asphaltic coating, a butyl coating, and/or any other adhesive coating described in the present application) and an optional release liner (e.g., any release liner described in the present application).

A fifth structure (“Structure 5”) can include the following layers from top to bottom: a microstructured coating (e.g., any thermoplastic coating 20a having gripping structures 24a described in the present application), a coating (e.g., an asphaltic coating, a butyl coating, or any other coating described in the present application), a reinforcement that is optionally partially impregnated with one or more coatings (e.g., any reinforcement described in the present application), an adhesive coating (e.g., one or more layers of an asphaltic coating, a butyl coating, and/or any other adhesive coating described in the present application), and an optional release layer (e.g., any release liner described in the present application).

A sixth structure (“Structure 6”) includes the layers from Structure 1 as described from top to bottom, and further includes the following layers positioned below the layers of Structure 1 from top to bottom: a coating (e.g., an asphaltic coating, a butyl coating, or any other coating described in the present application), a reinforcement that is optionally partially impregnated with one or more coatings (e.g., any reinforcement described in the present application), an adhesive coating (e.g., one or more layers of an asphaltic coating, a butyl coating, and/or any other adhesive coating described in the present application), and an optional release layer (e.g., any release liner described in the present application).

A seventh structure (“Structure 7”) includes the layers from Structure 2 as described from top to bottom, and further includes the following layers positioned below the layers of Structure 2 from top to bottom: a coating (e.g., an asphaltic coating, a butyl coating, or any other coating described in the present application), a reinforcement that is optionally partially impregnated with one or more coatings (e.g., any reinforcement described in the present application), an adhesive coating (e.g., one or more layers of an asphaltic coating, a butyl coating, and/or any other adhesive coating described in the present application), and an optional release layer (e.g., any release liner described in the present application).

It should be understood that any of Structures 1-7, or any other embodiment of a roofing underlayment or other multilayer structure described in the present application, can include one or more additional layers (e.g., any type of layers described in the present application). For Structures 1-7, or any other embodiment of a roofing underlayment or other multilayer structure described in the present application, it should be understood that when one or more layers are described as being adhered to another layer, the adhered layers can be directly adhered to each other or indirectly adhered to each other by one or more additional layers (e.g., any layers described in the present application).

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more (e.g., 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

The multilayer structures of the present disclosure can comprise, consist of, or consist essentially of the essential elements and limitations of the disclosure as described herein, as well as any additional or optional components or limitations described herein.

To the extent that the terms “include,” “includes,” or “including” are used in the specification or the claims, they are intended to be inclusive in a manner similar to the term “comprising” as that term is interpreted when employed as a transitional word in a claim. Furthermore, to the extent that the term “or” is employed (e.g., A or B), it is intended to mean “A or B or both A and B.” When the Applicant intends to indicate “only A or B but not both,” then the term “only A or B but not both” will be employed. Thus, use of the term “or” herein is the inclusive, and not the exclusive use. Furthermore, the phrase “at least one of A, B, and C” should be interpreted as “only A or only B or only C or any combinations thereof.” In the present disclosure, the words “a” or “an” are to be taken to include both the singular and the plural. Conversely, any reference to plural items shall, where appropriate, include the singular.

In some embodiments, it may be possible to utilize the various inventive concepts in combination with one another. Additionally, any particular element recited as relating to a particularly disclosed embodiment should be interpreted as available for use with all disclosed embodiments, unless incorporation of the particular element would be contradictory to the express terms of the embodiment. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

The scope of the general inventive concepts presented herein are not intended to be limited to the particular exemplary embodiments shown and described herein. From the disclosure given, those skilled in the art will not only understand the general inventive concepts and their attendant advantages, but will also find apparent various changes and modifications to the devices, systems, and methods disclosed. It is sought, therefore, to cover all such changes and modifications as fall within the spirit and scope of the general inventive concepts, as described and/or claimed herein, and any equivalents thereof.

What is claimed is:

1. A roofing underlayment comprising:
a reinforcement having a first reinforcement surface and a second reinforcement surface;
a film having a first film surface and a second film surface; and
a plurality of gripping structures,
wherein the first reinforcement surface is adhered to the second film surface,
wherein the plurality of gripping structures are disposed on at least a portion of the first film surface,
wherein the roofing underlayment has each of the following:
a coefficient of friction of between about 1.2 and about 1.8 when tested in dry conditions using a COF method 1,
a coefficient of friction of between about 0.8 and about 1.5 when tested in wet conditions using the COF method 1, and
a coefficient of friction of between about 0.5 and about 1.2 when tested in sawdust conditions using the COF method 1.

2. The roofing underlayment of claim 1, wherein the film and the plurality of gripping structures have a Shore D hardness of about 40 to 100.

3. The roofing underlayment of claim 1, wherein a pitch between adjacent gripping structures is from 150 μm to 4,000 μm.

4. The roofing underlayment of claim 1, wherein the plurality of gripping structures has a contact area of 5% to 15%.

5. The roofing underlayment of claim 1, wherein the plurality of gripping structures has an aspect ratio of 0.3:1 to 1.5:1.

6. The roofing underlayment of claim 1, where the film comprises at least one of a polyolefin, a polyester, a polyamide, a polyimide, a polycarbonate, a polyurethane, a fluoropolymer, a copolymer of an olefin and an α,β-unsaturated carbonyl, a synthetic rubber, or a thermoplastic elastomer.

7. The roofing underlayment of claim 1, wherein the reinforcement comprises a mesh structure, a nonwoven structure, a film structure, or combinations thereof.

8. The roofing underlayment of claim 1, which has a width of 0.6 m to 2 m, a length of 9 m to 100 m, and a thickness of 125 μm to 2,500 μm.

9. The roofing underlayment of claim 1, further comprising:
a first adhesive coating;
a second adhesive coating; and
an optional release liner,
wherein the reinforcement comprises a glass mat,
wherein the first adhesive coating is adhered to the second reinforcement surface,
wherein the glass mat is at least partially impregnated with at least one of the first adhesive coating and the second adhesive coating, and
wherein the optional release liner is optionally adhered to a surface of the second adhesive coating opposite the glass mat.

10. The roofing underlayment of claim 1, further comprising:
a bottom coating;
a first adhesive coating;
a second adhesive coating; and
an optional release liner,
wherein the reinforcement comprises a glass mat,
wherein the bottom coating is adhered to the second reinforcement surface,
wherein the first adhesive coating is adhered to the bottom coating opposite the second reinforcement surface,
wherein the glass mat is at least partially impregnated with at least one of the first adhesive coating and the second adhesive coating, and
wherein the optional release liner is optionally adhered to a surface of the second adhesive coating opposite the glass mat.

11. A roofing underlayment comprising:
a reinforcement having a first reinforcement surface and a second reinforcement surface; and
a thermoplastic coating including a plurality of gripping structures,
wherein the thermoplastic coating is adhered to the first reinforcement surface,
wherein the roofing underlayment has each of the following:
a coefficient of friction of between about 1.2 and about 1.8 when tested in dry conditions using a COF method 1,
a coefficient of friction of between about 0.8 and about 1.5 when tested in wet conditions using the COF method 1, and
a coefficient of friction of between about 0.5 and about 1.2 when tested in sawdust conditions using the COF method 1.

12. The roofing underlayment of claim 11, wherein the thermoplastic coating and the plurality of gripping structures have a Shore D hardness of about 40 to 100.

13. The roofing underlayment of claim 11, wherein a pitch between adjacent gripping structures is from 150 μm to 4,000 μm.

14. The roofing underlayment of claim 11, wherein the plurality of gripping structures has a contact area of 5% to 15%.

15. The roofing underlayment of claim 11, wherein the plurality of gripping structures has an aspect ratio of 0.3:1 to 1.5:1.

16. The roofing underlayment of claim 11, wherein the thermoplastic coating comprises at least one of a polyolefin, a polyacrylate, a polyester, a polyamide, a polyimide, a polycarbonate, a polyurethane, a fluoropolymer, a copolymer of an olefin and an α,β-unsaturated carbonyl, a synthetic rubber, a thermoplastic elastomer, or combinations thereof, and wherein the thermoplastic coating has a basis weight of 10 g/m² to 150 g/m².

17. The roofing underlayment of claim 11, wherein the reinforcement comprises a mesh structure, a nonwoven structure, a film structure, or combinations thereof.

18. The roofing underlayment of claim 11, which has a width of 0.6 m to 2 m, a length of 9 m to 100 m, and a thickness of 125 μm to 2,500 μm.

19. The roofing underlayment of claim 11, further comprising:
a first adhesive coating;
a second adhesive coating; and
an optional release liner,
wherein the reinforcement comprises a glass mat,
wherein the first adhesive coating is adhered to the second reinforcement surface,
wherein the glass mat is at least partially impregnated with at least one of the first adhesive coating and the second adhesive coating, and
wherein the optional release liner is optionally adhered to a surface of the second adhesive coating opposite the glass mat.

20. The roofing underlayment of claim 11, further comprising:
a bottom coating;
a first adhesive coating;
a second adhesive coating; and
an optional release liner,
wherein the reinforcement comprises a glass mat,
wherein the bottom coating is adhered to the second reinforcement surface,
wherein the first adhesive coating is adhered to the bottom coating opposite the second reinforcement surface,
wherein the glass mat is at least partially impregnated with at least one of the first adhesive coating and the second adhesive coating, and
wherein the optional release liner is optionally adhered to a surface of the second adhesive coating opposite the glass mat.
